(19) United States
(12) Patent Application Publication
(10) Pub. No.: US 2026/0108870 A1
(43) Pub. Date: Apr. 23, 2026

(54) POLYMER ADSORBENTS FOR SELECTIVE IONS ADSORPTION

(71) Applicant: Nanyang Technological University, Singapore (SG)

(72) Inventors: Atsushi GOTO, Singapore (SG); Hong Tho LE, Singapore (SG)

(21) Appl. No.: 18/861,243

(22) PCT Filed: May 12, 2023
(86) PCT No.: PCT/SG2023/050329

§ 371 Date: Oct. 29, 2024

(30) Foreign Application Priority Data
May 13, 2022 (SG) 10202205028S

(51) Int. Cl. B01J 39/20; B01J 39/04; C01B 35/00; C08F 238/00; C22B 3/24; C22B 3/42; C22B 26/12

(52) U.S. Cl. CPC B01J 39/20; B01J 39/04; C01B 35/00; C08F 238/00; C22B 3/24; C22B 3/42; C22B 26/12; C08F 2800/10; C08F 2810/20

(57) ABSTRACT

Disclosed herein are a polymeric material comprising a plurality of polymeric nanosheets arranged in a layer-by-layer configuration to provide a two-dimensional microporous polymeric material, wherein each of the plurality of polymeric nanosheets is formed from a plurality of ladder-shaped polymers, the ladder-shaped polymers are formed from at least one multivalent monomeric material that has: two or more polymerisable functional groups selected from one or both of acetylene and vinyl functional groups; and a functional group capable of forming a halogen bond with a halogen atom, use of the polymeric material, and a method of manufacturing the polymeric material. Also disclosed herein is a method of adsorbing Li⁺ and/or B³⁺ ions from an aqueous solution comprising a mixture of ionic species.

### FIELD OF INVENTION

The present disclosure generally relates to polymer adsorbents and more particularly relates to polymeric materials comprising a plurality of polymeric nanosheets arranged in a layer-by-layer configuration to provide two-dimensional microporous polymeric materials for Li⁺ and B³⁺ adsorption.

### BACKGROUND

The listing or discussion of a prior-published document in this specification should not necessarily be taken as an acknowledgement that the document is part of the state of the art or is common general knowledge.

Seawater reverse osmosis (SWRO) is Singapore's key strategic thrust, as desalinated water is expected to meet up to 30% of Singapore's future water needs by 2060. With growing demand for desalinated water in Singapore and other countries, a massive amount of SWRO brine (concentrates rejected from the process) is produced in the world and its amount is rapidly increasing. Ions present in SWRO brine such as Li⁺ are valuable metal ions. The recovery of such high-value resources can bring economic benefit and hence sustainable desalination. There is also a challenge of disposing the huge amount of SWRO brine, because SWRO brine contains boron that causes a detrimental impact on environment. Thus, boron must be removed from SWRO brine before disposal.

Li recovery potentially amounts to an economic benefit of >300 million SGD per year in Singapore. Li is highly demanded in batteries, for instance. Li is currently mined on land (from salt lakes and rocks) in particular countries, and those countries govern Li trading. Harnessing Li from seawater is borderless and has great market potential. Boron is an important precursor for glass products, soaps, detergents, and fire retardants in industry. The collection of boron may also offer economic gains potentially.

Therefore, there is an urgent need for an effective method for recovery of precious metals and removal of boron from SWRO brine.

### SUMMARY OF INVENTION

In a first aspect of the invention, there is provided a polymeric material comprising:
a plurality of polymeric nanosheets arranged in a layer-by-layer configuration to provide a two-dimensional microporous polymeric material, wherein:
each of the plurality of polymeric nanosheets is formed from a plurality of ladder-shaped polymers,
the ladder-shaped polymers are formed from at least one multivalent monomeric material that has:
   two or more polymerisable functional groups selected from one or both of acetylene and vinyl functional groups; and
   a functional group capable of forming a halogen bond with a halogen atom.

In a second aspect of the invention, there is provided a use of a polymeric material according to the first aspect of the invention and any technically sensible combination of its embodiments in the adsorption of Li⁺ and/or B³⁺ ions from an aqueous solution comprising a mixture of ionic species, the mixture of ionic species comprising Li⁺ and/or B³⁺ ions.

In a third aspect of the invention, there is provided a method of adsorbing Li⁺ and/or B³⁺ ions from an aqueous solution comprising a mixture of ionic species, the method comprising:
(i) providing an aqueous solution comprising a mixture of ionic species, the aqueous solution comprising at least one of Li⁺ and B³⁺ ions; and
(i) adding a polymeric material according to the first aspect of the invention and any technically sensible combination of its embodiments for a period of time to adsorb at least one of Li⁺ and B³⁺ ions from the aqueous solution comprising a mixture of ionic species.

In a fourth aspect of the invention, there is provided a method of manufacturing a polymeric material according to the first aspect of the invention and any technically sensible combination of its embodiments, wherein the method comprises the steps of:
(a) providing a solid precursor material comprising:
   an initiator;
   at least one multivalent monomeric material that has two or more polymerisable functional groups selected from one or both of acetylene and vinyl functional groups and a functional group capable of forming a halogen bond with a halogen atom; and
   a linker molecule capable of forming a halogen bond with the at least one multivalent monomeric material; and
(b) subjecting the solid precursor material to free radical solid phase polymerization to generate the polymeric material according to the first aspect of the invention and any technically sensible combination of its embodiments, wherein
   the solid precursor material comprises cocrystals or polycrystalline materials formed by a network of the at least one multivalent monomeric material and the halogen bonding linker molecule, which cocrystals or polycrystalline materials are dispersed in the initiator.

### DRAWINGS

FIG. 1 depicts schematic illustration of halogen-bond (XB)-assisted solid phase polymerization (SPP), compounds used in this work, monomer cocrystal and polymer structures, and powder X-ray diffraction (PXRD) patterns before and after polymerization. (a) Schematic illustration of XB-assisted SPP of acetylene. (b) Schematic illustration of polyacetylene synthesis, 2D conjugated microporous polymer (CMP) formation after linker removal, and metal ion adsorption of 2D CMP. The inserted photos show poly(pyridyl-3,5-diacetylene) (PPDA)-CMP-1, 2, and 3 generated from monomer cocrystals 1.6, 1.7, and 1.8, respectively (after linker removal). (c) Monomers, linkers, and photo-initiator used in this work. (d) (A) Monomer cocrystal structure of 1.6 determined by single-crystal X-ray diffraction and a possible polymer structure expected from the monomer cocrystal structure. The figure extracts a single x-y plane of the monomer cocrystal and its possible polymer structure, which is a ladder-shaped polymer growing on the x-axis. The ladder-shaped polymer is further connected to the neighboring ladder-shaped polymers on the y-axis, forming a nanosheet in the x-y plane. The discussion of the polymer structure is given in Example 2 and FIG. 2. (B) A possible multilayer structure of PPDA-CMP-1, showing that the nanosheets form a layer-by-layer structure on the z-axis. (e) PXRD patterns of pure XB linker 6, monomer cocrystal 1.6, and the polymer obtained from 1.6 via SPP, and their calculated PXRD patterns (in dotted line and overlapped with the experimental spectra). 60% of the PXRD pattern of the polymer matched that of the monomer cocrystal. (f) PXRD patterns of pure solid monomer 1 and the polymer obtained from 1 via solution-phase polymerization, and their calculated PXRD patterns (dotted line). 6% of the PXRD pattern of the polymer matched that of the solid monomer.

FIG. 2 depicts three possible structures of PPDA-CMP-1 expected from the monomer cocrystal structure 1-6.

FIG. 3 depicts single-crystal X-ray crystallography structure of monomer cocrystal PDA·I-C₆F₄-I (1·6) and four possible monomer addition (propagation) patterns (Table 1, entry 1). (a) Paths A and B in parallel alignments with monomer distances of 3.535-4.813 Å (tail-to-tail) and 3.648-4.903 Å (head-to-head) (path A) and 3.393-4.232 Å (head-to-tail) (path B). (b) Paths C and D in zigzag alignments with monomer distances of 3.663-3.724 Å (tail-to-tail) and 4.066-4.097 Å (head-to-head) (path C), and 3.584-7.002 Å (head-to-tail) (path D). The π-π distance between two linkers was 3.885-4.321 Å. The molecular packing views down crystallographic b axis in ball-and-stick and space-filling representation are constructed using the crystallographic information file and software package Mercury 3.10.3. Halogen bonds are presented as dotted lines.

FIG. 4 depicts single-crystal X-ray crystallography structure of monomer cocrystal 3PA·I-C₆F₄-I (2·6) and four possible monomer addition (propagation) patterns (Table 1, entry 2). (a) Paths A and B in parallel alignments with monomer distances of 4.349 Å (head-to-head and tail-to-tail) (path A), and 4.068 A (head-to-tail) (path B). (b) Paths C and D in zigzag alignments with monomer distances of 4.616 Å (head-to-head) and 5.780 Å (tail-to-tail) (path C), and 5.121-5.428 Å (head-to-tail) (path D). The TT-TT distance between two linkers was 4.187 Å.

FIG. 5 depicts single-crystal X-ray crystallography structure of monomer cocrystal 4PA·I-C₆F₄-I (3·6) and four possible monomer addition (propagation) patterns (Table 1, entry 3). (a) Paths A and B in parallel alignments with monomer distances of 6.107 Å (head-to-head and tail-to-tail) (path A), and 5.379 Å (head-to-tail) (path B). (b) Paths C and D in zigzag alignments with monomer distances of 3.782 Å (tail-to-tail) and 5.059 Å (head-to-head) (path C), and 3.859 Å (head-to-tail) (path D). The π-π distance between two linkers was 5.086 Å.

FIG. 6 depicts single-crystal X-ray crystallography structure of monomer cocrystal PMA·I-C₆F₄-I (4·6) and four possible monomer addition (propagation) patterns (Table 1, entry 4). (a) Paths A and B in parallel alignments with monomer distances of 5.133 Å (head-to-head and tail-to-tail) (path A), and 4.775 Å (head-to-tail) (path B). (b) Paths C and D in zigzag alignments with monomer distances of 3.763 Å (tail-to-tail) and 4.792 Å (head-to-head) (path C), and 3.994-4.827 Å (head-to-tail) (path D). The TT-TT distance between two linkers was 3.733 Å.

FIG. 7 depicts single-crystal X-ray crystallography structure of monomer cocrystal PPVA·I-C₆F₄-I (5.6) and four possible monomer addition (propagation) patterns (Table 1, entry 5). (a) Paths A and B in parallel alignments with monomer distances of 7.782 Å (head-to-head and tail-to-tail) (path A), and 6.337 Å (head-to-tail) (path B). (b) Paths C and D in zigzag alignments with monomer distances of 5.370 Å (tail-to-tail) and 5.588 Å (head-to-head) (path C), and 4.556-6.451 Å (head-to-tail) (path D). The TT-TT distance between two linkers was 7.391 Å.

FIG. 8 depicts single-crystal X-ray crystallography structure of monomer cocrystal 3PA·C₆F₃I₃ (2·7) and four possible monomer addition (propagation) patterns (Table 1, entry 6). (a) Paths A and B in parallel alignments with monomer distances of 3.704 Å (head-to-head) and 3.719 Å (tail-to-tail) (path A) and 3.479 Å (head-to-tail) (path B). (b) Paths C and D in zigzag alignments with monomer distances of 4.958 Å (head-to-head) and 5.353 Å (tail-to-tail) (path C), and 4.895-5.337 Å (head-to-tail) (path D). The average π-π distance between two linkers was 3.571 Å.

FIG. 9 depicts four possible monomer addition (propagation) patterns that can occur inside the cocrystals.

FIG. 10 depicts transmission electron microscopy (TEM) images in the solid phase of (a) three-component monomer cocrystal 1.6 and (b) polymer solid from 1·6 via SPP.

FIG. 11 depicts TEM images in the solid phase of (a) three-component monomer cocrystal 1·7 and (b) polymer solid from 1·7 via SPP.

FIG. 12 depicts TEM images in the solid phase of (a) three-component monomer cocrystal 1·8 and (b) polymer solid from 1·8 via SPP.

FIG. 13 depicts infrared (IR) spectra of XB linker 6 (I-C₆F₄-I), polymer from 1·6 before linker removal, and polymer (PPDA-CMP-1) after linker removal (washing with ethanol) (KBr). The ═C—H stretch, non-aromatic C═C bonds (polyacetylene backbone), and aromatic C═C bonds (pyridine) appeared at 2968, 1698, and 1596 cm⁻¹, respectively. The C—F stretch at 956 cm⁻¹ and C—I stretch at 741 cm⁻¹ for XB linker 6 disappeared after washing with ethanol, indicating complete removal of XB linker 6.

FIG. 14 depicts IR spectra of XB linker 7 (C₆F₃I₃), polymer from 1·7 before linker removal, and polymer (PPDA-CMP-2) after linker removal (washing with ethanol) (KBr). The ═C—H stretch, non-aromatic C═C bonds (polyacetylene backbone), and aromatic C═C bonds (pyridine) appeared at 3047, 1721, and 1639 cm⁻¹, respectively. The C—F stretch at 1036 cm-1 and C—I stretch at 649 cm⁻¹ for XB linker 7 disappeared after washing with ethanol, indicating complete removal of XB linker 7.

FIG. 15 depicts IR spectra of XB linker 8 (I—(CF₂)₂—I), polymer from 1.8 before linker removal, and polymer (PPDA-CMP-3) after linker removal (washing with ethanol) (KBr). The ═C—H stretch, non-aromatic C═C bonds (polyacetylene backbone), and aromatic C═C bonds (pyridine) appeared at 3005, 1698, and 1560 cm⁻¹, respectively. The C—F stretch of XB linker 8 at 1116 cm⁻¹ and C—I stretch at 701 cm⁻¹ disappeared after washing with ethanol, indicating complete removal of XB linker 8.

FIG. 16 depicts IR spectra of XB linker 6 (I-C₆F₄—I), polymer from 2.6 before linker removal, and polymer (P3PA-1) after linker removal (washing with ethanol) (KBr). The ═C—H stretch, non-aromatic C═C bonds (polyacetylene backbone), and aromatic C═C bonds (pyridine) appeared at 2970, 1709, and 1615 cm-1, respectively. The C—F stretch of XB linker 6 at 956 cm⁻¹ and C—I stretch at 741 cm-1 disappeared after washing with ethanol, indicating complete removal of XB linker 6.

FIG. 17 depicts IR spectra of XB linker 7 (C₆F₃I₃), polymer from 2.7 before linker removal, and polymer (P3PA-2) after linker removal (washing with ethanol) (KBr). The ═C—H stretch, non-aromatic C═C bonds (polyacetylene backbone), and aromatic C═C bonds (pyridine) appeared at 2965, 1723, and 1644 cm⁻¹, respectively. The C—F stretch at 1036 cm⁻¹ and C—I stretch at 649 cm⁻¹ for XB linker 7 disappeared after washing with ethanol, indicating complete removal of XB linker 7.

FIG. 18 depicts thermal gravimetric analysis (TGA) curve of PPDA-CMP-1 (after washing with ethanol) at a heating rate of 10° C./min under flowing air atmosphere. T_{d(5%)}=106° C., T_{d(50%)}=667° C.

FIG. 19 depicts TGA curve of PPDA-CMP-2 (after washing with ethanol) at a heating rate of 20° C./min under flowing air atmosphere. T_{d(5%)}=249° C.; T_{d(50%)}=543° C.

FIG. 20 depicts TGA curve of PPDA-CMP-3 (after washing with ethanol) at a heating rate of 20° C./min under flowing air atmosphere. T_{d(5%)}=190° C.; T_{d(50%)}=363° C.

FIG. 21 depicts PXRD patterns of pure XB linkers, monomer cocrystals, and polymer solids obtained via SPP, and their calculated PXRD patterns (in dashed lines). (a) PXRD patterns of pure XB linker 7 (C₆F₃I₃), monomer cocrystal 1·7, and polymer solid from 1·7 via SPP. (b) PXRD patterns of monomer cocrystal 1·8 and polymer solid from 1·8 via SPP. (c) PXRD patterns of pure XB linker 6 (I-C₆F₄—I), monomer cocrystal 2·6, and polymer solid from 2·6 via SPP. (d) PXRD patterns of pure XB linker 7 (C₆F₃I₃), monomer cocrystal 2·7, and polymer solid from 2·7 via SPP. 43%, 79%, 43%, and 58% of PXRD patterns of polymers matched those of the monomer cocrystals in (a)-(d), respectively, showing the SPP is crystal-to-crystal polymerization.

FIG. 22 depicts modified Scherrer equation fittings (least square method) for plots of ln(β) vs ln(1/cos θ) from PXRD patterns (FIGS. 1e-f and 21, Equation (1), and Table 4). (A) Polymer (PPDA) synthesized from 1·6 via SPP (FIG. 1e). (B) Monomer cocrystal 1·6 (FIG. 1e). (C) Polymer (PPDA) synthesized via solution-phase polymerization (FIG. 1f). (D) Monomer 1 (FIG. 1f). (E) Polymer (PPDA) synthesized from 1·7 via SPP (FIG. 21a). (F) Monomer cocrystal 1·7 (FIG. 21a). (G) Polymer (PPDA) synthesized from 1·8 via SPP (FIG. 21b). (H) Monomer cocrystal 1·8 (FIG. 21b). (I) Polymer (P3PA) synthesized from 2·6 via SPP (FIG. 21c). (J) Monomer cocrystal 2·6 (FIG. 21c). (K) Polymer (P3PA) synthesized from 2·7 via SPP (FIG. 21d). (L) Monomer cocrystal 2·7 (FIG. 21d).

FIG. 23 depicts porous structures, 2D exfoliated structures, and Brunauer-Emmett-Teller (BET) analysis of PPDA-CMP. (a) Schematic illustration of three types of pores in CMPs. (b) Scanning electron microscopy (SEM) images of non-exfoliated PPDA-CMP-1 showing inter-grainmicropores. (c) TEM images of exfoliated PPDA-CMP-1 (at 2×10⁻⁴ wt % of CMP in γ-butyrolactone (GBL)) showing surface (image A) and single-chain nanopores (zoom-in image B) at the outermost layer of CMP. (d) atomic force microscopy (AFM) images and schematic illustration of exfoliated PPDA-CMP-1 (at 2×10⁻⁴ wt % and 0.1 wt % of CMP in GBL) with (A) monolayer, (B) bilayer, (C) tri-layer, and (D) tetra-layer nanosheets. (e) BET analysis with a nitrogen (N₂) adsorption-desorption isotherm of non-exfoliated PPDA-CMP-1.

FIG. 24 depicts additional AFM image and height profiles of exfoliated PPDA-CMP-1 (exfoliated at 0.1 wt % of CMP in GBL). (A) AFM image. (B) Height profiles.

FIG. 25 depicts additional TEM images of exfoliated PPDA-CMP-1 (exfoliated at 2×10⁻⁴ wt % of CMP in GBL) and a possible polymer structure expected from the monomer cocrystal (1·6) structure before linker removal. The TEM images show surface (image A) and single-chain nanopores (zoom-in image B) at the outermost layer of CMP. The polymer structure given in the figure is not an actual experimental X-ray structure but is expected from the monomer cocrystal structure.

FIG. 26 depicts SEM images of non-exfoliated PPDA-CMP-2 and TEM images of exfoliated PPDA-CMP-2 (exfoliated at 2×10⁻⁴ wt % of CMP in GBL). (a) The SEM images show inter-grain micropores (after washing with ethanol). (b) The TEM images show surfaces (images A and B) and single-chain nanopores (zoom-in images C and D) at the outermost layer of CMP. The arrows in images A and B show edges where thin layered structures were particularly clearly observed.

FIG. 27 depicts SEM images of non-exfoliated PPDA-CMP-3 and TEM images of exfoliated PPDA-CMP-3 (exfoliated at 2×10⁻⁴ wt % of CMP in GBL). (a) The SEM images show inter-grain micropores (after washing with ethanol). (b) The TEM images show surfaces (images A and B) and single-chain nanopores (zoom-in images C and D) at the outermost layer of CMP. The arrows in image A show edges where thin layered structures were particularly clearly observed.

FIG. 28 depicts (a)-(e) AFM images and height profiles of exfoliated PPDA-CMP-2 (exfoliated at 2×10⁻⁴ wt % of CMP in GBL). (A) AFM image. (B) Height profiles.

FIG. 29 depicts (a)-(d) AFM images and height profiles of exfoliated PPDA-CMP-3 (exfoliated at 2×10⁻⁴ wt % of CMP in GBL). (A) AFM image. (B) Height profiles.

FIG. 30 depicts (A) BET nitrogen (N₂) adsorption-desorption isotherms, (B) N₂ adsorption isotherms at P/P₀=0.06-0.14, and (C) BET linear plots at P/P₀=0.06-0.14 (Equation (7)) of non-exfoliated PPDA-CMPs. (a) PPDA-CMP-1. (b) PPDA-CMP-2. (c) PPDA-CMP-3.

FIG. 31 depicts metal ion adsorption-desorption in PPDA-CMP. (a) Schematic illustration of adsorption-desorption of Li⁺ (left) and B³⁺ (right) in PPDA-CMP. Li⁺ is selectively adsorbed from a mixture of Li⁺, Rb⁺ and Cs⁺ in PPDA-CMP-1 (bottom). (b) Full and Li 1 s X-ray photoelectron spectroscopy (XPS) spectra of PPDA-CMP-1 after Li⁺ adsorption (i) and desorption (ii) for the pure Li⁺ system (Table 8, entry 1). (c) Full, Li 1 s, Rb 3p, and Cs 3d XPS spectra of PPDA-CMP-1 after metal ion adsorption (i) and desorption (ii) for the Li⁺+Rb⁺+Cs⁺ system (Table 8, entry 4). (d) SEM-EDS mapping images of PPDA-CMP-1 after B³⁺ adsorption (top) and desorption (bottom) for the pure B³⁺ system (Table 8, entry 7); electron images (SEM), summarized EDS images (EDS), and individual element images (carbon (C), oxygen (O), nitrogen (N), and boron (B)).

FIG. 32 depicts SEM images of non-exfoliated P3PA-1 polymer synthesized from 3PA·I-C₆F₄—I (2·6). The SEM images (image A and zoom-in image B) show inter-grain micropores (after washing with ethanol).

FIG. 33 depicts SEM images of non-exfoliated P3PA-2 polymer synthesized from 3PA·C₆F₃I₃ (2·7). The SEM images (image A and zoom-in image B) show inter-grain micropores (after washing with ethanol).

FIG. 34 depicts examples of acetylene monomers in the present disclosure.

FIG. 35 depicts examples of vinyl monomers in the present disclosure.

FIG. 36 depicts examples of vinyl and acetylene combined monomers in the present disclosure.

FIG. 37 depicts synthesis of poly(divinyl pyridine) (PDVP)-porous organic polymer (POP)-1 and PDVP-POP-2 via XB-based SPP.

FIG. 38 depicts PDVP-POP-1. (a) TEM images (image A and zoom-in image B) show single-chain nanopores. (b) AFM images and height profiles (A and B) show inter-chain nanopores. (c) SEM images (image A and zoom-in image B) show inter-grain micropores.

FIG. 39 depicts PDVP-POP-2. (a) TEM images (image A and zoom-in image B) show single-chain nanopores. (b) AFM images and height profiles (A and B) show inter-chain nanopores. (c) SEM images (image A and zoom-in image B) show inter-grain micropores.

### DESCRIPTION

It has been surprisingly found that the controlled polymerisation of monomers comprising two or more acetylenic and/or vinyl groups using halogen bonding provides a polymeric material that is useful in the adsorption of metal ions. Thus, in a first aspect of the invention, there is provided a polymeric material comprising:
a plurality of polymeric nanosheets arranged in a layer-by-layer configuration to provide a two-dimensional microporous polymeric material, wherein:
each of the plurality of polymeric nanosheets is formed from a plurality of ladder-shaped polymers,
the ladder-shaped polymers are formed from at least one multivalent monomeric material that has:
   two or more polymerisable functional groups selected from one or both of acetylene and vinyl functional groups; and
   a functional group capable of forming a halogen bond with a halogen atom.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, and the like.

When used herein, the term “two-dimensional” means a material that may extend beyond the nanoscale in two dimensions, while remaining in the nanoscale in at least one dimension. Examples of two-dimensional or 2D materials include nanosheets. In the current invention, the nanosheets may be formed by a ladder-shaped polymeric material (also referred to as ladder-shaped polymers) and these may be arranged in a layer-by-layer manner to form a porous polymeric material.

The ladder-shaped polymers may be conjugated or non-conjugated and both are able to provide the desired 2D microporous polymeric material. In certain embodiments, the ladder-shaped polymers may be conjugated.

The polymeric material disclosed herein may have a relatively low BET surface area. For example, the BET surface area of the polymeric material may be less than 100 m² g⁻¹. For example, the BET surface area of the polymeric material may be less than or equal to 50 m² g⁻¹. For example, the BET surface area of the polymeric material may be less than or equal to 26 m² g⁻¹. More particularly, the BET surface area of the polymeric material may be from 5 to 26 m² g⁻¹, such as from 11 to 13 m² g⁻¹, such as about 11 m² g⁻¹, such as about 13 m² g⁻¹, such as about 26 m² g⁻¹.

For the avoidance of doubt, it is explicitly contemplated that where a number of numerical ranges related to the same feature are cited herein, the end points for each range are intended to be combined in any order to provide further contemplated (and implicitly disclosed) ranges.

Thus, the BET surface area of the polymeric material may be:
from 5 to 11 m² g⁻¹, from 5 to 13 m² g⁻¹, from 5 to less than or equal to 26 m² g⁻¹, from 5 to less than or equal to 50 m² g⁻¹, from 5 to less than 100 m² g⁻¹;
from 11 to 13 m² g⁻¹, from 11 to less than or equal to 26 m² g⁻¹, from 11 to less than or equal to 50 m² g⁻¹, from 11 to less than 100 m² g⁻¹;
from 13 to less than or equal to 26 m² g⁻¹, from 13 to less than or equal to 50 m² g⁻¹, from 13 to less than 100 m² g⁻¹;
from 26 to less than or equal to 50 m² g⁻¹, from 26 to less than 100 m² g⁻¹; and
from 50 to less than 100 m² g⁻¹.

The term multivalent monomeric material refers to a monomer that has two or more (e.g. 2, 3, or 4) groups that can partake in the formation of a polymeric material. In the context of the current invention, these groups are acetylene and/or vinyl functional groups. In addition, the multivalent monomeric material is one which has at least one functional group (e.g. 1, 2, 3, or 4) that is capable of forming a halogen bond with a halogen atom. A halogen bond occurs when there is evidence of a net attractive interaction between an electrophilic region associated with a halogen atom in a molecular entity and a nucleophilic region in another, or the same, molecular entity.

Any suitable multivalent monomeric material may be used herein. For example, the at least one multivalent monomeric material may be selected from one or more of the group consisting of:

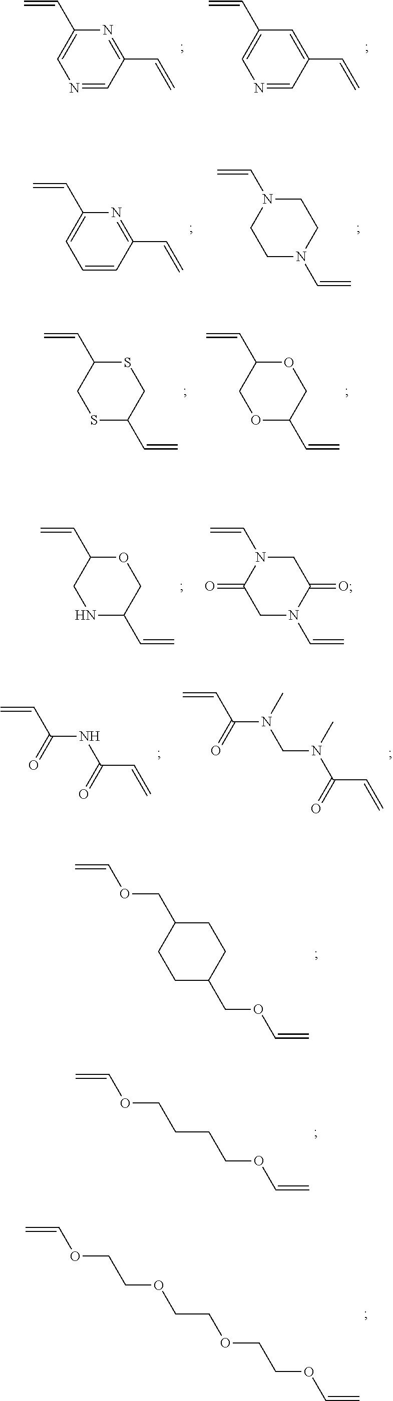

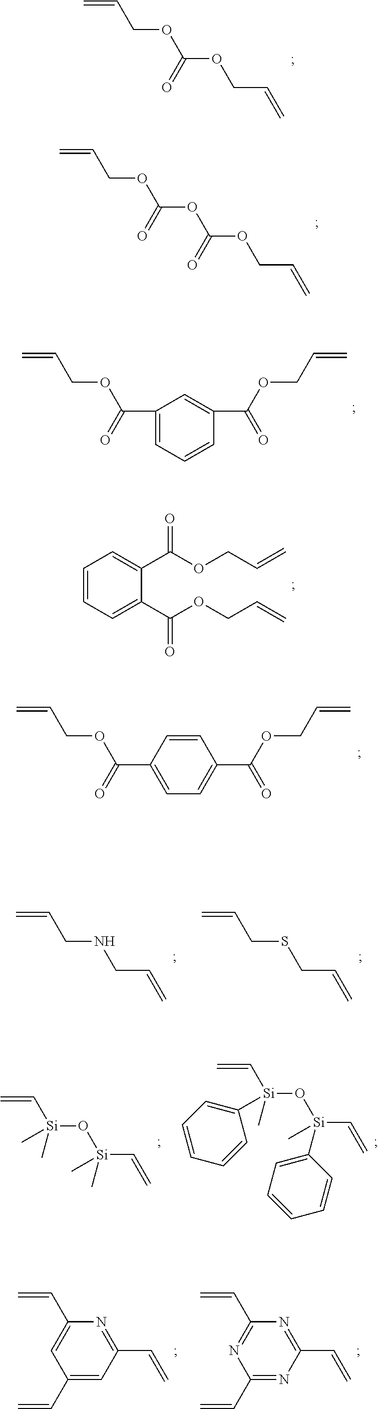

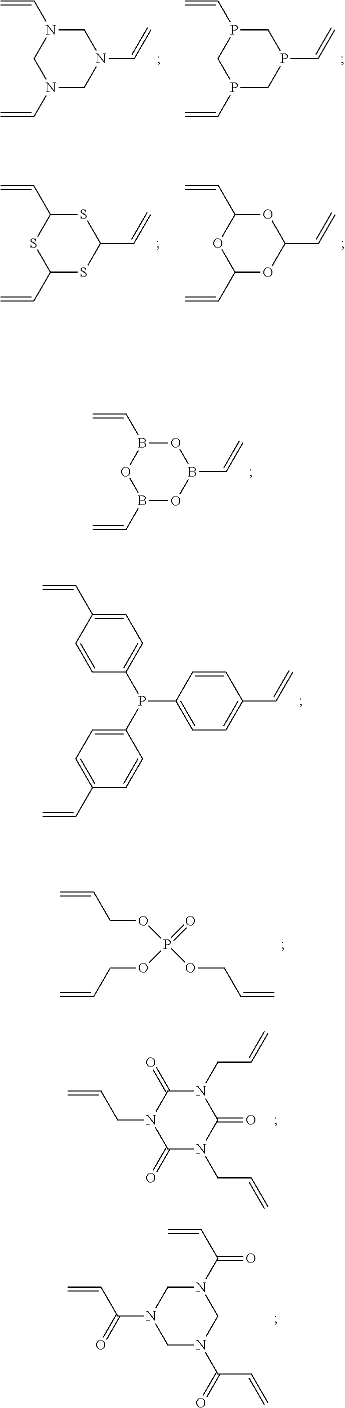

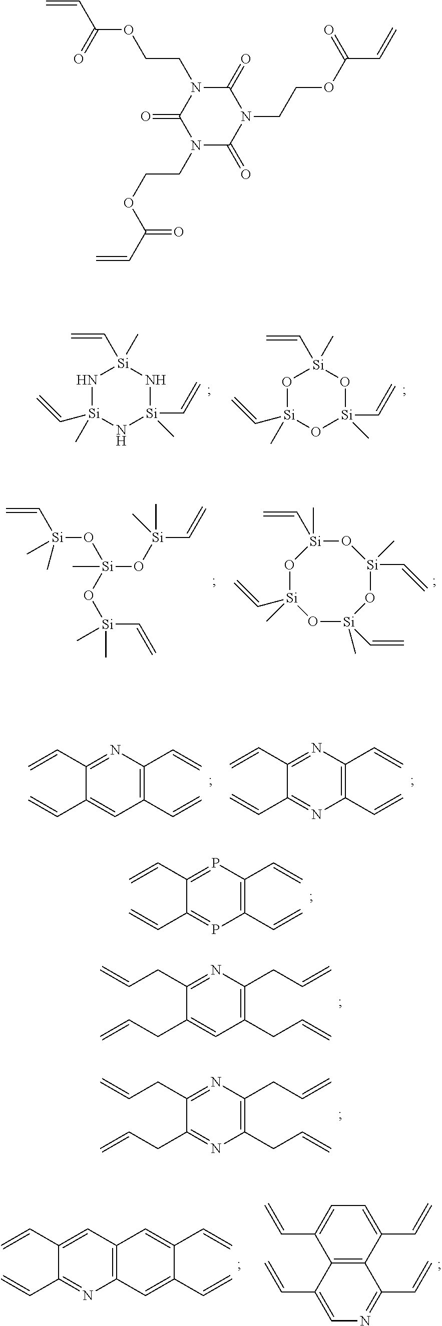

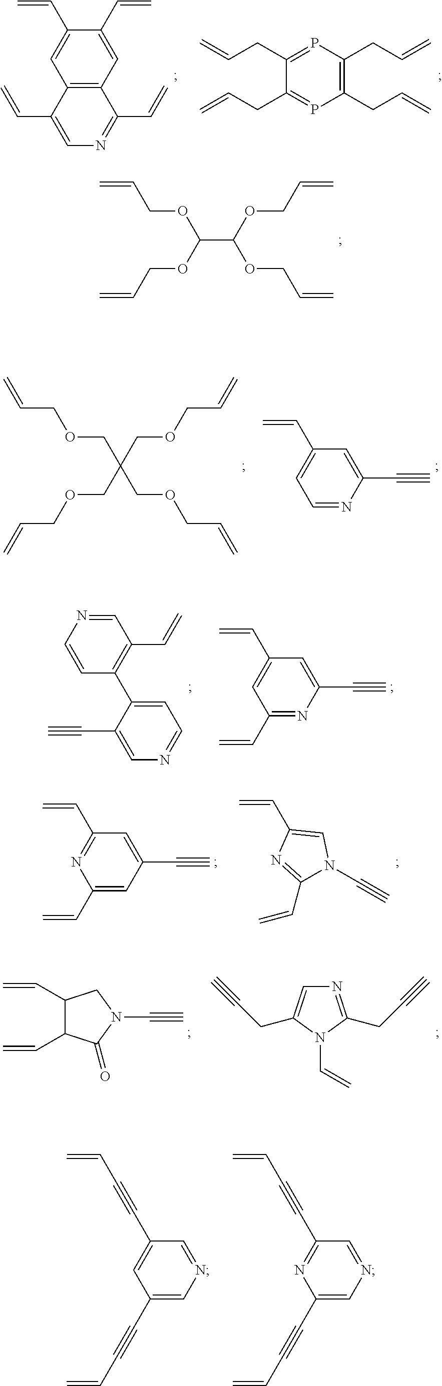

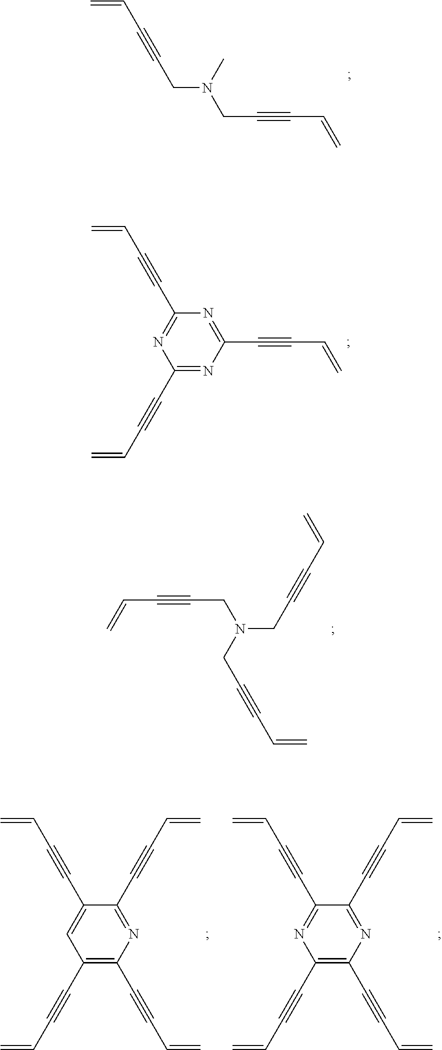

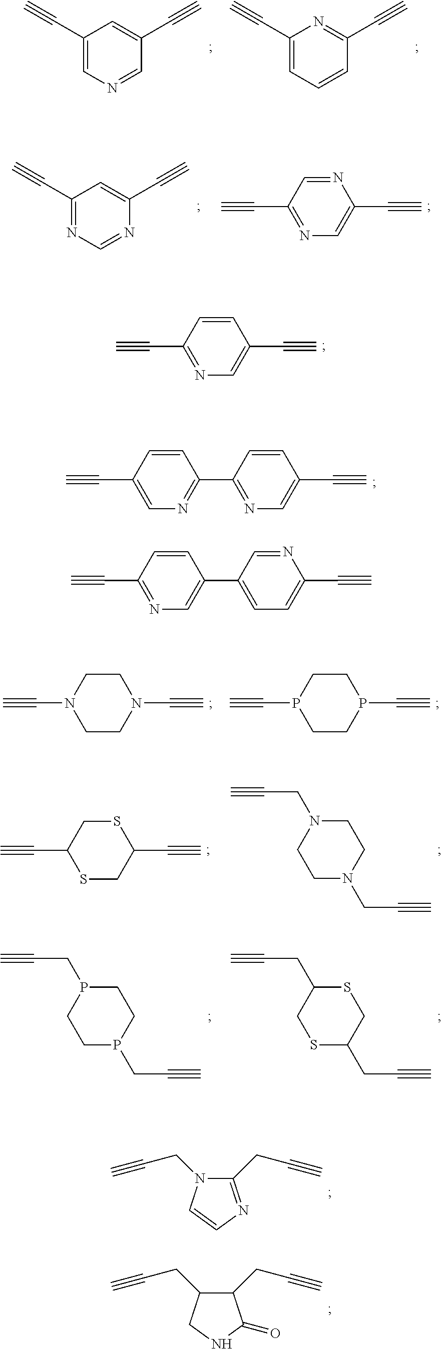

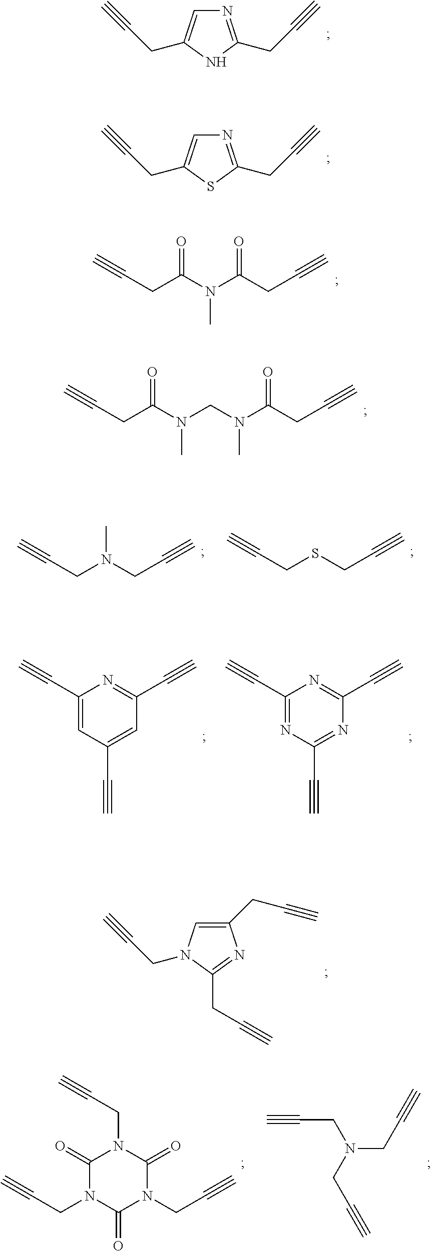

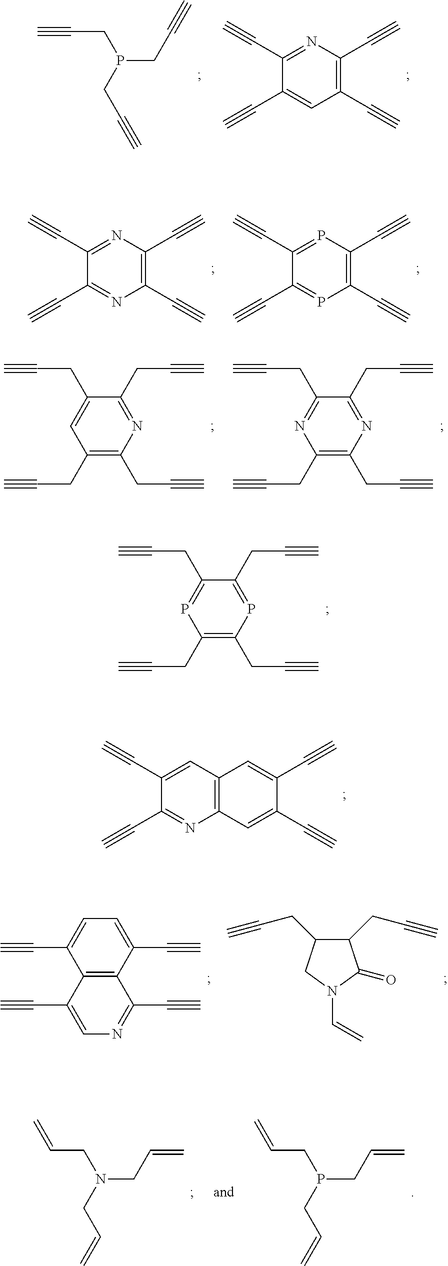

In more particular embodiments that may be mentioned herein, the at least one multivalent monomeric material may be selected from one or more of the group consisting of:

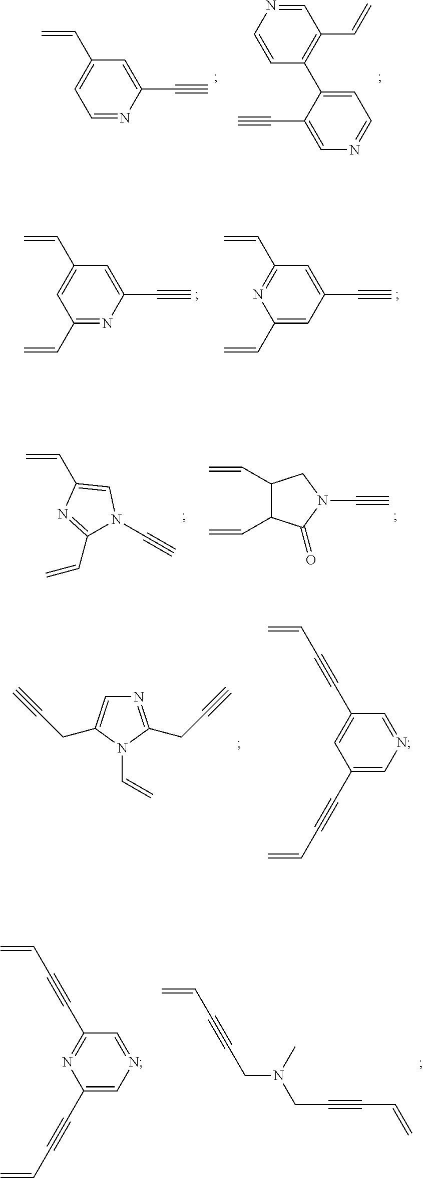

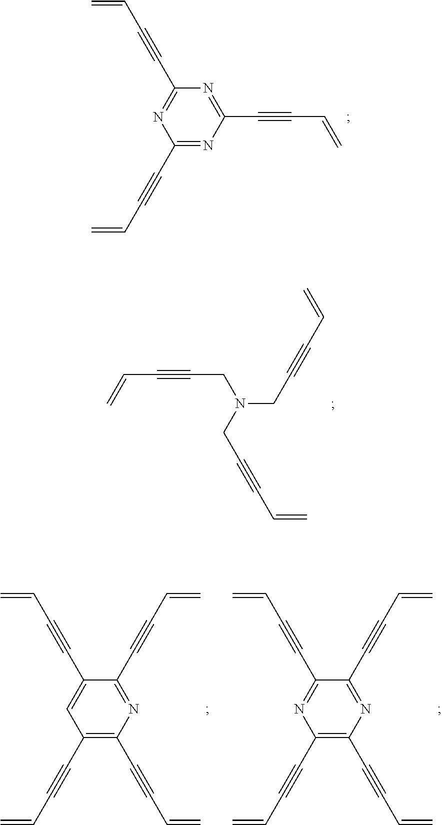

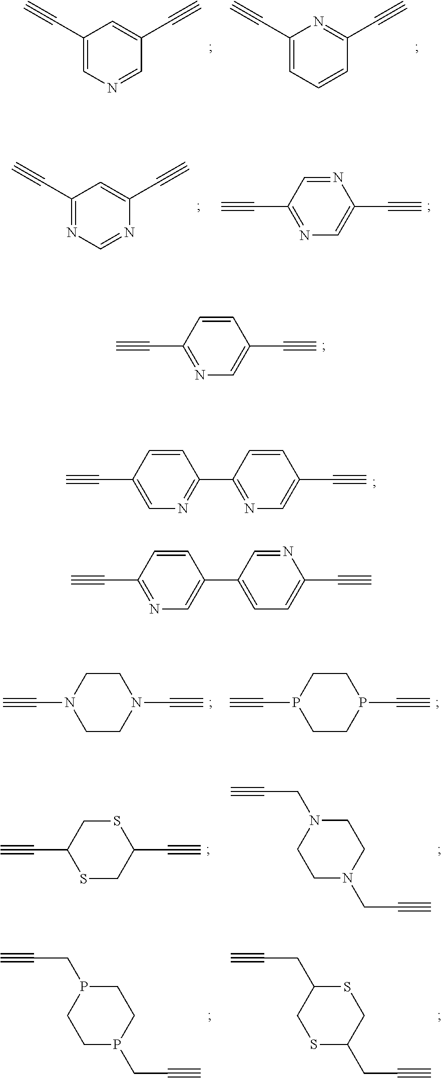

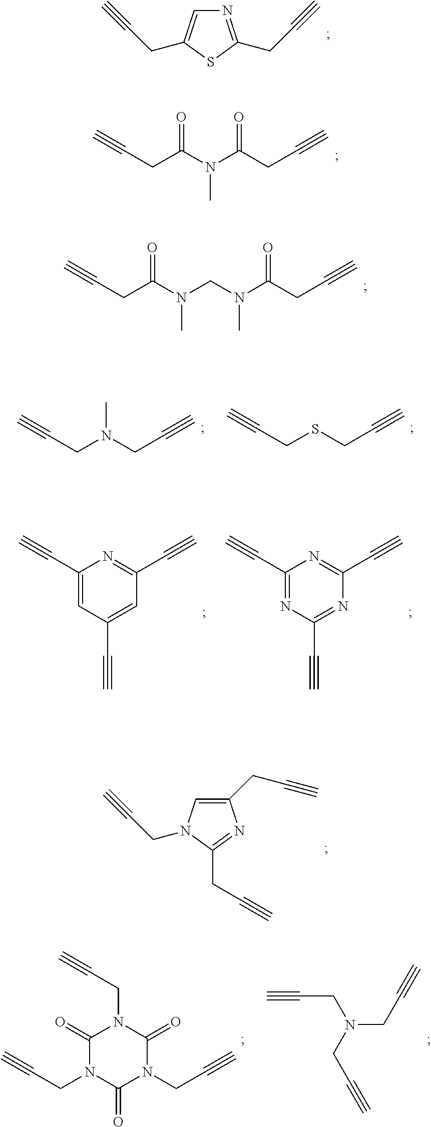

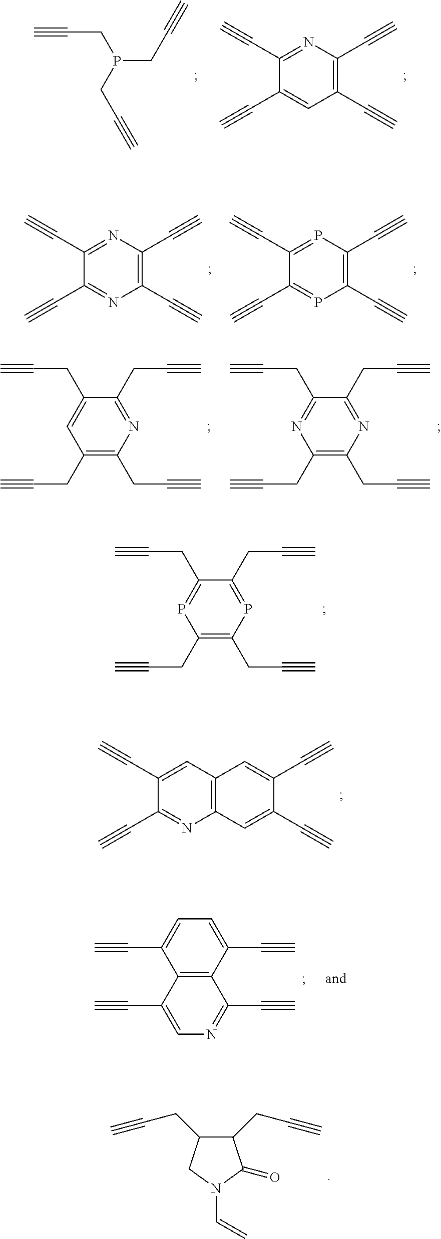

In yet more particular embodiments that may be mentioned herein, the at least one multivalent monomeric material may be selected from one or more of the group consisting of:

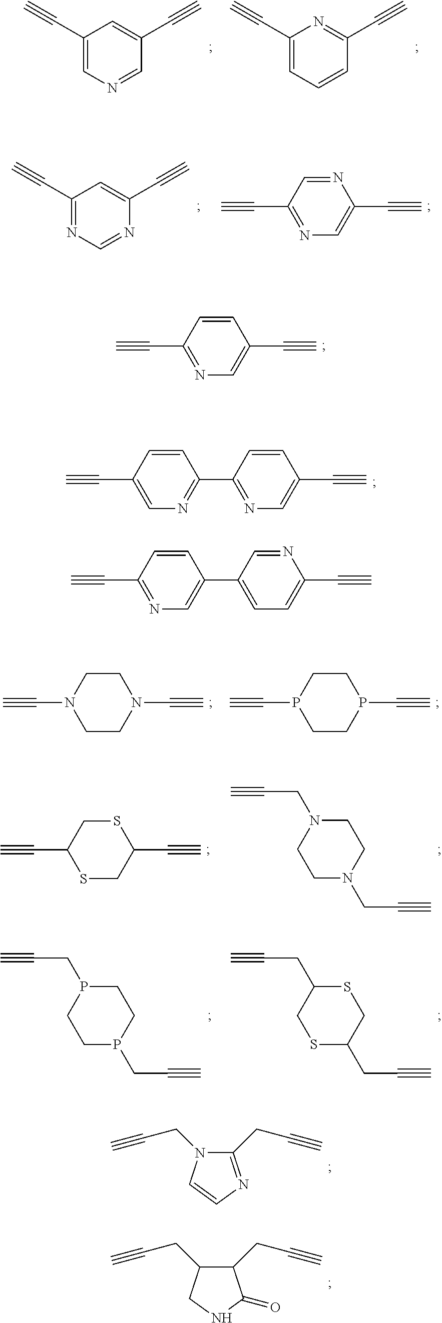

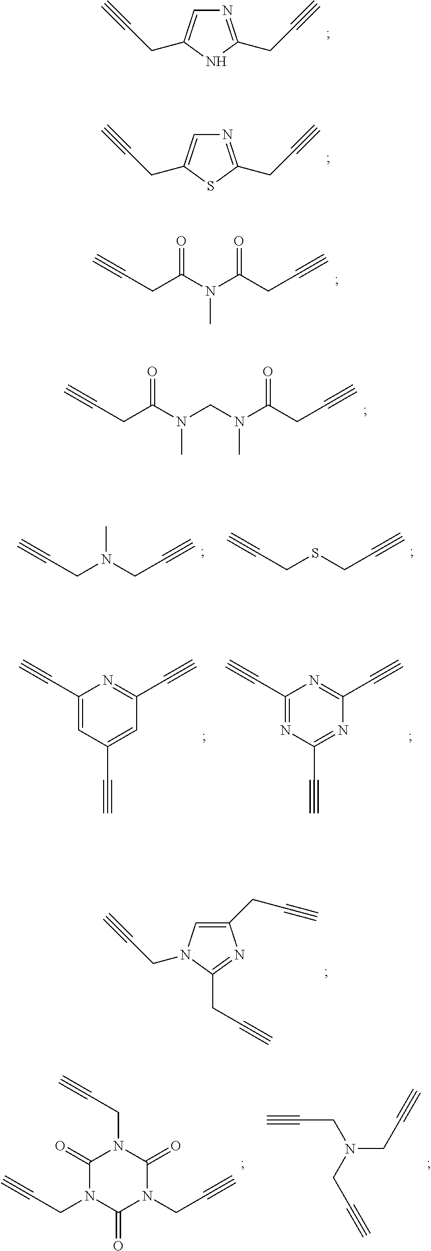

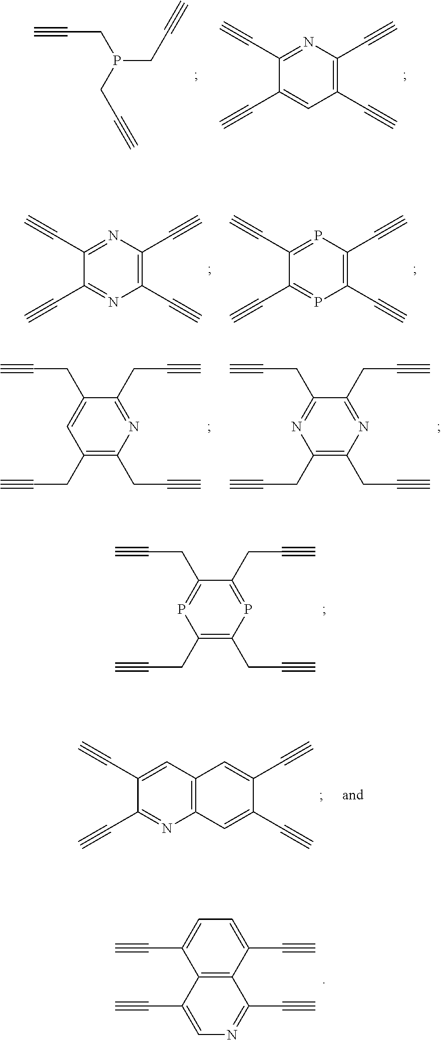

In still more particular embodiments that may be mentioned herein, the at least one multivalent monomeric material may be selected from one or more of the group consisting of:

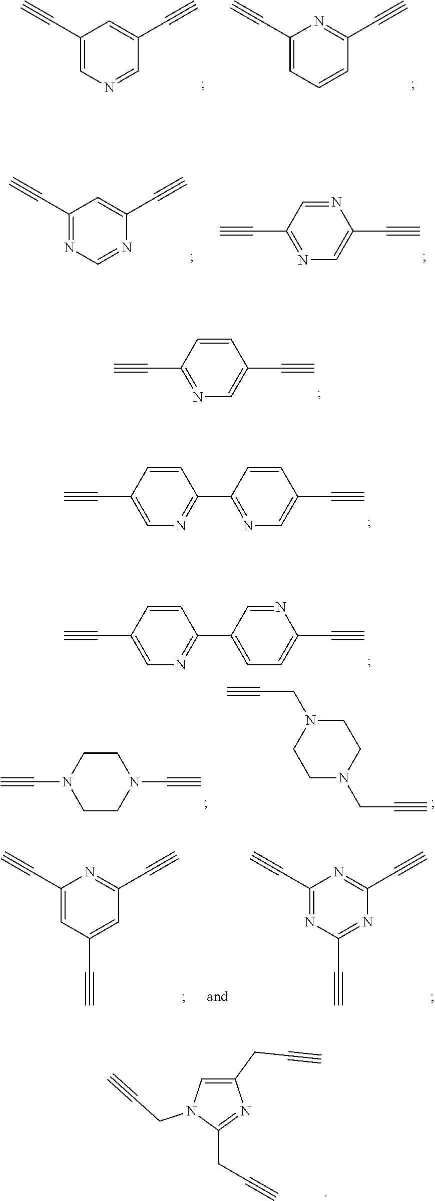

In more particular embodiments that may be mentioned herein, the at least one multivalent monomeric material may be selected from one or more of the group consisting of:

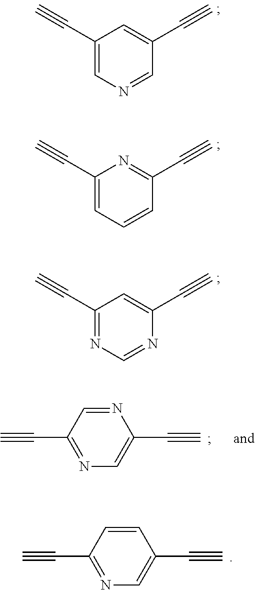

In more particular embodiments, the at least one multivalent monomeric material may be:

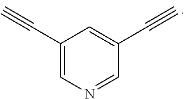

In certain embodiments, the ladder-shaped polymers may be further formed from one or more monomeric materials that has:
one polymerisable functional group selected from acetylene or vinyl functional groups; and
a functional group capable of forming a halogen bond with a halogen atom, selected from one or more of the group consisting of:

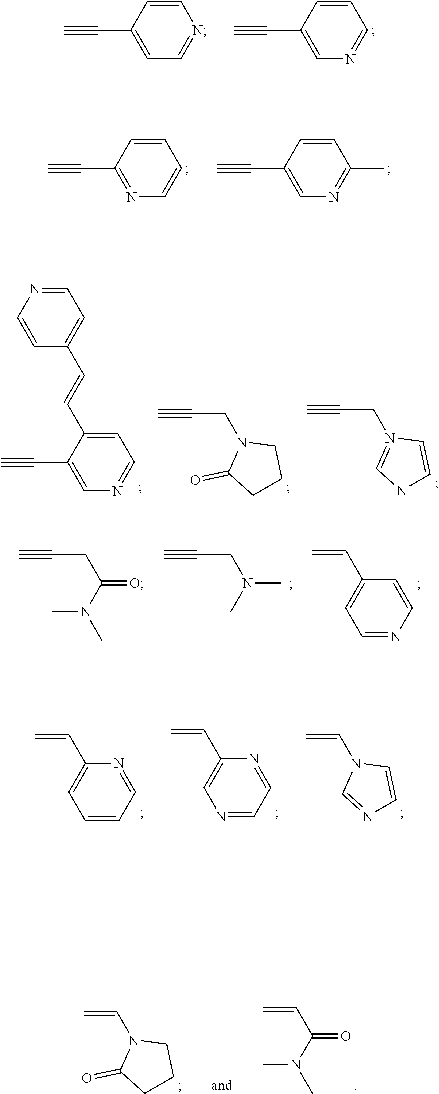

The above monomeric materials may help to change the pore size of the overall material, which may be beneficial in certain circumstances.

The polymeric material disclosed herein may be crystalline. This may be as a large mono-crystal or, more particularly, as multiple crystal grains. Thus, in embodiments of the invention, the polymeric material may have a plurality of pores corresponding to:
voids in the ladder-shaped polymers;
voids between any two nanosheets; and
voids between any two polymer crystals (i.e. between any two of the multiple crystal grains).

The polymeric material disclosed herein may be water insoluble.

As noted hereinbefore, the polymeric materials disclosed herein may be useful for the adsorption of metal ions. Thus, in a further aspect of the invention, there is provided a use of a polymeric material as described herein in the adsorption of Li⁺ and/or B³⁺ ions from an aqueous solution comprising a mixture of ionic species, the mixture of ionic species comprising Li⁺ and/or B³⁺ ions.

In yet a further aspect of the invention, there is provided a method of adsorbing Li⁺ and/or B³⁺ ions from an aqueous solution comprising a mixture of ionic species, the method comprising:
(i) providing an aqueous solution comprising a mixture of ionic species, the aqueous solution comprising at least one of Li⁺ and B³⁺ ions; and
(i) adding a polymeric material as described herein for a period of time to adsorb at least one of Li⁺ and B³⁺ ions from the aqueous solution comprising a mixture of ionic species.

In yet a further aspect of the invention, there is provided a method of manufacturing a polymeric material as described herein, wherein the method comprises the steps of:
(a) providing a solid precursor material comprising:
   an initiator;
   at least one multivalent monomeric material that has two or more polymerisable functional groups selected from one or both of acetylene and vinyl functional groups and a functional group capable of forming a halogen bond with a halogen atom; and
   a linker molecule capable of forming a halogen bond with the at least one multivalent monomeric material; and
(b) subjecting the solid precursor material to free radical solid phase polymerization to generate the polymeric material as described herein, wherein
   the solid precursor material comprises cocrystals or polycrystalline materials formed by a network of the at least one multivalent monomeric material and the halogen bonding linker molecule, which cocrystals or polycrystalline materials are dispersed in the initiator.

In certain embodiments of the invention, step (b) may be followed by a washing step to remove unwanted materials, including the intiator and the halogen bonding linker molecule.

The solid precursor material may be formed by dissolving the initiator, the at least one multivalent monomeric material and the halogen bonding linker molecule in a solvent and removing the solvent over a period of time, optionally wherein:
(ai) the solvent may be dichloromethane; and/or
(aii) the solvent removal may use one or both of evaporation at room temperature and atmospheric pressure and solvent removal under reduced pressure at room temperature.

Any suitable initiator may be used herein. For example, the initiator may be a photoinitiator or a thermal initiator or a mixture of both. In particular embodiments that may be mentioned herein, the initiator may be a photoinitiator.

Examples of particular initiators that may be mentioned herein include, but are not limited to:

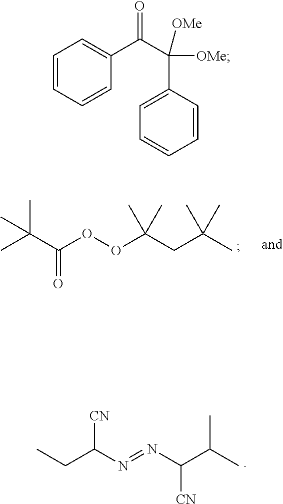

The first of the compounds listed above is a photoinitiator and the remaining two compounds are thermal initiators.

Any suitable material having halogen atoms may be used as the halogen bonding linker molecule. In embodiments that may be mentioned herein, the halogen bonding linker molecule may be selected from one or more of the group consisting of:

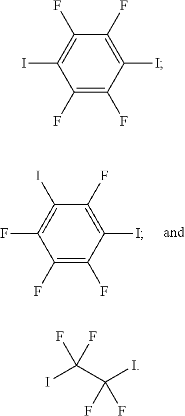 [SMILES: Fc1c(F)c(I)c(F)c(F)c1I ; Fc1c(F)c(I)c(F)c(I)c1F ; FC(F)(I)C(F)(F)I]

As the multivalent monomeric materials are identical to that already discussed for the polymeric material, they are omitted here for brevity.

Further aspects and embodiments of the current invention will now be described by reference to the following non-limiting examples.

### EXAMPLES

### Materials

Pyridyl-3,5-diacetylene (PDA, 1, or 3,5-diethynylpyridine) (>96.0%, Tokyo Chemical Industry (TCI), Japan), 3-pyridylacetylene (3PA) (2) (or 3-ethynyl pyridine) (98%, Sigma Aldrich, USA), 4-pyridylacetylene (4PA) (3) (or 4-ethynyl pyridine) (Aldrich^{CPR}, Sigma Aldrich), pyridyl-2-methyl-5-acetylene (PMA) (4) (or 5-ethynyl-2-methylpyridine) (Aldrich^{CPR}, Sigma Aldrich), (E)-pyridyl-4-[2-(4-pyridinyl) vinyl]-3-acetylene (PPVA) (5) (or (E)-3-ethynyl-4-[2-(4-pyridinyl) vinyl] pyridine) (97%, Sigma Aldrich), 1,4-diiodotetrafluorobenzene (I-C₆F₄—I) (6) (98%, Sigma-Aldrich), 1,3,5-trifluoro-2,4,6-triiodotrifluorobenzene (C₆F₃I₃) (7) (97%, Alfa Aesar, USA), 1,2-diiodotetrafluoroethane (I—(CF₂)₂—I) (8) (96%, Alfa Aesar), 2,2-dimethoxy-2-phenylacetophenone (DMPA) (9) (99%, Sigma-Aldrich), 2,6-dibromopyridine (DBP) (98%, Sigma-Aldrich), 3,5-dibromopyridine (3,5-DBP) (>98%, TCI), tributyl(vinyl) tin (95%, AK Scientific, USA), tetrakis(triphenylphosphine) palladium (0) (Pd(PPh₃)₄) (99%, Sigma-Aldrich), γ-butyrolactone (GBL) (≥99%, Sigma-Aldrich), lithium hydroxide monohydrate (LiOH·H₂O) (99.995% trace metals basis, Sigma-Aldrich), rubidium hydroxide solution (RbOH) (50 wt % in H₂O) (99.9% trace metals basis, Sigma-Aldrich), cesium hydroxide monohydrate (CsOH·H₂O) (99.95% trace metals basis, Sigma-Aldrich), nitric acid (HNO₃) (70%, purified by redistillation) (≥99.999% trace metals basis, Sigma-Aldrich), ammonium tetrafluoroborate (NH₄BF₄) (99.999% trace metals basis, Sigma-Aldrich), dichloromethane (99.8%, Fisher Scientific, USA), ethanol (>99.5%, absolute, Fisher Scientific), diethyl ether (≥99.5%, Fisher Scientific), N,N-dimethylformamide (DMF) (>99.5%, Kanto Chemical, Japan), hexane (>99%, International Scientific, Singapore), anhydrous tetrahydrofuran (THF) (inhibitor-free, ≥99.9%, Sigma-Aldrich), deuterated chloroform (CDCl₃) (99.8% D, Cambridge Isotope Laboratories, USA), deuterated dimethyl sulfoxide (DMSO-d₆) (99.9% D, Cambridge Isotope Laboratories), α,α,α-trifluorotoluene (C₆H₅CF₃) (≥99%, Sigma-Aldrich), lithium bromide (LiBr) (>99%, TCI), and potassium bromide (KBr) (≥99%, trace metals basis, Sigma-Aldrich) were used as received. A silicon (Si) wafer (produced by Czochralski process, thickness: 525±25 μm) was purchased from Matsuzaki Seisakusho (Japan).

### Analytical Techniques

### Nuclear Magnetic Resonance (NMR) Spectroscopy

¹H NMR spectra were recorded at room temperature on a Bruker (Germany) BBFO400 spectrometer (400 MHz), and AV400 spectrometer (400 MHz). ¹⁹F NMR spectra were recorded at room temperature on a Bruker BBFO400 spectrometer (376 MHz). CDCl₃ and DMSO-de were used as NMR solvents. The residual non-deuterated solvents were used as the internal standards for 1H NMR analysis (calibration of chemical shift). C₆H₅CF₃ was added as the internal standard for 19F NMR analysis (calibration of chemical shift).

### Gel Permeation Chromatography (GPC)

The gel permeation chromatography (GPC) analysis was performed on a Shimadzu (Kyoto, Japan) LC-2030C Plus liquid chromatograph equipped with two Shodex LF-804 columns (300×8.0 mm; bead size=6 μm; pore size=1500 Å) and one Shodex KD-802 column (300×8.0 mm; bead size=6 μm; pore size=150 Å). The eluent was DMF (containing 10 mM of LiBr) at a flow rate of 0.34 mL/min (40° C.). Sample detection was conducted using a Shimadzu differential refractometer detector RID-20A. The column system was calibrated with standard polystyrenes.

### Fourier-Transform Infrared (FTIR) Spectroscopy

FTIR spectroscopy was carried out on a Bruker ALPHA FTIR spectrometer. KBr was used as a matrix for FTIR. FTIR was used for analysing the polymer solids after the polymerization.

### SEM

SEM images were obtained on a JSM-7600F Schottky field emission scanning electron microscope (JOEL, Japan) operated at 5 kV.

### UV Radiation

The UV light source was a UV-LED light (365 (±10) nm wavelength and 900 mW/cm² intensity) (C11924-101 and C14052-0-A5 models (Hamamatsu Photonics, Japan)).

### Atomic Force Microscopy (AFM)

The AFM images were obtained with a MultiMode Scanning Probe Microscope (Bruker) in the ScanAsyst™ mode using a cantilever (ScanAsyst-Air, Bruker).

### TEM

The TEM images were obtained with a JEOL (Tokyo, Japan) TEM-1400 transmission electron microscope operated at 100 kV. The TEM grid was carbon-coated on 200 mesh (copper (Cu)) (Ted Pella, Redding, US).

### TGA

The thermal analyses of the polymers were performed on a TGA Q500 model device (TA instrument, New Castle, US).

### Single Crystal XRD

Single crystal X-ray diffraction frames were analysed with a Bruker D8 QUEST (Bruker) and integrated with the Bruker SAINT software package using a narrow-frame algorithm. The data were corrected for absorption effects using the Multi-Scan method (SADABS). The structures were solved by XT VERSION 2014/5 and refined by SHELXL-2017/1 (Sheldrick, 2017) programs, respectively. The refinement was carried out by full-matrix least-squares on F². Hydrogen atoms were placed using standard geometric models and with their thermal parameters riding on those of their parent atoms.

### Example 1. General Procedure for Preparation of Cocrystals Using Monomers (1-5), XB Linkers (6-8), and Initiator (DMPA, 9) Via Evaporation Method (Le, H. T., Wang, C. G. & Goto, A., Angew. Chem. Int. Ed. 2020, 59, 9360-9364)

Monomers 1-5, XB linkers 6-8 (N/I molar ratio=1/1), and initiator (DMPA, 9) were dissolved in dichloromethane in a flask. Typically, monomer 1 (0.127 g, 1.00 mmol) and XB linker 6 (0.201 g, 0.50 mmol) or XB linker 7 (0.170 g, 0.333 mmol) or XB linker 8 (0.177 g, 0.50 mmol) were dissolved in dichloromethane (2.50 mL) in a flask. For example, monomer 1 (0.10 g, 0.79 mmol), XB linker 6 (0.16 g, 0.39 mmol) (N/I molar ratio=1/1), and DMPA (67.0 mg, 0.26 mmol) were dissolved in dichloromethane (2 mL) in a flask. Slow evaporation of dichloromethane was performed using a rotary evaporator (Hei-VAP Precision, Heidolph, Germany) under constant pressure (200 mbar) and rotation speed (10 rpm), yielding cocrystals after complete evaporation of dichloromethane.

### Characterisation

The cocrystal monomers were characterized with X-ray single-crystal crystallography, ¹H NMR, and ¹⁹F NMR. The NMR analyses of the (co-)crystals were conducted by dissolving the cocrystals in CDCl₃.

Co-crystal of PDA and I-C₆F₄—I (1·6). A white solid. ¹⁹F NMR (376 MHZ, CDCl₃): δ −119.11 ppm. ¹H NMR (400 MHZ, CDCl₃): δ 8.63 (d, J=2.00 Hz, 2H, ═CH—N═CH—), 7.83 (t, J=2.00 Hz, 1H, —C(CH)═CH—C(CH)═), 3.23 (s, 2H, —C≡CH) ppm. The ¹⁹F and ¹H NMR analyses confirmed the co-presence of the monomer and XB linker in the cocrystal.

Co-crystal of PDA and I—(CF₂)₂—I (1·7). A white solid. ¹⁹F NMR (376 MHZ, CDCl₃): 0-119.11 ppm. ¹H NMR (400 MHZ, CDCl₃): δ 8.64 (d, J=1.88 Hz, 2H, ═CH—N═CH—), 7.84 (t, J=1.92 Hz, 1H, —C(CH)═CH—C(CH)═), 3.24 (s, 2H, —C≡CH) ppm.

Co-crystal of PDA and C₆F₃I₃ (1.8). A white solid. 19F NMR (376 MHZ, CDCl₃): δ −119.10 ppm. ¹H NMR (400 MHZ, CDCl₃): δ 8.64 (d, J=2.00 Hz, 2H, ═CH—N═CH—), 7.84 (t, J=2.00 Hz, 1H, —C(CH)═CH—C(CH)═), 3.24 (s, 2H, —C═CH) ppm.

### Results and Discussion

Dichloromethane would initially evaporate relatively quickly. Once the solution has been saturated, cocrystals began to form. Because the solution was not pure dichloromethane but a mixture of monomer, linker, photo-initiator, and solvent, the evaporation gradually slowed down and needed a reduced pressure to completely remove the solvent. The low rotation speed (10 rpm) would prevent vibrations to the solution and was applied not to disturb the growth of the cocrystals.

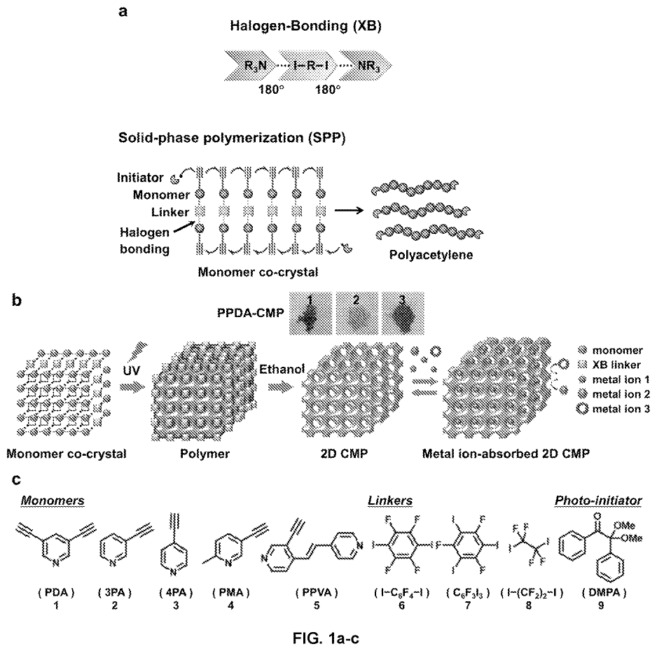

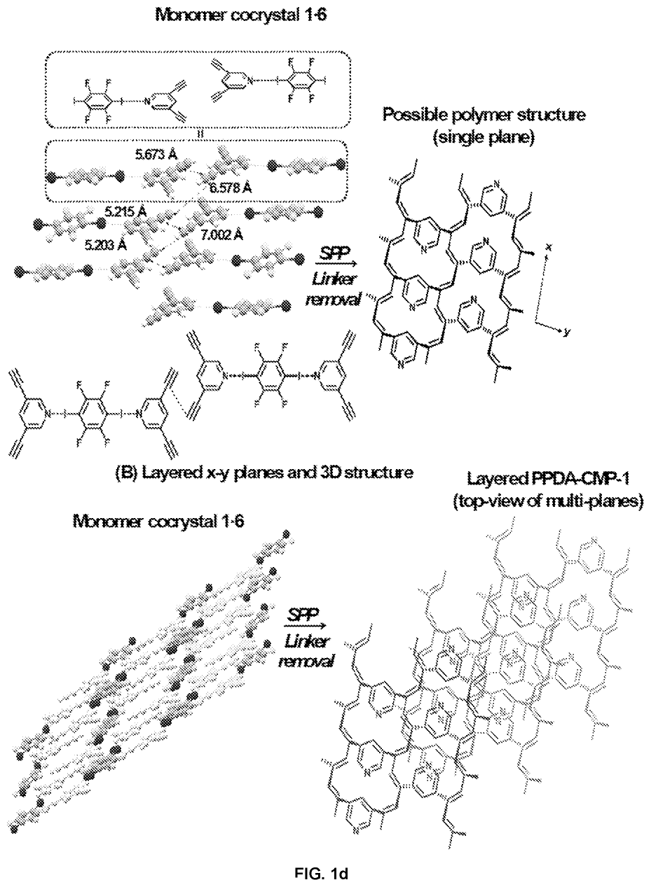

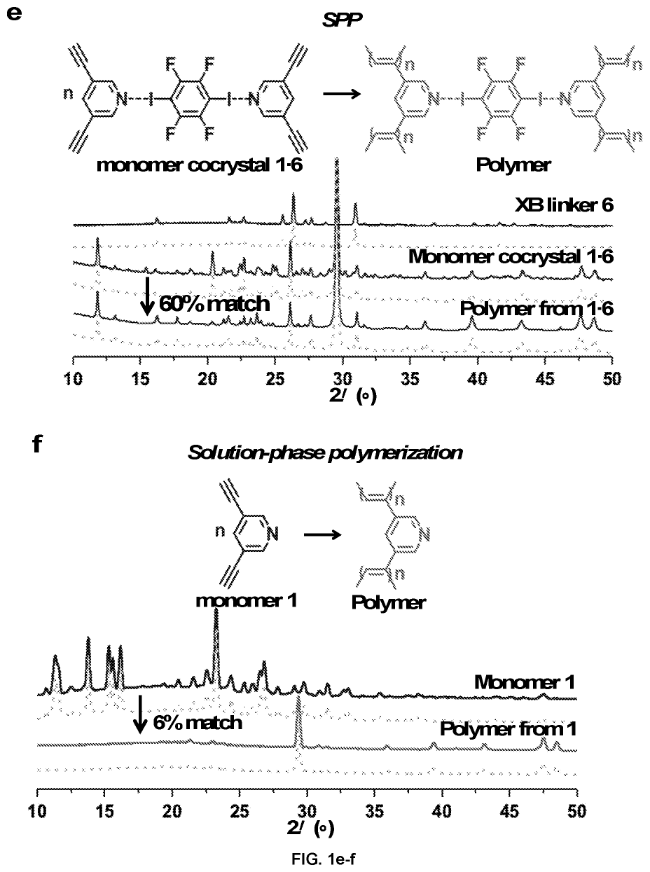

The studied monomers (FIG. 1c) are pyridyl-3,5-diacetylene (PDA) (1), 3-pyridylacetylene (3PA) (2), 4-pyridylacetylene (4PA) (3), pyridyl-2-methyl-5-acetylene (PMA) (4), and (E)-pyridyl-4-[2-(4-pyridinyl) vinyl]-3-acetylene (PPVA) (5). The studied XB linkers (FIG. 1c) are 1,4-diiodotetrafluorobenzene (I-C₆F₄—I) (6), 1,3,5-trifluoro-2,4,6-triiodotrifluorobenzene (C₆F₃I₃) (7), and 1,2-diiodotetrafluoroethane (I—(CF₂)₂—I) (8). XB can be formed between a nitrogen (N) atom in the monomer and an iodine (I) atom in the linker. All of the compounds 1-8 are commercially available. We mixed a monomer (1-3 eq.), a linker (1 eq.), and a photo-initiator (2,2-dimethoxy-2-phenyl-acetophenone (DMPA, 9) (FIG. 1c) (0.67 eq.) in dichloromethane (solvent), setting equimolar atoms of N and I for stoichiometric XB formation. We evaporated the solvent from the mixture and obtained solids in gram scales.

We studied the combinations of 1 with 6 (1·6), 7 (1·7), and 8 (1·8), 2 with 6 (2·6) and 7 (2·7), 3 with 6 (3·6), 4 with 6 (4·6), and 5 with 6 (5·6). The combinations 1.7 and 1.8 did not form single cocrystals, generating polycrystalline solids. The other six combinations generated single cocrystals, and their single-crystal X-ray diffraction analyses showed that the cocrystals contained the monomer and linker. DMPA was not observed in the single-crystal X-ray structures, meaning that the monomer and linker formed cocrystals (78.0-82.7 wt %) that were dispersed in amorphous DMPA (17.3-22.0 wt %).

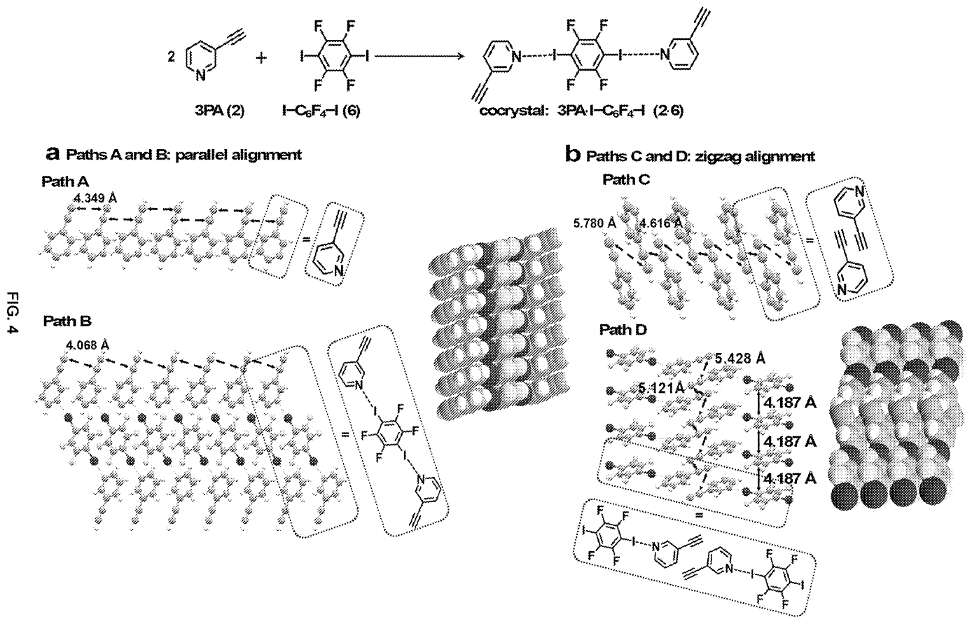

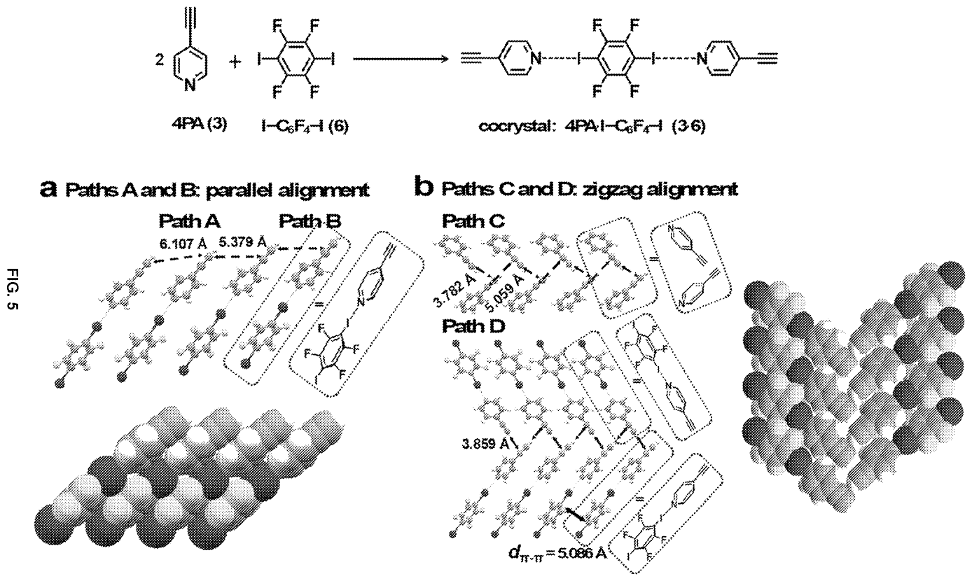

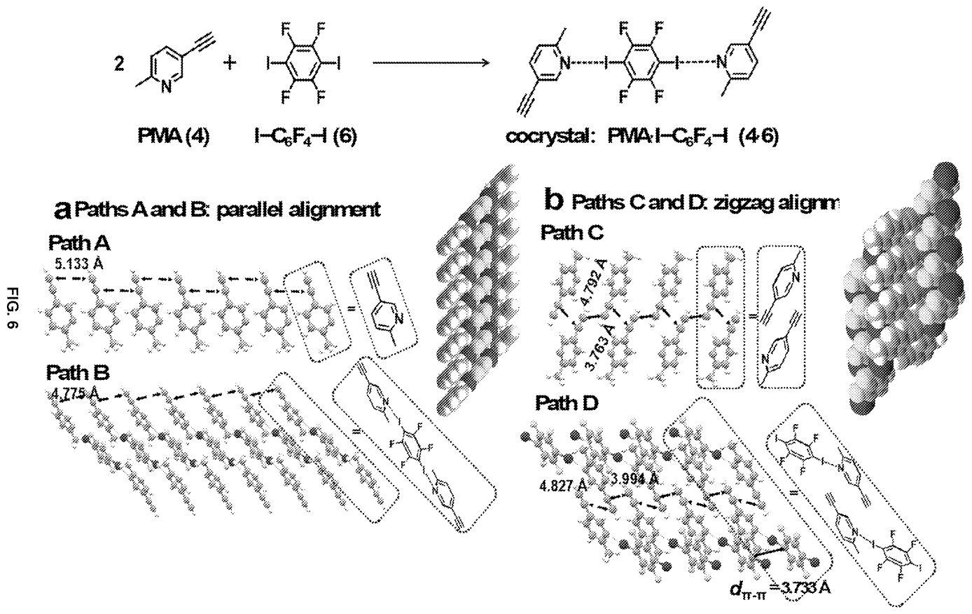

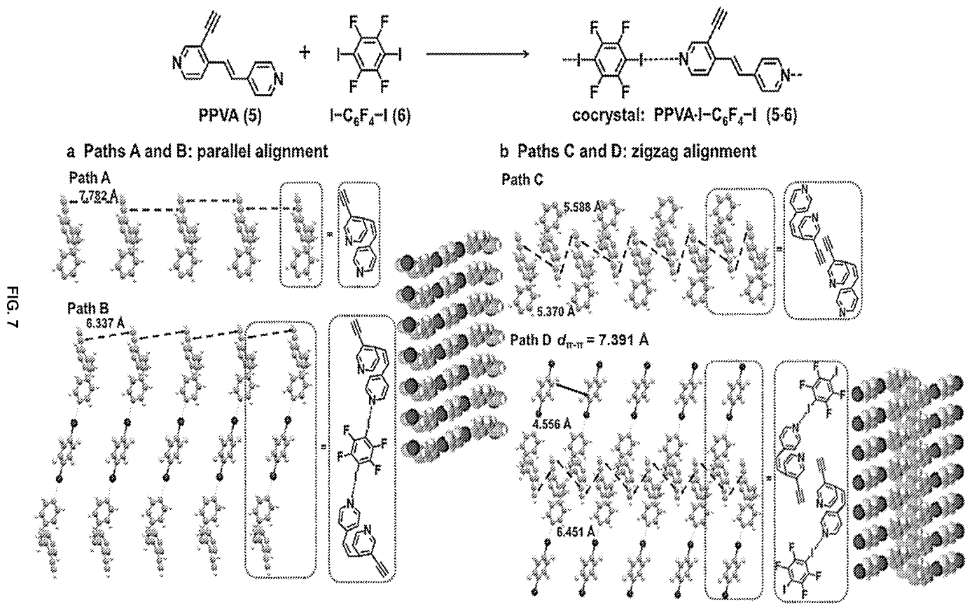

The aromatic linkers (6 and 7) were regularly aligned via the TT-TT stacking, and the monomers were thereby aligned along with the linkers via XB (FIGS. 1d and 3-8). The carbon-carbon distances between two adjacent C≡C groups (3.4-7.0 Å in Table 1) were sufficiently short for the propagation to occur in all cases. The distances (3.4-7.0 Å) are not interatomic distances for reactions (van der Waals radii typically <4.0 Å for an effective orbital overlap) but interatomic distances between the two reactive carbons in the cocrystal lattices. In topochemical polymerizations, the interatomic distances in the cocrystal lattices are close to van der Waals radii. The present polymerization is not topochemical polymerization but free-radical polymerization. The propagating polymer chain end would move to approach the neighboring monomer, although the exact motion is not clear. Upon the polymerization, the interatomic distances would become shorter, resulting in slight deformation in the cocrystal structure.

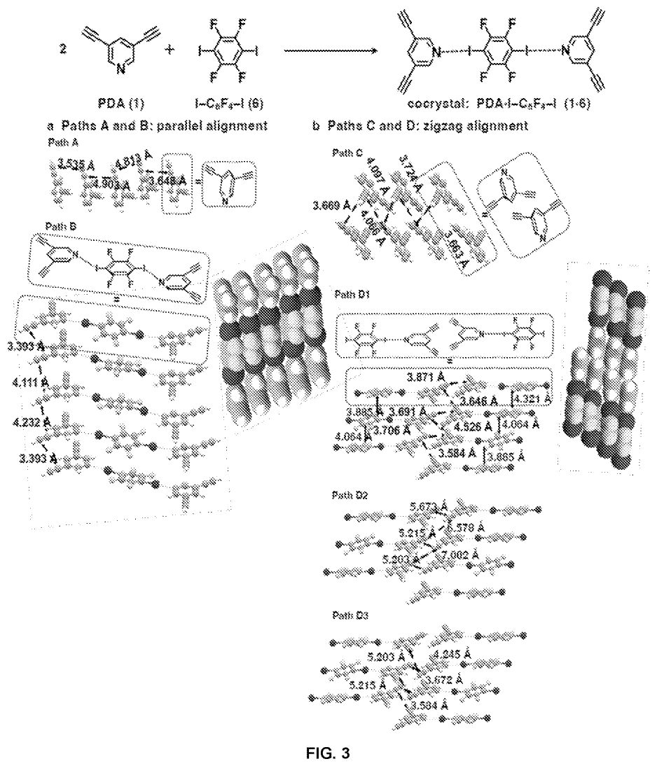

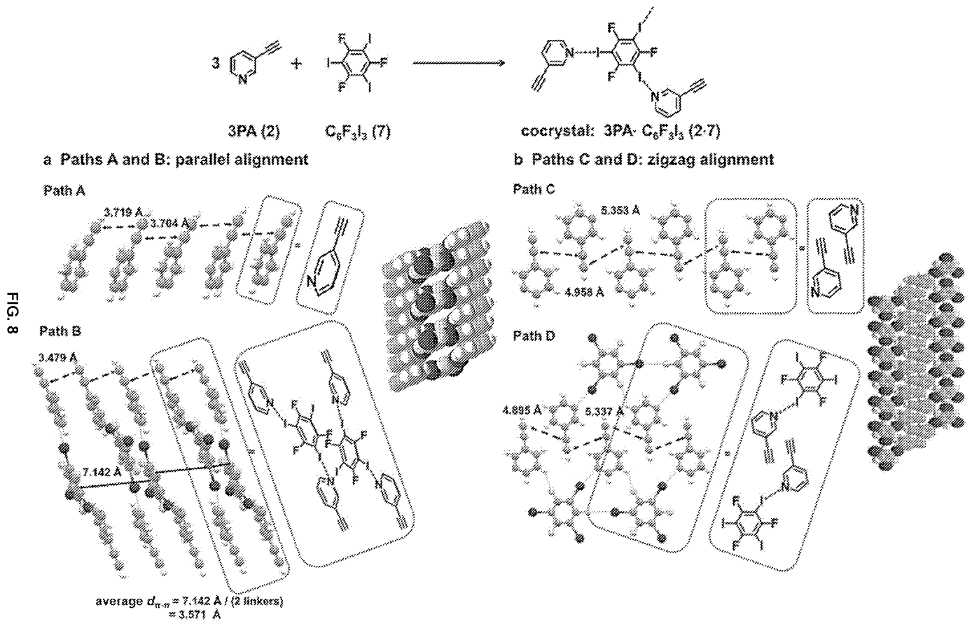

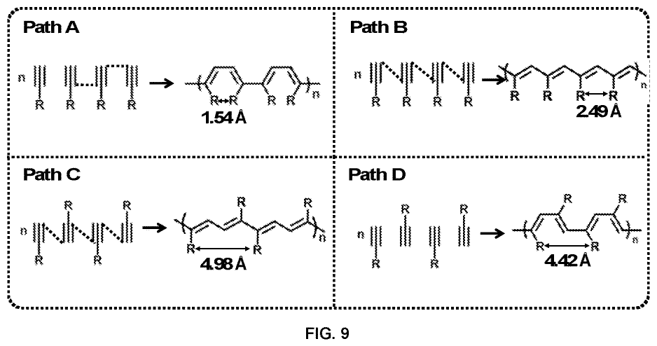

TABLE 1
Single-crystal X-ray crystallography data of monomer cocrystals (FIGS. 3-8) and four possible
monomer addition (propagation) patterns that can occur inside the cocrystals (FIG. 9).

| | Co- | | d_{C≡C adjacent} (Å)^{b} | | | | |
|---|---|---|---|---|---|---|---|
| Entry | crystal | d_{π-π} (Å)^{a} | Path A | Path B | Path C | Path D | R %^{c} |
| 1 | 1•6 | 3.885-4.321 | 3.535-4.813 (tt) | 3.393-4.232 (ht) | 3.663-3.724 (tt) | 3.584-7.002 (ht) | 4.58 |
| | | | 3.648-4.903 (hh) | | 4.066-4.097 (hh) | | |
| 2 | 2•6 | 4.187 | 4.349 (tt, hh) | 4.068 (ht) | 5.780 (tt) | 5.121 (ht shorter) | 4.72 |
| | | | | | 4.616 (hh) | 5.428 (ht longer) | |
| 3 | 3•6 | 5.086 | 6.107 (tt, hh) | 5.379 (ht) | 3.782 (tt) | 3.859 (ht) | 5.49 |
| | | | | | 5.059 (hh) | | |
| 4 | 4•6 | 3.733 | 5.133 (tt, hh) | 4.775 (ht) | 3.763 (tt) | 3.994 (ht shorter) | 3.64 |
| | | | | | 4.792 (hh) | 4.827 (ht longer) | |
| 5 | 5•6 | 7.391 | 7.782 (tt, hh) | 6.337 (ht) | 5.370 (tt) | 4.556 (ht shorter) | 4.13 |
| | | | | | 5.588 (hh) | 6.451 (ht longer) | |
| 6 | 2•7 | 3.571 | 3.719 (tt) | 3.479 (ht) | 5.353 (tt) | 4.895 (ht shorter) | 3.37 |
| | | | 3.704 (hh) | | 4.958 (hh) | 5.337 (ht longer) | |

^{a}π-π distance between two linkers (average π-π distance between two linkers for entry 6).
^{b}hh = head-to-head, tt = tail-to-tail, and ht = head-to-tail.
^{c}R % is the R-factor in refinement using Bruker SHELXTL software, showing the discrepancy index between the experimental X-ray diffraction data and crystallographic model.
Normally, R % less than 10% indicates a good fit.

TABLE 2
Single-crystal X-ray crystallography data and structure refinement for monomer cocrystals.^{a}

| | PDA•I—C₆F₄—I | | 3PA•I—C₆F₄—I | | 4PA•I—C₆F₄—I | | PMA•I—C₆F₄—I | | PPVA•I—C₆F₄—I | | 3PA•C₆F₃I₃ | |
|---|---|---|---|---|---|---|---|---|---|---|---|---|
| Cocrystal monomer | (1•6) | | (2•6) | | (3•6) | | (4•6) | | (5•6) | | (2•7) | |
| Empirical formula | C₃₉H₁₅F₈I₄N₃ | | C₂₀H₁₀F₄I₂N₂ | | C₁₃H₅F₄I₂N | | C₁₁H₇F₂IN | | C₂₃H₁₀F₆I₃N₂ | | C₂₀H₁₀F₃I₃N₂ | |
| Crystal habit | Colorless | | Colorless | | Colorless | | Colorless | | Colorless | | Colorless | |
| | block | | plate | | needle | | needle | | block | | plate | |
| Formula weight | 1185.14 | g mol⁻¹ | 608.10 | g mol⁻¹ | 504.98 | g mol⁻¹ | 318.08 | g mol⁻¹ | 809.03 | g mol⁻¹ | 716.00 | g mol⁻¹ |
| Crystal system | Triclinic | | Triclinic | | Monoclinic | | Monoclinic | | Triclinic | | Monoclinic | |
| Space group | P-1 | | P-1 | | P 1 21 1 | | P 1 21/n 1 | | P-1 | | C 1 2/c 1 | |
| Unit cell dimensions | a = 10.8574 | | a = 4.3494 | | a = 15.7878 | | a = 5.1327 | | a = 7.7820 | | a = 31.2256 | |
| | (±0.0005) Å | | (±0.0013) Å | | (±0.0006) Å | | (±0.0002) Å | | (±0.0003) Å | | (±0.0010) Å | |
| | b = 12.5022 | | b = 8.693 | | b = 6.1075 | | b = 11.6109 | | b = 13.2748 | | b = 9.2010 | |
| | (±0.0005) Å | | (±0.003) Å | | (±0.0002) Å | | (±0.0005) Å | | (±0.0005) Å | | (±0.0003) Å | |
| | c = 15.9721 | | c = 13.848 | | c = 21.8459 | | c = 18.6949 | | c = 13.3139 | | c = 7.4040 | |
| | (±0.0007) Å | | (±0.004) Å | | (±0.0008) Å | | (±0.0009) Å | | (±0.0004) Å | | (±0.0002) Å | |
| | α = 86.580 | | α = 90.158 | | α = 90° | | α = 90° | | α = 112.7531 | | α = 90° | |
| | (±0.002)° | | (±0.009)° | | β = 101.122 | | β = 96.6396 | | (±0.0012)° | | β = 100.7467 | |
| | β = 74.824 | | β = 96.904 | | (±0.002)° | | (±0.0016)° | | β = 100.3998 | | (±0.0012)° | |
| | (±0.002)° | | (±0.008)° | | γ = 90° | | γ = 90° | | (±0.0012)° | | γ = 90° | |
| | γ = 67.044 | | γ = 104.072 | | | | | | γ = 96.2329 | | | |
| | (±0.002)° | | (±0.009)° | | | | | | (±0.0012)° | | | |
| Volume | 1924.55 | | 503.9 | | 2066.91 | | 1106.66 | | 1223.15 | | 2089.91 | |
| | (±0.15) Å³ | | (±0.3) Å³ | | (±0.13) Å³ | | (±0.08) Å³ | | (±0.08) Å³ | | (±0.11) Å³ | |
| Z | 2 | | 1 | | 6 | | 4 | | 2 | | 4 | |
| Density (calculated) | 2.045 | g cm⁻³ | 2.004 | g cm⁻³ | 2.434 | g cm⁻³ | 1.909 | g cm⁻³ | 2.197 | g cm⁻³ | 2.276 | g cm⁻³ |
| Absorption coefficient | 3.310 | mm⁻¹ | 3.164 | mm⁻¹ | 4.598 | mm⁻¹ | 2.886 | mm⁻¹ | 3.893 | mm⁻¹ | 4.521 | mm⁻¹ |

| F(000) | 1108 | 286 | 1392 | 604 | 750 | 1320 |
|---|---|---|---|---|---|---|
| Crystal size | 0.060 × 0.100 × | 0.040 × 0.220 × | 0.020 × 0.040 × | 0.020 × 0.040 × | 0.080 × 0.120 × | 0.020 × 0.200 × |
| | 0.120 mm³ | 0.240 mm³ | 0.280 mm³ | 0.220 mm³ | 0.126 mm³ | 0.240 mm³ |
| Theta range for data | 2.11 to 34.96° | 1.48 to 27.00° | 1.90 to 36.34° | 2.19 to 41.26° | 2.71 to 36.35° | 2.66 to 32.70° |
| collection | | | | | | |
| Completeness to θfull | 99.7% | 99.5% | 99.7% | 99.6% | 99.5% | 98.0% |
| Reflections collected | 65250 | 5858 | 101700 | 32036 | 47190 | 3766 |
| Rᵢₙₜ | 0.0865 | 0.0480 | 0.0491 | 0.0544 | 0.0532 | 0.0468 |
| Independent reflections | 16861 | 2202 | 12160 | 7401 | 11831 | 12359 |
| Data/restrains/parameters | 16861/0/487 | 2202/0/127 | 12160/1/542 | 7401/0/137 | 11831/0/307 | 3766/0/129 |
| Goodness-of-fit on F² | 0.955 | 1.129 | 1.138 | 1.038 | 1.050 | 1.030 |
| Final R indices | R₁ = 0.0458 | R₁ = 0.0472 | R₁ = 0.0549 | R₁ = 0.0364 | R₁ = 0.0413 | R₁ = 0.0337 |
| [I > 2σ(I)] | wR₂ = 0.0705 | wR₂ = 0.1141 | wR₂ = 0.0937 | wR₂ = 0.0636 | wR₂ = 0.0635 | wR₂ = 0.0547 |
| Final R indices [all data] | R₁ = 0.1101 | R₁ = 0.0567 | R₁ = 0.0773 | R₁ = 0.0602 | R₁ = 0.0742 | R₁ = 0.0600 |
| | wR₂ = 0.0857 | wR₂ = 0.1210 | wR₂ = 0.1043 | wR₂ = 0.0734 | wR₂ = 0.0745 | wR₂ = 0.0614 |
| Largest diff. peak and | 1.153 and | 2.439 and | 1.646 and | 1.222 and | 2.287 and | 0.795 and |
| hole | −1.390 eÅ⁻³ | −1.071 eÅ⁻³ | −1.475 eÅ⁻³ | −1.718 eÅ⁻³ | −2.213 eÅ⁻³ | −0.787 eÅ⁻³ |

^{a}All the X-ray intensity data were measured at the temperature 100 (±2) K and wavelength λ = 0.71073 Å, with Multi-Scan absorption
correction.

### Example 2. Monomer Alignments and Four Possible Monomer Addition (Propagation) Patterns

Table 1 shows four possible monomer addition (propagation) patterns, i.e., path A (parallel alignment+head-to-head and tail-to-tail propagation), path B (parallel alignment+head-to-tail propagation), path C (zigzag alignment+head-to-head and tail-to-tail propagation), and path D (zigzag alignment+head-to-tail propagation). Table 1 shows single-crystal X-ray crystallography data. The p-p distance between two linkers, hence the distance of two pyridyl (R) groups of monomers, was 3.571-7.391 Å. The propagation in the parallel alignment (paths A and B) will give R-R distances of 1.54-2.49 Å in the generated polymers, which are much shorter than the original R-R distances (3.571-7.391 Å) (hence p-p distances) in the monomer cocrystals and will cause significant deformation of the crystal structures. Therefore, paths A and B might occur but would not be major paths in the present polymerizations. The propagation in the zigzag alignment (paths C and D) will give parallel (every other) R-R distances of 4.42-4.98 Å in the generated polymers, which are close to the original parallel R-R distances (3.571-7.391 Å) (hence p-p distances) in the monomer cocrystals and will suppress the deformation of the crystal structures. Therefore, paths C and D would be more likely to occur than paths A and B. Electronically and sterically, path D (head-to-tail propagation) would be more favorable than path C (head-to-head and tail-to-tail propagation). This is because, in path D, the electron-rich and sterically hindered propagating radical carbon (with an electro-donating R group) can react with an acetylene monomer at the electron-deficient and sterically less hindered tail carbon (C—H) rather than the electron-rich and sterically more hindered head carbon (C—R). Thus, path D would be favorable. However, other paths (A-C) might also occur to some extents.

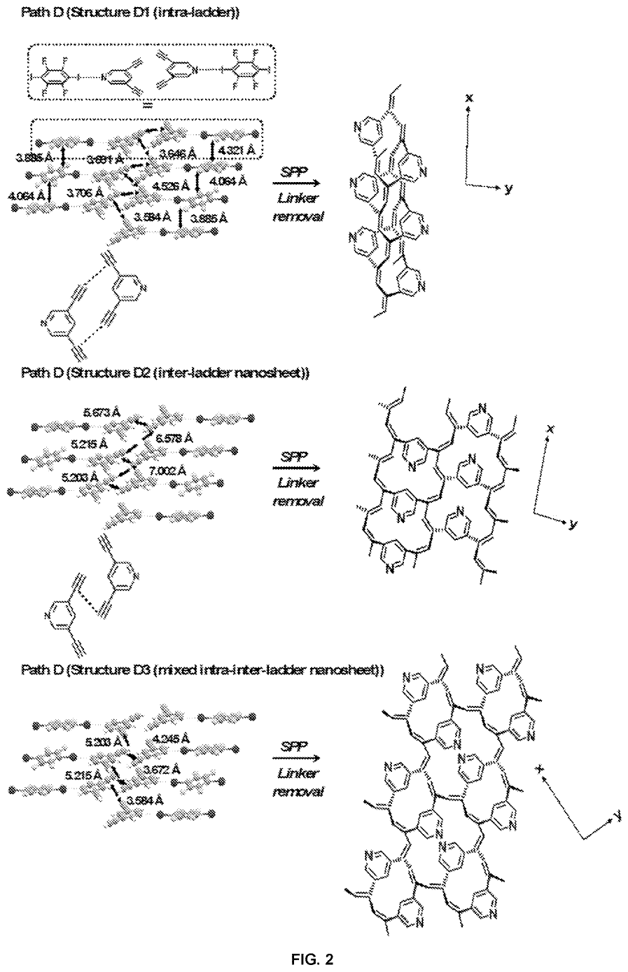

For the di-acetylene monomer (1), path D can occur in two ways because two acetylenes are present in one monomer (FIG. 2). In one way, monomers are linked in a face-to-face manner, where two monomers are bridged via two bonds, forming an intra-ladder (single ladder) polymer structure (structure D1 in FIG. 2). In another way, monomers are linked in a staggered manner, where one monomer is linked with one monomer via one bond and another monomer via another bond, forming an inter-ladder polymer nanosheet structure (structure D2 in FIG. 2). These two ways might also operate in mixed manners, forming mixed intra-inter-ladder polymer nanosheet structures; an example is structure D3 in FIG. 2. Experimentally, we observed polymer nanosheets (as described in the manuscript), and hence the structures would not be a pure form of structure D1 but be structure D2 and mixed structures exemplified by structure D3. We put structure D2 in FIG. 1d as a guide. It should be noted that other structures might also be formed. Different propagation patterns (paths A-D) and formation of mixed structures exemplified by structure D3 might occur simultaneously. Also, there might be defects in the monomer cocrystal structures. Thus, structure D2 is viewed as one of the probable structures (FIG. 2).

Meanwhile, monomer addition patterns (head/tail configuration) would mostly be determined by the alignment of monomers, because monomer re-alignment (entire molecular rotation) in the cocrystals would hardly occur due to the limited freedom. Polyacetylenes consist of sp² carbons in the backbones and hence are rigid. Therefore, mobility of the chain end radical is restricted, which would also assist the retention of monomer alignment structures in the polymer structures.

### Example 3. Radical SPP of Monomer Cocrystals to Give PPDA-CMPs

### UV Irradiation to Two-Component Cocrystal Monomers

The two-component cocrystal monomers of monomers 1-5 and XB linkers 6-8 were prepared with vaporization method as described in Example 1 except without photo-initiator DMPA. The obtained cocrystal monomers were put in a vial. The vial was capped with a rubber septum, and oxygen was removed with an argon flow for 10 min. The cocrystal monomers were then irradiated with UV light (λ=365 nm) at room temperature for 40 h.

### Characterisation

The irradiated samples were then analysed with 1H NMR and GPC, showing no formation of polymers for all studied cases.

### Moulding of Cocrystal Monomers

The cocrystal monomers were moulded using 2T Mini-Pellet Press (Specac, UK) to form sheets with a diameter of 7 mm. The polymers for the resistivity measurements were pressed into thin films with a diameter of 13 mm using 15T Manual Hydraulic Press (Specac).

Photo-SPP of Three-Component Cocrystal Monomers (Le, H. T., Wang, C. G. & Goto, A., Angew. Chem. Int. Ed. 2020, 59, 9360-9364)

The cocrystal solid powder obtained above was moulded using a 2T mini-hand hydraulic press to form a round-shape sheet with a diameter of 7 mm. The sheet was put in a vial. The vial was capped with a rubber septum, and oxygen was removed with an argon flow for 10 min. The sheet was irradiated with UV light (λ=365 nm) at room temperature for 40 h. DMPA gradually decomposed to continuously supply radicals under 365 nm UV LED during the polymerization rather than to generate radicals in a bursting manner. In the present study, DMPA was sufficient to attain nearly quantitative monomer conversions. (We also studied the SPP of 1·6 at varied polymerization time (0.25-40 h) and with varied amounts of photo-initiator (0.01-0.67 equiv to linker and 0.005-0.335 equiv to the monomer) (Table 3). The polymers formed at shorter times (0.25, 3, 7, and 24 h) and smaller amounts of photo-initiator (0.01 and 0.10 equiv to linker (0.005 and 0.05 equiv to monomer, respectively)) did not reach high monomer conversions or retain the grain (cocrystal) structures, suggesting that the SPP for 40 h with 0.67 equiv of DMPA to linker (0.335 equiv to monomer) is an optimal SPP condition.) The sheet was washed with ethanol (20 mL) three times to remove soluble polymer, residual monomer (if present), XB linker, and residual DMPA, yielding purified insoluble polymer. The soluble part of the polymer in ethanol (10 mL) was reprecipitated into hexane (100 mL) to remove the residual monomer, XB linker, and DMPA, and analysed with GPC to determine the molecular weight and dispersity of the soluble part of polymer. The monomer conversion was determined by analyzing the ethanol solution (containing soluble polymer and monomer) using 1H NMR and the weight of insoluble polymer (monomer conversion=(total amount of soluble polymer and insoluble polymer)/(total amount of monomer, soluble polymer, and insoluble polymer)).

TABLE 3
Polymerizations of monomer cocrystal 1•6 under UV light
(λ = 365 nm) at room temperature for varied
polymerization time and varied amounts of photo-initiator (DMPA).

| | | [1]₀/[6]₀/ | | Monomer |
|---|---|---|---|---|
| Entry | Varied Condition | [DMPA]₀ | t (h) | conversion^{a} (%) |
| 1 | Polymerization | 2/1/0.67 | 0.25 | 30 |
| | time | | 3 | 33 |
| | | | 7 | 36 |
| | | | 24 | 59 |
| | | | 40^{b} | 100^{b} |
| 2 | Amount of DMPA^{c} | 2/1/0.01 | 40 | 0 |
| 3 | | 2/1/0.10 | 40 | 0 |

^{a}Monomer conversions were determined with ¹H NMR for soluble polymers in ethanol.
^{b}Table 5, entry 1.
^{c}Amounts of DMPA at 0.67 equiv to linker and 0.335 equiv to monomer (entry 1), 0.01 to linker and 0.005 equiv to monomer (entry 2), and 0.10 equiv to linker and 0.05 equiv (entry 3) to monomer.

### Characterisation

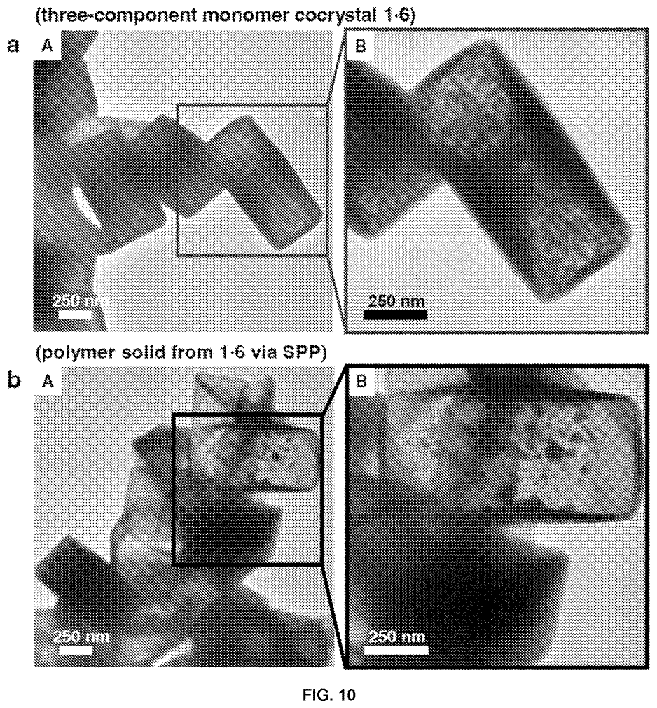

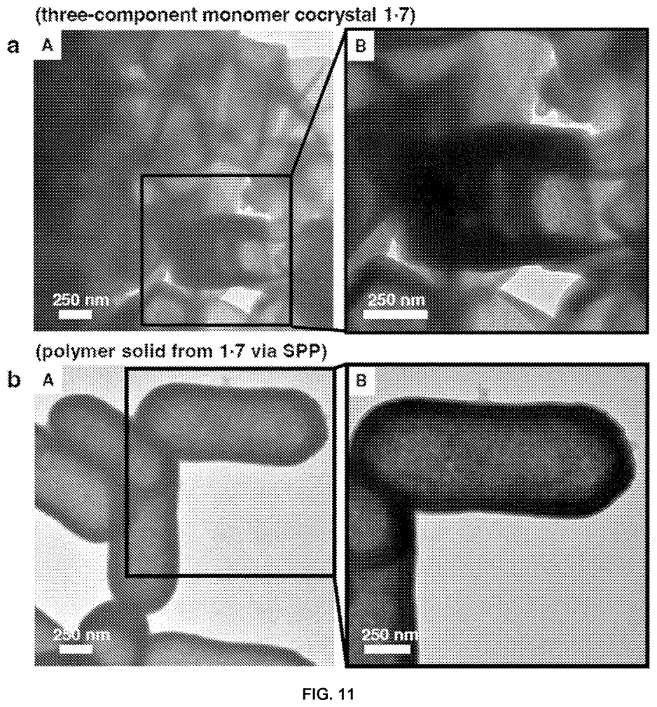

The monomer cocrystals 1.6, 1.7, and 1.8 and their polymers obtained via SPP were analysed with TEM. The dried solid samples were grinded into fine powders and directly attached onto the Cu grids (FIGS. 10-12).

### Removal of Linker After Polymerization

After the SPP, the polymerized 1.6, 1.7, 1.8, 2-6, and 2.7 cocrystals were purified (washed) using ethanol to remove the linkers.

### Characterisation

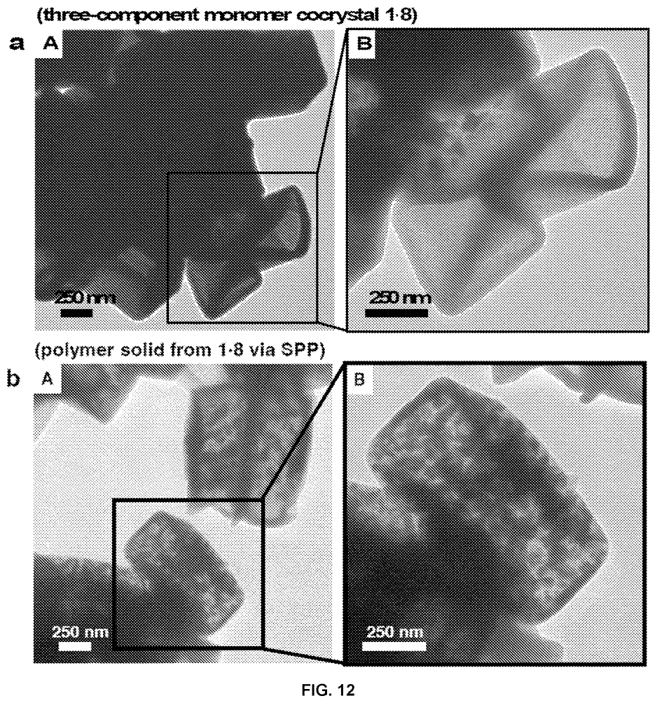

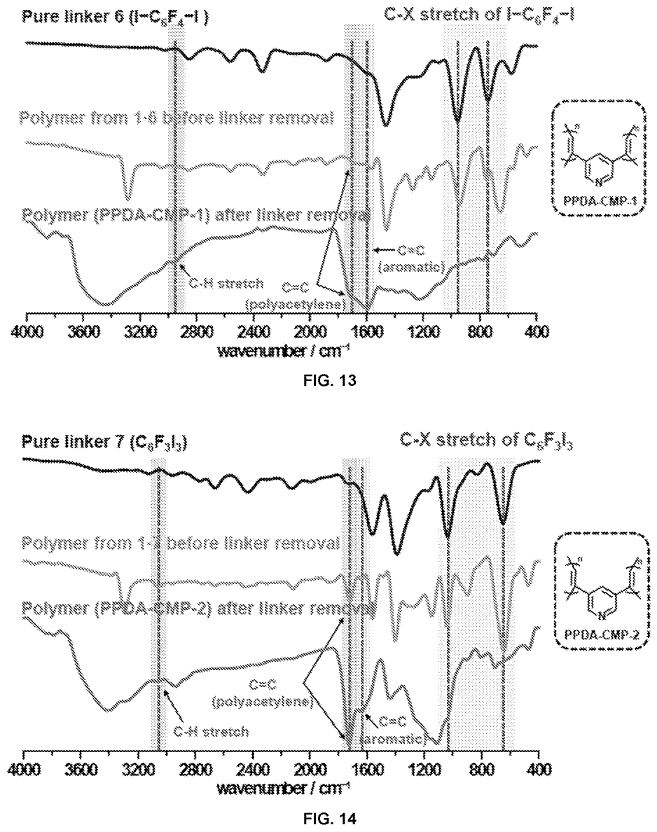

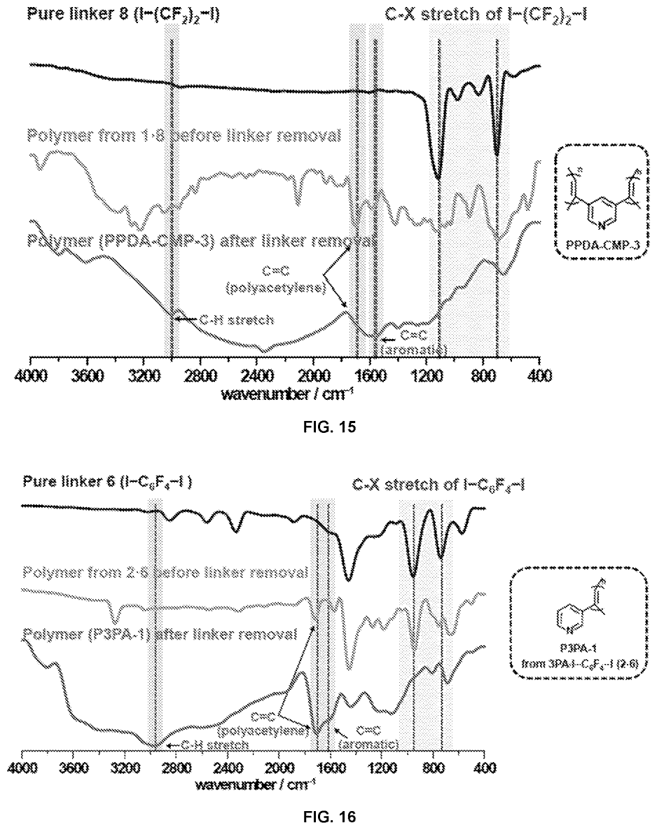

The FTIR analysis of the washed polymers showed no C—F and C-I peaks of the linkers, demonstrating complete removal of the linkers from the polymers (FIGS. 13-17).

### Preparation of PPDA-CMP-1, PPDA-CMP-2 and PPDA-CMP-3

In a typical run, monomer 1 (0.10 g, 0.79 mmol), XB linker 6 (0.16 g, 0.39 mmol) (N/I molar ratio=1/1) and DMPA (67.0 mg, 0.26 mmol) were dissolved in dichloromethane (2 mL) in a flask. Slow evaporation of dichloromethane was performed using a rotary evaporator, yielding the co-crystal solid after hours. The solid was moulded using a mini-hand hydraulic press to form a round-shape sheet with a diameter of 7 mm. The sheet was put in a vial. The vial was capped with a rubber septum, and oxygen was removed with an argon flow. The sheet was irradiated with UV light (/=365 nm) at room temperature for 40 h. The sheet was washed with ethanol (20 mL) three times to completely remove soluble polymer, residual monomer (if present), XB linker 6, and DMPA, yielding poly(pyridyl-3,5-diacetylene) (PPDA-CMP-1) with dark brown color as the final product (insoluble part). The cocrystal monomers 1·7 and 1·8 were polymerized and purified similarly, yielding PPDA-CMP-2 and PPDA-CMP-3 with brown and dark brown colors, respectively, as the final products (insoluble part). The soluble parts of polymers in ethanol (10 mL) were reprecipitated into hexane (100 mL) to remove the residual monomers, XB linkers, and DMPA, and analysed with 1H NMR and GPC to determine the monomer conversion, molecular weight, and dispersity in the soluble part.

### TGA Analysis

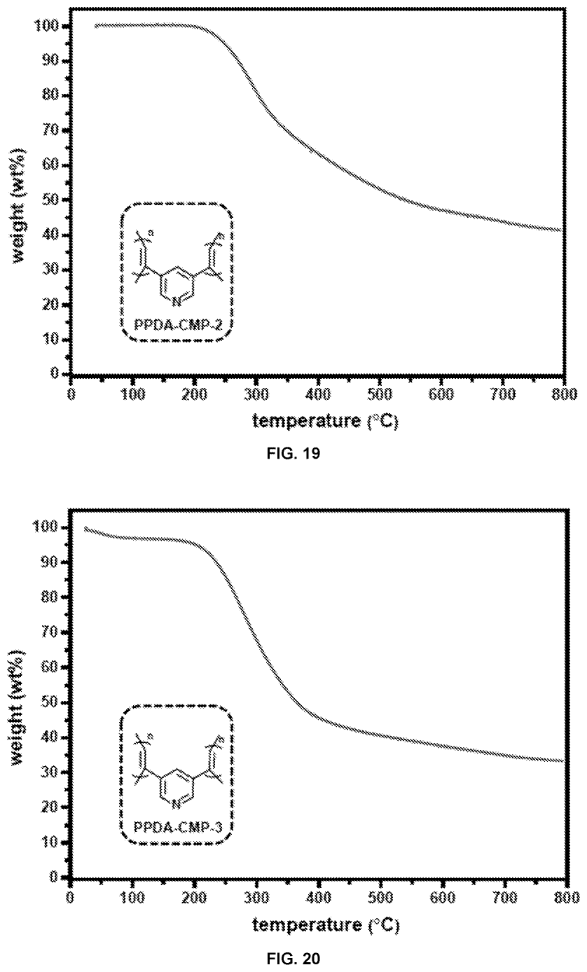

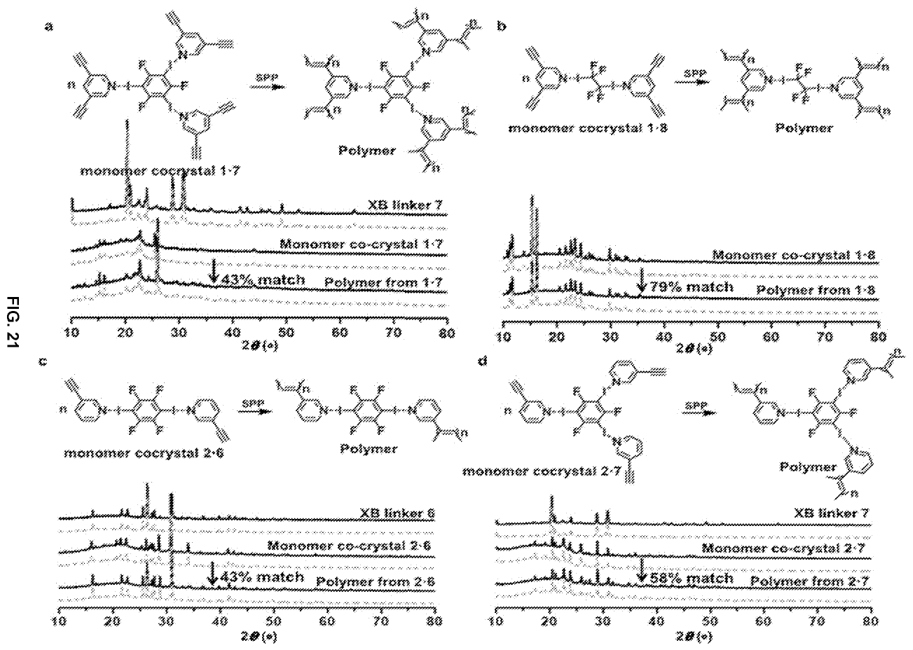

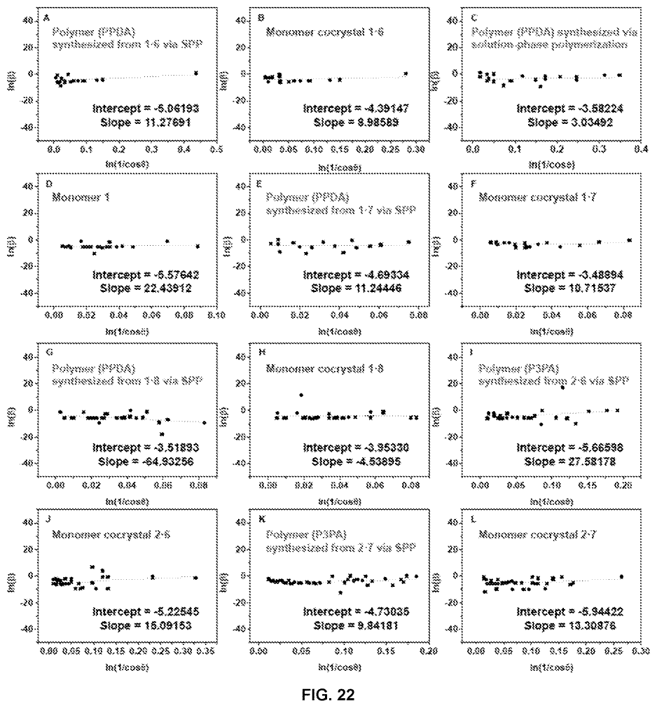

The TGA analysis was carried out in platinum pans under flowing air at a flow rate of 60 mL/min with a heating rate of 10° C./min for PPDA-CMP-1 (FIG. 18) or 20° C./min for PPDA-CMP-2 and PPDA-CMP-3 (FIGS. 19-20) and heated up to 780-790° C.

### PXRD

PXRD analysis was carried out on a Bruker D8 ADVANCE (Bruker) from 10.000° to 79.994° (step size 0.020) using CuK_{α} radiation (wavelength (λ)=1.541874 Å). The parameters (2 theta (20) and full width of half maximum (FWHM) shown in Table 4) were calculated from PXRD spectra and data calculated from Origin software. The crystallite size was calculated using the modified Scherrer equation (least square) (Monshi, A., Foroughi, M. R. & Monshi, M. R., World J. Nano Sci. Eng. 2012, 2, 154-160).

TABLE 4
PXRD data of crystallized monomers, non-crystallized monomers,
and the respectively obtained polymers (FIGS. 1e-f and 21-22).

| | | | | | | Crystallite | Dislocation | | Match |
|---|---|---|---|---|---|---|---|---|---|
| | | 2θ | FWHM | dₕₖₗ | Microstrain | size (D) | density | Rp | ratio |
| Entry | Compound | (°) | (°) | (nm) | (ϵ) | (nm) | (δ) (nm⁻²) | (%)^{a} | (%)^{b} |
| 1 | Polymer | 10.91201 | 4.24175 | 0.810818 | 0.1937737 | 0.972958 | 1.056359 | 6.8 | 60% |
| | P(PDA•I—C₆F₄—I) | 16.26794 | 25.64861 | 0.544877 | 0.78301467 | | | | |
| | (1•6) | 16.26794 | 0.17165 | 0.544877 | 0.00524022 | | | | |
| | | 17.75867 | 0.11767 | 0.49946 | 0.00328646 | | | | |
| | | 21.5442 | 0.17578 | 0.41248 | 0.00403134 | | | | |
| | | 23.59873 | 0.01049 | 0.377014 | 0.00021911 | | | | |
| | | 24.94124 | 1.66006 | 0.357016 | 0.03275224 | | | | |
| | | 24.94124 | 2.24804 | 0.357016 | 0.04435282 | | | | |
| | | 29.57729 | 0.14194 | 0.302027 | 0.00234595 | | | | |
| | | 29.57748 | 0.35524 | 0.302025 | 0.00587129 | | | | |
| | | 36.11691 | 0.21648 | 0.2487 | 0.00289703 | | | | |
| | | 33.29202 | 39.52008 | 0.269128 | 0.57674268 | | | | |
| | | 39.6024 | 0.3224 | 0.227578 | 0.0039071 | | | | |
| | | 43.26075 | 0.41116 | 0.209143 | 0.00452418 | | | | |
| | | 47.64555 | 0.43468 | 0.190869 | 0.00429565 | | | | |
| | | 48.62404 | 0.40596 | 0.187254 | 0.00392088 | | | | |
| | | 57.45616 | 0.66506 | 0.160394 | 0.00529422 | | | | |
| | | 61.17923 | 0.92425 | 0.151495 | 0.00682192 | | | | |
| | | 99.45419 | 130.9202 | 0.101044 | 0.48398837 | | | | |
| 2 | Monomer | 10.92663 | 5.6541 | 0.809736 | 0.25794566 | 0.968894 | 1.065239 | 4.6 | NA |
| | cocrystal | 16.26686 | 0.15388 | 0.544913 | 0.00469805 | | | | |
| | PDA•I—C₆F₄—I | 17.07599 | 4.02962 | 0.519271 | 0.11711616 | | | | |
| | (1•6) | 22.24118 | 5.5981 | 0.399709 | 0.1242656 | | | | |
| | | 28.80383 | 39.43103 | 0.309959 | 0.66999881 | | | | |
| | | 28.80383 | 6.79728 | 0.309959 | 0.1154971 | | | | |
| | | 29.57728 | 0.13805 | 0.302027 | 0.00228166 | | | | |
| | | 29.57753 | 0.329 | 0.302025 | 0.00543759 | | | | |
| | | 36.11669 | 0.24223 | 0.248701 | 0.00324165 | | | | |
| | | 39.60242 | 0.33104 | 0.227578 | 0.00401181 | | | | |
| | | 43.26035 | 0.4051 | 0.209145 | 0.00445754 | | | | |
| | | 47.64556 | 0.42768 | 0.190869 | 0.00422648 | | | | |
| | | 48.62428 | 0.39774 | 0.187254 | 0.00384147 | | | | |
| | | 57.4583 | 0.65136 | 0.160388 | 0.00518493 | | | | |
| | | 61.18001 | 0.92742 | 0.151493 | 0.00684521 | | | | |
| | | 81.79344 | 104.587 | 0.117755 | 0.52688214 | | | | |
| 3 | Polymer PDA (1) | 21.08288 | 9.47516 | 0.4214 | 0.22217096 | 0.962003 | 1.080556 | 5.6 | 6% |
| | synthesized in | 21.08288 | 145.9197 | 0.4214 | 3.42148599 | | | | |
| | solution | 29.2952 | 0.34129 | 0.304871 | 0.00569756 | | | | |
| | | 29.2952 | 46.06331 | 0.304871 | 0.76898947 | | | | |
| | | 30.9818 | 1.62464 | 0.288648 | 0.02557727 | | | | |
| | | 35.94859 | 0.24737 | 0.249825 | 0.00332699 | | | | |
| | | 35.94859 | 65.87125 | 0.249825 | 0.88593247 | | | | |
| | | 43.14715 | 0.01204 | 0.209667 | 0.00013287 | | | | |
| | | 47.51755 | 0.36 | 0.191353 | 0.00356842 | | | | |
| | | 48.51106 | 0.31266 | 0.187664 | 0.00302771 | | | | |
| | | 54.45379 | 17.63831 | 0.168505 | 0.14957842 | | | | |
| | | 60.99088 | 0.85523 | 0.151918 | 0.00633623 | | | | |
| | | 63.15792 | 0.00408 | 0.147217 | 2.8961E−05 | | | | |
| | | 65.28493 | 1.58414 | 0.142926 | 0.01079054 | | | | |
| | | 65.28493 | 11.60734 | 0.142926 | 0.07906468 | | | | |
| | | 71.28828 | 8.66091 | 0.132293 | 0.05269918 | | | | |
| | | 77.23758 | 8.94165 | 0.123521 | 0.04884077 | | | | |
| | | 77.23758 | 0.56649 | 0.123521 | 0.00309426 | | | | |
| | | 85.91169 | 33.61085 | 0.113134 | 0.15751142 | | | | |
| | | 90.24659 | 24.57447 | 0.108793 | 0.10676586 | | | | |
| 4 | Pure PDA (1) | 11.4013 | 0.44281 | 0.776129 | 0.01935516 | 0.975422 | 1.051029 | 5.8 | NA |
| | monomer solid | 13.78283 | 0.25034 | 0.642511 | 0.00903775 | | | | |
| | | 15.4069 | 0.48649 | 0.575129 | 0.01569281 | | | | |
| | | 16.17866 | 0.21829 | 0.547864 | 0.00670135 | | | | |
| | | 20.91469 | 21.25802 | 0.424751 | 0.5025522 | | | | |
| | | 21.57584 | 0.24047 | 0.411882 | 0.00550666 | | | | |
| | | 22.60064 | 0.3552 | 0.393432 | 0.00775603 | | | | |
| | | 23.26686 | 0.24586 | 0.382315 | 0.00521067 | | | | |
| | | 24.34932 | 0.26375 | 0.365559 | 0.0053342 | | | | |
| | | 25.34071 | 0.00235 | 0.351478 | 4.561E−05 | | | | |
| | | 26.51232 | 0.2438 | 0.336206 | 0.00451553 | | | | |
| | | 26.83257 | 0.25859 | 0.332266 | 0.00473019 | | | | |
| | | 27.8353 | 0.18558 | 0.32052 | 0.00326771 | | | | |
| | | 29.07741 | 0.24451 | 0.307105 | 0.00411384 | | | | |
| | | 29.76062 | 0.31994 | 0.300208 | 0.00525383 | | | | |
| | | 29.76062 | 10.20128 | 0.300208 | 0.1675181 | | | | |
| | | 31.52482 | 0.25956 | 0.283799 | 0.00401237 | | | | |
| | | 32.89816 | 0.58426 | 0.272259 | 0.00863452 | | | | |
| | | 35.38089 | 0.27899 | 0.253703 | 0.00381658 | | | | |
| | | 42.26099 | 26.39714 | 0.213856 | 0.29802163 | | | | |
| | | 47.51015 | 0.42404 | 0.191381 | 0.00420394 | | | | |
| 5 | Polymer | 11.83938 | 3.93701 | 0.747507 | 0.16567554 | 0.970866 | 1.060918 | 4.8 | 43% |
| | P(PDA•C₆F₃I₃) | 15.51053 | 2.41019 | 0.57131 | 0.07722022 | | | | |
| | (1•7) | 15.35849 | 69.5766 | 0.576931 | 2.2515067 | | | | |
| | | 16.03413 | 0.00719 | 0.55277 | 0.00022274 | | | | |
| | | 20.85771 | 7.27088 | 0.425898 | 0.17236806 | | | | |
| | | 22.66974 | 0.36579 | 0.392249 | 0.00796228 | | | | |
| | | 25.97687 | 0.21695 | 0.343013 | 0.00410405 | | | | |
| | | 24.59166 | 0.00187 | 0.362011 | 3.7436E−05 | | | | |
| | | 28.65894 | 12.26978 | 0.311493 | 0.20958363 | | | | |
| | | 31.22384 | 0.5145 | 0.286466 | 0.00803398 | | | | |
| | | 32.94383 | 0.00444 | 0.271892 | 6.5521E−05 | | | | |
| | | 34.55045 | 43.46734 | 0.259608 | 0.60986342 | | | | |
| | | 35.3989 | 0.15366 | 0.253578 | 0.00210092 | | | | |
| | | 37.83568 | 0.68341 | 0.237788 | 0.00870069 | | | | |
| | | 39.56927 | 1.38809 | 0.227761 | 0.01683726 | | | | |
| | | 43.79889 | 11.95823 | 0.206697 | 0.12979954 | | | | |
| 6 | Monomer | 12.11337 | 11.5033 | 0.730661 | 0.4730484 | 0.961007 | 1.082797 | 4.9 | NA |
| | cocrystal | 12.6268 | 7.99281 | 0.701064 | 0.31521981 | | | | |
| | PDA•C₆F₃I₃ | 15.27517 | 5.62404 | 0.580059 | 0.18299924 | | | | |
| | (1•7) | 15.27529 | 9.93507 | 0.580055 | 0.3232722 | | | | |
| | | 15.81986 | 1.59673 | 0.560208 | 0.05014498 | | | | |
| | | 18.81943 | 7.96993 | 0.471541 | 0.20984022 | | | | |
| | | 20.64408 | 5.24597 | 0.430257 | 0.12567994 | | | | |
| | | 22.49244 | 1.48149 | 0.3953 | 0.03250904 | | | | |
| | | 22.73856 | 0.21648 | 0.391077 | 0.00469755 | | | | |
| | | 25.43525 | 4.60841 | 0.350193 | 0.08909835 | | | | |
| | | 25.43525 | 0.16822 | 0.350193 | 0.00325234 | | | | |
| | | 26.01669 | 2.02E−01 | 0.342497 | 0.00381916 | | | | |
| | | 26.9093 | 0.36541 | 0.331335 | 0.0066644 | | | | |
| | | 28.94232 | 1.62497 | 0.308507 | 0.02747308 | | | | |
| | | 31.05245 | 7.68087 | 0.288008 | 0.12063356 | | | | |
| | | 33.9569 | 0.28485 | 0.264009 | 0.00407079 | | | | |
| | | 37.8586 | 0.84137 | 0.237649 | 0.01070474 | | | | |
| | | 41.30232 | 13.79153 | 0.218596 | 0.15966503 | | | | |
| | | 46.15986 | 46.93403 | 0.19666 | 0.48058595 | | | | |
| 7 | Polymer | 8.29641 | 14.43338 | 1.065763 | 0.86833658 | 0.961333 | 1.082063 | 4.9 | 79% |
| | P(PDA•I—(CF₂)₂—I) | 11.26248 | 0.19632 | 0.785664 | 0.00868758 | | | | |
| | (1•8) | 11.66005 | 0.18212 | 0.758963 | 0.0077826 | | | | |
| | | 15.351 | 0.17353 | 0.577211 | 0.00561822 | | | | |
| | | 16.21849 | 0.18278 | 0.546527 | 0.00559725 | | | | |
| | | 20.27508 | 11.88466 | 0.438003 | 0.29002061 | | | | |
| | | 21.63704 | 0.21287 | 0.410731 | 0.00486051 | | | | |
| | | 22.59076 | 0.2333 | 0.393602 | 0.00509655 | | | | |
| | | 23.38476 | 0.24892 | 0.380415 | 0.00524818 | | | | |
| | | 24.42399 | 0.18533 | 0.364459 | 0.00373639 | | | | |
| | | 25.29223 | 0.00448 | 0.352141 | 8.7122E−05 | | | | |
| | | 25.99845 | 0.18044 | 0.342733 | 0.00341046 | | | | |
| | | 26.54908 | 0.21671 | 0.335749 | 0.00400802 | | | | |
| | | 26.76203 | 4.49104 | 0.333125 | 0.08237587 | | | | |
| | | 27.53656 | 3.71451 | 0.323929 | 0.06614361 | | | | |
| | | 29.80077 | 0.20143 | 0.299813 | 0.00330308 | | | | |
| | | 30.95841 | 0.22947 | 0.288861 | 0.00361549 | | | | |
| | | 31.52517 | 0.25043 | 0.283796 | 0.00387119 | | | | |
| | | 32.82294 | 0.50063 | 0.272866 | 0.00741651 | | | | |
| | | 32.90607 | 51.60528 | 0.272195 | 0.76245738 | | | | |
| | | 34.1914 | 0.18389 | 0.262251 | 0.00260885 | | | | |
| | | 35.45269 | 0.27406 | 0.253205 | 0.00374104 | | | | |
| | | 36.3434 | 19.90475 | 0.247202 | 0.26459878 | | | | |
| | | 38.56833 | 0.00635 | 0.233438 | 7.9189E−05 | | | | |
| | | 39.14077 | 6.77E−07 | 0.230155 | 8.3052E−09 | | | | |
| | | 40.15697 | 0.06946 | 0.224562 | 0.00082916 | | | | |
| | | 45.13077 | 9.96E−45 | 0.200902 | 1.0462E−46 | | | | |
| | | 46.10813 | 0.00591 | 0.196869 | 6.0592E−05 | | | | |
| 8 | Monomer | 11.29547 | 0.24688 | 0.783377 | 0.01089286 | 0.965507 | 1.072727 | 6.1 | NA |
| | cocrystal | 11.64764 | 0.1894 | 0.759769 | 0.00810238 | | | | |
| | PDA•I—(CF₂)₂—I | 11.80539 | 9.60867 | 0.749652 | 0.40552037 | | | | |
| | (1•8) | 15.35119 | 0.17434 | 0.577204 | 0.00564438 | | | | |
| | | 16.21654 | 0.17914 | 0.546593 | 0.00548645 | | | | |
| | | 20.57346 | 9.41506 | 0.431718 | 0.22635185 | | | | |
| | | 22.03535 | 6.11E+06 | 0.403396 | 137022.357 | | | | |
| | | 22.59287 | 0.19834 | 0.393566 | 0.00433241 | | | | |
| | | 23.33004 | 0.28714 | 0.381294 | 0.00606861 | | | | |
| | | 24.41469 | 0.17979 | 0.364595 | 0.00362612 | | | | |
| | | 25.34714 | 0.13158 | 0.35139 | 0.00255309 | | | | |
| | | 26.01276 | 0.19249 | 0.342548 | 0.00363614 | | | | |
| | | 26.54553 | 0.19787 | 0.335793 | 0.00366009 | | | | |
| | | 26.91999 | 0.28864 | 0.331206 | 0.00526208 | | | | |
| | | 29.78138 | 4.52315 | 0.300004 | 0.07422174 | | | | |
| | | 29.79992 | 0.2117 | 0.299821 | 0.00347159 | | | | |
| | | 30.97161 | 0.20373 | 0.288741 | 0.0032085 | | | | |
| | | 31.54808 | 0.26045 | 0.283595 | 0.00402301 | | | | |
| | | 32.75548 | 0.24659 | 0.273412 | 0.00366102 | | | | |
| | | 33.11663 | 0.22919 | 0.270513 | 0.00336347 | | | | |
| | | 34.18257 | 0.29917 | 0.262317 | 0.00424549 | | | | |
| | | 35.4456 | 0.29952 | 0.253254 | 0.00408945 | | | | |
| | | 38.44271 | 13.75546 | 0.234172 | 0.17214596 | | | | |
| | | 38.44271 | 0.28249 | 0.234172 | 0.00353529 | | | | |
| | | 40.73983 | 33.64243 | 0.221483 | 0.3953492 | | | | |
| | | 40.73983 | 7.31807 | 0.221483 | 0.08599834 | | | | |
| | | 45.19062 | 0.23342 | 0.20065 | 0.00244732 | | | | |
| | | 46.09298 | 0.25839 | 0.19693 | 0.0026501 | | | | |
| 9 | Polymer | 16.24212 | 0.14583 | 0.545738 | 0.00445915 | 0.975806 | 1.050203 | 6.0 | 43% |
| | P(3PA•I—C₆F₄—I) | 17.62266 | 5.85482 | 0.503284 | 0.1648046 | | | | |
| | (2•6) | 22.18362 | 7.5105 | 0.400733 | 0.16716032 | | | | |
| | | 22.52673 | 0.88077 | 0.394706 | 0.01929696 | | | | |
| | | 25.55401 | 0.1602 | 0.348592 | 0.0030824 | | | | |
| | | 26.34195 | 0.15069 | 0.338342 | 0.00280971 | | | | |
| | | 27.12922 | 1.15746 | 0.328699 | 0.0209323 | | | | |
| | | 27.68822 | 0.13355 | 0.322189 | 0.00236456 | | | | |
| | | 28.72878 | 0.14742 | 0.310752 | 0.00251174 | | | | |
| | | 30.94201 | 0.16617 | 0.28901 | 0.00261961 | | | | |
| | | 31.21858 | 5.98068 | 0.286513 | 0.0934056 | | | | |
| | | 34.23381 | 0.43935 | 0.261936 | 0.00622485 | | | | |
| | | 36.72281 | 0.2734 | 0.244734 | 0.00359417 | | | | |
| | | 38.41004 | 5.26E−43 | 0.234363 | 6.5851E−45 | | | | |
| | | 39.75865 | 0.27469 | 0.226719 | 0.00331473 | | | | |
| | | 41.63306 | 0.21352 | 0.216935 | 0.00245047 | | | | |
| | | 42.64958 | 0.19601 | 0.211997 | 0.00219081 | | | | |
| | | 44.18153 | 0.86685 | 0.204996 | 0.00931911 | | | | |
| | | 46.63457 | 0.0016 | 0.194768 | 1.6197E−05 | | | | |
| | | 47.0451 | 47.32559 | 0.193164 | 0.47439955 | | | | |
| | | 51.79203 | 0.26876 | 0.176521 | 0.00241548 | | | | |
| | | 53.96646 | 1.69E+09 | 0.169911 | 14451519.8 | | | | |
| | | 55.30156 | 0.15286 | 0.166121 | 0.00127306 | | | | |
| | | 57.81968 | 0.0021 | 0.159471 | 1.6592E−05 | | | | |
| | | 61.61491 | 29.89019 | 0.150528 | 0.21871781 | | | | |
| | | 66.13039 | 52.07 | 0.141303 | 0.3489846 | | | | |
| | | 68.74071 | 50.69263 | 0.13656 | 0.32339622 | | | | |
| 10 | Monomer | 15.75844 | 4.19526 | 0.562378 | 0.13227136 | 0.973793 | 1.054548 | 6.2 | NA |
| | cocrystal | 16.0274 | 0.2007 | 0.553 | 0.00622027 | | | | |
| | 3PA•I—C₆F₄—I | 19.74146 | 5.63193 | 0.44972 | 0.14122821 | | | | |
| | (2•6) | 21.3924 | 0.14558 | 0.415372 | 0.00336299 | | | | |
| | | 22.32117 | 2.90515 | 0.398295 | 0.06425097 | | | | |
| | | 26.08509 | 2.39553 | 0.341615 | 0.04512174 | | | | |
| | | 26.08509 | 0.79331 | 0.341615 | 0.01494263 | | | | |
| | | 26.15124 | 0.18435 | 0.340765 | 0.00346329 | | | | |
| | | 27.06296 | 0.14368 | 0.329489 | 0.00260501 | | | | |
| | | 27.51189 | 0.14416 | 0.324214 | 0.00256942 | | | | |
| | | 28.54313 | 0.18501 | 0.31273 | 0.00317358 | | | | |
| | | 30.76394 | 0.181 | 0.290642 | 0.00287074 | | | | |
| | | 33.98756 | 0.19781 | 0.263778 | 0.0028242 | | | | |
| | | 30.76394 | 9.87816 | 0.290642 | 0.15667194 | | | | |
| | | 36.12583 | 0.70599 | 0.24864 | 0.00944539 | | | | |
| | | 36.12583 | 6.34113 | 0.24864 | 0.08483748 | | | | |
| | | 39.31867 | 0.00566 | 0.229154 | 6.9129E−05 | | | | |
| | | 41.42971 | 0.19635 | 0.217953 | 0.00226552 | | | | |
| | | 42.45689 | 0.00445 | 0.212915 | 4.9986E−05 | | | | |
| | | 43.95989 | 0.01022 | 0.205978 | 0.00011048 | | | | |
| | | 49.61915 | 46300.01 | 0.18373 | 437.023609 | | | | |
| | | 49.61915 | 0.28682 | 0.18373 | 0.00270728 | | | | |
| | | 51.75665 | 0.00405 | 0.176633 | 3.6428E−05 | | | | |
| | | 55.10968 | 2840.426 | 0.166654 | 23.7525323 | | | | |
| | | 55.10968 | 23.52804 | 0.166654 | 0.19674886 | | | | |
| | | 57.56299 | 0.00386 | 0.160121 | 3.066E−05 | | | | |
| | | 57.56299 | 28.71936 | 0.160121 | 0.22811589 | | | | |
| | | 75.07011 | 39.8215 | 0.126539 | 0.22615409 | | | | |
| | | 75.07022 | 19.10313 | 0.126539 | 0.1084902 | | | | |
| | | 87.85187 | 12.21789 | 0.11113 | 0.05534775 | | | | |
| 11 | Polymer | 17.47337 | 5.72311 | 0.50755 | 0.1624954 | 0.97109 | 1.060427 | 5.3 | 58% |
| | P(3PA•C₆F₃I₃) | 19.12206 | 1.22417 | 0.464146 | 0.0317117 | | | | |
| | (2•7) | 20.55643 | 1.25114 | 0.432071 | 0.0301047 | | | | |
| | | 21.01807 | 1.89647 | 0.422685 | 0.04460817 | | | | |
| | | 22.56784 | 0.76071 | 0.393997 | 0.01663539 | | | | |
| | | 23.75491 | 0.94919 | 0.37457 | 0.01969181 | | | | |
| | | 25.99713 | 1.96952 | 0.34275 | 0.03722745 | | | | |
| | | 26.83797 | 2.08049 | 0.3322 | 0.0380489 | | | | |
| | | 27.4315 | 0.82882 | 0.325146 | 0.01481741 | | | | |
| | | 28.84938 | 0.31568 | 0.30948 | 0.00535509 | | | | |
| | | 30.9762 | 0.22758 | 0.288699 | 0.00358355 | | | | |
| | | 31.80055 | 0.23215 | 0.281401 | 0.00355591 | | | | |
| | | 30.26726 | 2.18682 | 0.295298 | 0.03528114 | | | | |
| | | 32.87221 | 0.64975 | 0.272468 | 0.00961038 | | | | |
| | | 34.88362 | 0.33949 | 0.257204 | 0.00471479 | | | | |
| | | 35.95527 | 0.40142 | 0.249781 | 0.00539781 | | | | |
| | | 38.08209 | 0.56747 | 0.236306 | 0.00717429 | | | | |
| | | 38.92293 | 0.32061 | 0.231393 | 0.0039589 | | | | |
| | | 40.68704 | 0.29211 | 0.221758 | 0.00343758 | | | | |
| | | 41.52787 | 0.19446 | 0.21746 | 0.00223791 | | | | |
| | | 42.83034 | 0.31222 | 0.211144 | 0.00347352 | | | | |
| | | 45.91341 | 0.5836 | 0.197658 | 0.00601165 | | | | |
| | | 46.96858 | 40.53601 | 0.193461 | 0.40708229 | | | | |
| | | 49.45811 | 2.62E−04 | 0.18429 | 2.4784E−06 | | | | |
| | | 50.64517 | 0.51455 | 0.180246 | 0.00474481 | | | | |
| | | 51.60142 | 4.44901 | 0.177128 | 0.04015535 | | | | |
| | | 52.19495 | 63.9053 | 0.175253 | 0.56924568 | | | | |
| | | 53.13471 | 1.60433 | 0.172373 | 0.01399901 | | | | |
| | | 54.09095 | 4.1557 | 0.169549 | 0.03551764 | | | | |
| | | 55.39342 | 1.88425 | 0.165867 | 0.01566201 | | | | |
| | | 56.33318 | 49.14059 | 0.163321 | 0.40044517 | | | | |
| | | 56.8113 | 0.06566 | 0.16206 | 0.00052974 | | | | |
| | | 57.88296 | 1.32445 | 0.159312 | 0.01045076 | | | | |
| | | 60.94954 | 6.60909 | 0.152011 | 0.04900586 | | | | |
| | | 62.61472 | 0.05439 | 0.148363 | 0.00039021 | | | | |
| | | 64.39532 | 3.64744 | 0.144684 | 0.02527482 | | | | |
| | | 64.98885 | 0.63344 | 0.143506 | 0.00433939 | | | | |
| | | 65.69779 | 65.21297 | 0.142128 | 0.44070142 | | | | |
| | | 67.7092 | 45.23796 | 0.138387 | 0.29424747 | | | | |
| 12 | Monomer | 18.71944 | 26.20227 | 0.474037 | 0.69363127 | 0.976925 | 1.047797 | 4.8 | NA |
| | cocrystal | 18.71944 | 7.32543 | 0.474037 | 0.19392012 | | | | |
| | 3PA•C₆F₃I₃ | 20.58541 | 3.17E−04 | 0.43147 | 7.6193E−06 | | | | |
| | (2•7) | 21.99898 | 4.15808 | 0.404054 | 0.09334232 | | | | |
| | | 22.65052 | 0.23155 | 0.392577 | 0.00504462 | | | | |
| | | 23.83496 | 0.19357 | 0.37333 | 0.0040019 | | | | |
| | | 25.92278 | 0.21399 | 0.343717 | 0.0040568 | | | | |
| | | 26.38692 | 0.37158 | 0.337775 | 0.0069161 | | | | |
| | | 26.48849 | 2.13524 | 0.336503 | 0.03958461 | | | | |
| | | 28.93053 | 0.1904 | 0.30863 | 0.00322043 | | | | |
| | | 31.00882 | 0.00368 | 0.288403 | 5.7882E−05 | | | | |
| | | 30.94368 | 0.2247 | 0.288995 | 0.00354211 | | | | |
| | | 31.74496 | 0.1631 | 0.281881 | 0.00250286 | | | | |
| | | 31.74496 | 4.92506 | 0.281881 | 0.07557768 | | | | |
| | | 34.77576 | 0.27237 | 0.257977 | 0.00379512 | | | | |
| | | 36.00339 | 0.43469 | 0.249458 | 0.00583683 | | | | |
| | | 38.05901 | 0.3283 | 0.236444 | 0.00415327 | | | | |
| | | 38.73933 | 0.65628 | 0.232447 | 0.00814529 | | | | |
| | | 40.92387 | 1.14535 | 0.220529 | 0.01339363 | | | | |
| | | 41.35799 | 0.00246 | 0.218314 | 2.8438E−05 | | | | |
| | | 42.83389 | 0.32759 | 0.211128 | 0.00364418 | | | | |
| | | 46.0517 | 0.32942 | 0.197097 | 0.00338198 | | | | |
| | | 46.95452 | 0.00202 | 0.193516 | 2.0293E−05 | | | | |
| | | 49.35626 | 0.00237 | 0.184647 | 2.2506E−05 | | | | |
| | | 50.73718 | 0.33851 | 0.179941 | 0.00311502 | | | | |
| | | 50.73718 | 31.31188 | 0.179941 | 0.28813672 | | | | |
| | | 52.31198 | 0.19483 | 0.174888 | 0.001731 | | | | |
| | | 53.25142 | 0.18447 | 0.172023 | 0.00160555 | | | | |
| | | 53.25142 | 9.07831 | 0.172023 | 0.07901396 | | | | |
| | | 53.25142 | 14.50078 | 0.172023 | 0.12620896 | | | | |
| | | 56.36855 | 0.00389 | 0.163227 | 3.1676E−05 | | | | |
| | | 56.84769 | 0.1944 | 0.161965 | 0.00156721 | | | | |
| | | 59.20702 | 12.65377 | 0.156062 | 0.09717769 | | | | |
| | | 59.20778 | 3.64318 | 0.15606 | 0.02797825 | | | | |
| | | 62.17799 | 24.81167 | 0.1493 | 0.17954483 | | | | |
| | | 62.26614 | 24.85636 | 0.149109 | 0.17955572 | | | | |
| | | 65.1447 | 0.09419 | 0.1432 | 0.00064332 | | | | |
| | | 65.98668 | 0.38099 | 0.141575 | 0.0025605 | | | | |
| | | 79.63941 | 35.17373 | 0.120389 | 0.18407687 | | | | |

^{a}Rₚ is the R profile factor in Rietveld refinement, showing the discrepancy index between the experimental and calculated spectra. Normally, Rₚ less than 10% indicates a good fit.
^{b}Match ratio (%) = (the number of peaks of the polymer identically matched with those of the monomer (red))/Σ{(the number of peaks of the polymer identically matched with those of the monomer) + (the number of shifted peaks in the polymer (blue)) + (the number of new peaks appeared in the polymer (green, if applicable)) + (the number of peaks present in the monomer but disappeared in the polymer (green, if applicable))} × 100%. The matching ratio was calculated in pairs (entries 1 vs 2, 3 vs 4, 5 vs 6, 7 vs 8, 9 vs 10, and 11 vs 12).

The layers distance/plane spacing (dₕₖₗ), microstrain (ε), crystallite size (D), and dislocation density (δ) were calculated from the following formula:

$$Scherrer equation : ln β = ln \frac{1}{cos θ} + ln \frac{K λ}{D} = ln \frac{1}{cos θ} + intercept b \qquad ( 1 )$$

$$Crystallite size ( D ) = \frac{K λ}{{e}^{intercept b}} [ nm ] \qquad ( 2 )$$

$$Layer spacing ( {d}_{hkl} ) = \frac{n λ}{2 sin θ} [ nm ] \qquad ( 3 )$$

$$Microstain ( ε ) = \frac{radians ( FWHM )}{4 tan θ} \qquad ( 4 )$$

$$Dislocation density ( δ ) = \frac{1}{{D}^{2}} [ {nm}^{- 2} ] \qquad ( 5 )$$

$$where :$$

$$β is the radians of FWHM ;$$

$$θ is the incident angle ( the angle between the incident ray and the scatter plane ) [ ° ] ;$$

$$K is the Scherrer constant , which is a dimensionless shape factor ( K = 0.9 ) ;$$

$$λ is the radiation wavelength ( λ = 0.1541874 nm ) ;$$

$$D is the crystallite size [ nm ] in the powder sample and was obtained from the intercept of the plot of ln β vs ln ( 1 / cos θ ) according to equation ( 1 ) or ( 2 ) ) ; and$$

$$n is an integer ( n = 1 ) .$$

### Results and Discussion

We used acetylene monomers in XB-assisted free-radical SPP and attempted to obtain polyacetylene polymers (not oligomers) (FIG. 1a). Because of the alignment of acetylene monomers in the cocrystals, the adjacent C≡C groups can be close enough to undergo effective polymerization, which is not attainable in solutions. This work opens up an effective synthesis of polyacetylenes via radical polymerization, giving significant scientific and practical impacts. Experimentally, we used mono-acetylenes (HC≡CR) to obtain linear polymers and a di-acetylene (HC≡C—R—C≡CH with an R spacer) to obtain network polymers (2D CMPs) (FIGS. 1b-c). We combined monomer 1 and XB linkers to generate monomer co-crystals, which were polymerized by photo-irradiation to generate polymers (network polymers) (FIG. 1b). The synthesis of 2D CMPs via radical polymerization is unprecedented. Unlike hydrogen bonds, XB is highly directional with a bonding angle of nearly 180° (FIG. 1a) and can assemble acetylene monomers into supramolecular structures in directional manners. After the polymerization and XB linker removal (FIG. 1b), 2D CMPs with regulated pores were created. The pore sizes can be modulated by changing XB linkers.

The obtained monomer/linker/photo-initiator three-component solids (called monomer cocrystals below) were exposed to UV light (λ=365 nm) under an argon atmosphere for 40 h at room temperature (22° C.). As mentioned, DMPA (photo-initiator) was not incorporated in the monomer/linker cocrystal lattices but located in gaps among the cocrystal grains (outside the cocrystals). Upon irradiation, DMPA decomposed, and the radicals were generated outside the cocrystals. The radicals subsequently entered into the cocrystals through the cocrystal surfaces. The propagation occurred from one face to the center and to the counter face in the cocrystals.

We studied the SPP of 1.6 with varying amounts of DMPA (0.01-0.67 equiv to linker and 0.005-0.335 equiv to monomer). No polymer was generated with the amounts of DMPA at 0.005 and 0.05 equivs to monomer, whereas the polymer was obtained with a 100% monomer conversion at 0.335 equiv to monomer after 40 h, suggesting that this is an optimal SPP condition (Table 3). The amount of DMPA (0.335 equiv to monomer) was large, because the lifetime of radicals is short (is not sufficient for radicals to diffuse) and only the DMPA located close to the cocrystal surfaces could generate effective radicals that can enter into the cocrystals. A majority of the DMPA apart from the cocrystal surfaces would not enter the cocrystals, and therefore an excess of DMPA was required in the present study. The exact diffusivity of radicals is not clear at this moment.

The SPP of 1.6 (actually containing 1, 6, and DMPA) led to a 100% monomer conversion. After the SPP, the solid was stirred in ethanol and divided into ethanol-soluble (3 wt %) and ethanol-insoluble (97 wt %) polymers (Table 5, entry 1). The monomer (1 (PDA)) is a diacetylene bearing two polymerizable C≡C groups, and hence the polymer can be branched or further crosslinked, giving an insoluble polymer. Thus, not only a soluble polymer with a peak-top molecular weight (Mₚ) of 46000, a number-average molecular weight (Mₙ) of 48000 and a dispersity index (Ð=M_{w}/Mₙ) of 1.16 (Table 5, entry 1) but also an even higher molecular-weight insoluble polymer (e.g., crosslinked polymer) was yielded, where M_{w} is the weight-average molecular.

TABLE 5
Polymerizations of crystallized and non-crystallized monomers under
UV light (λ = 365 nm) at room temperature for 40 h.

| | | | | | Monomer | | | | Soluble | Insoluble |
|---|---|---|---|---|---|---|---|---|---|---|
| | | | | | conversion | | | | polymer | polymer |
| Entry | Mode | M | L^{a} | [M]₀/[L]₀/[DMPAP]₀ | (%) | Mₚ^{b} | Mₙ^{b} | Ð^{b} | (% wt) | (% wt) |
| 1 | SPP | PDA (1) | 6 | 2/1/0.67 | 100 | 46000 | 48000 | 1.16 | 3 | 97 |
| 2 | SPP | PDA (1) | 7 | 3/1/0.67 | 99 | 17000 | 13000 | 1.96 | 7 | 93 |
| 3 | SPP | PDA (1) | 8 | 2/1/0.67 | 97 | 12000 | 13000 | 1.51 | 8 | 92 |
| C1 | Solution | PDA (1) | NA | 2/0/0.67 | 10 | 15000 | 11000 | 1.66 | 82 | 18 |
| 4 | SPP | 3PA (2) | 6 | 2/1/0.67 | 100 | 13000 | NA | NA | 45 | 55 |
| 5 | SPP | 3PA (2) | 7 | 3/1/0.67 | 87 | 5400 | NA | NA | 88 | 12 |
| C2 | Solution | 3PA (2) | NA | 2/0/0.67 | 0 | NA | NA | NA | NA | NA |
| 6 | SPP | 4PA (3) | 6 | 2/1/0.67 | 100 | 6300 | NA | NA | 85 | 15 |
| C3 | Solution | 4PA (3) | NA | 2/0/0.67 | 100 | 5000 | NA | NA | 89 | 11 |
| 7 | SPP | PMA (4) | 6 | 2/1/0.67 | 100 | 5300 | NA | NA | 91 | 9 |
| C4 | Solution | PMA (4) | NA | 2/0/0.67 | 3 | 5200 | NA | NA | 100 | 0 |
| 8 | SPP | PPVA (5) | 6 | 1/1/0.67 | 100 | 5400 | NA | NA | 88 | 12 |
| C5 | Solution | PPVA (5) | NA | 2/0/0.67 | 50 | 5000 | NA | NA | 90 | 10 |

Bold values indicate the numbering of the monomers and linkers used in the solid-phase polymerization.
DMF was used as the GPC eluent. Mₚ is the peak-top molecular weight. Because of the presence of oligomers and possible clusters of LiBr contained in the DMF eluent, the GPC baseline was not horizontal in all cases. Hence, the number-average molecular weight (Mₙ) and dispersity (Ð) values were not accurately determined, and we studied the Mₚ value instead.
^{a}L = XB linker.
^{b}Polystyrene (PSt)-calibrated DMF-GPC values for soluble polymers in ethanol, where GPC is gel permeation chromatography.

We further studied SPPs for other monomers and linkers. All studied SPPs (1·7, 1·8, 2·6, 2·7, 3·6, 4·6, and 5·6) led to high monomer conversions (87-100%) (Table 5, entries 2-8). Polymers synthesized from 1·7 to 1·8 comprised a minor fraction of soluble polymer (7 and 8 wt %) and large fractions (93 and 92 wt %) of insoluble polymers, indicating the dominant formation of high-molecular weight (crosslinked) polymers (Table 5, entries 2 and 3). Monomers 2-5 are mono-acetylenes and hence yielded only linear (non-crosslinked) polymers. Nevertheless, monomer cocrystals 2·6, 2·7, 3·6, 4·6, and 5·6 still generated 9-55 wt % of insoluble polymers (Table 5, entries 4-8), which would be high-molecular-weight linear polyacetylenes. The solution-phase polymerizations of monomers 2-5 (Table 5, entries C2-C5) resulted in no or slow polymerizations or less insoluble fractions than those in the SPP. These results demonstrate more efficient polymerizations in the solid states. During the SPP, the color changed from white (monomer cocrystals) to dark brown, yellow-brown, or brown because of the generation of polyacetylenes (FIG. 1b). The slightly different colors in the polymers generated from 1·6, 1·7, and 1·8 (FIG. 1b) would be ascribed to different polyacetylene (cis/trans) configurations or different polymer structures (propagation patterns) brought by different linkers 6, 7, and 8. The reaction mode of acetylenes may be continuous radical chain propagation to form polymers (polymerization) or discontinuous radical addition to form dimers (dimerization). If the discontinuous radical addition occurs, the reactions of mono-acetylenes (monomers 2-5) will give only dimers. In the present systems, we actually obtained polymers (as described above), demonstrating that the reaction mode was continuous radical chain propagation (polymerization). For all studied SPPs (1·6, 1·7, 1·8, 2·6, 2·7, 3·6, 4·6, and 5·6), without using DMPA (photo-initiator), no polymerization took place under the UV irradiation, meaning that no topochemical polymerizations took place in the studied cocrystals. The result confirms that the observed SPP (Table 5, entries 1-8) is ascribed to radical polymerization initiated by DMPA.

The obtained polymers did not maintain single-crystal structures but became polycrystalline solids. This is because the neighboring monomer-monomer distances in the cocrystals were non-topochemical distances and became shorter by the polymerization, which would bring some deformation of cocrystal structures. Thus, instead of single-crystal X-ray diffraction, we used PXRD to study the change in the crystallinity from the monomer cocrystals to the polymer solids. From PXRD, we determined the diffraction pattern matching before and after the SPP. For 1·6 (FIG. 1e), 60% of the diffraction peaks remained even after the SPP (Table 4, entries 1 and 2), demonstrating that the monomer cocrystal structure was relatively largely retained even after the SPP.

In the solid phase, propagation can occur only within a cocrystal grain. Thus, the grain size would decide the maximum chain length (maximum molecular weight), which would correspond to a distance from one face to the counter face in the grain. The grain sizes of cocrystals 1·6, 1·7, and 1·8 were ˜500-1000 nm, according to the TEM analysis (FIGS. 10-12). The grains would be single cocrystals or assemblies of cocrystals, which were embedded in the DMPA (photo-initiator) matrix. The grain sizes were virtually the same before and after the SPP (FIGS. 10-12), suggesting that the origin of the grains of the formed polymers (below) is the grains of the monomer cocrystals.

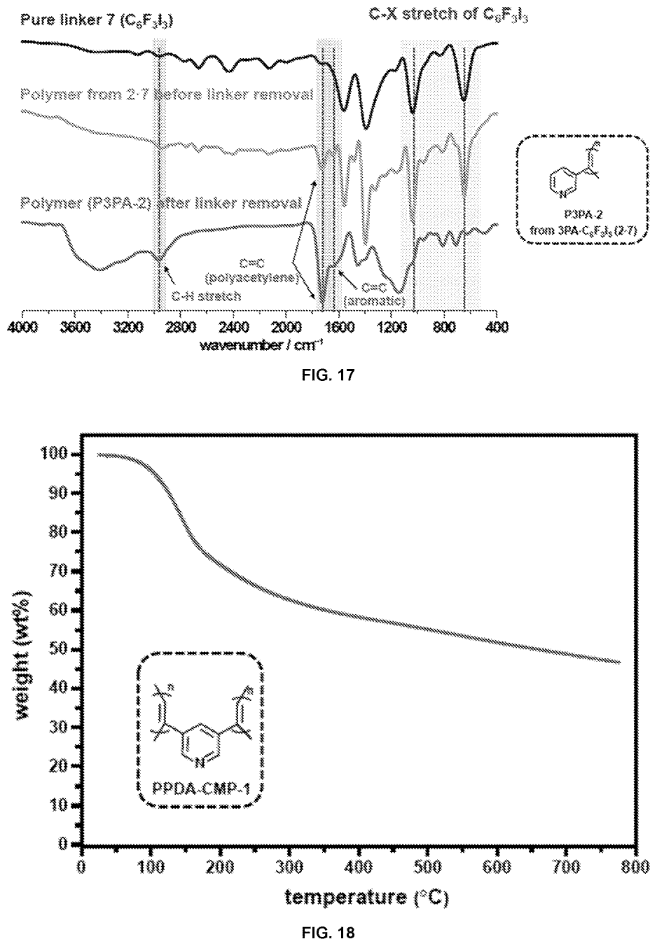

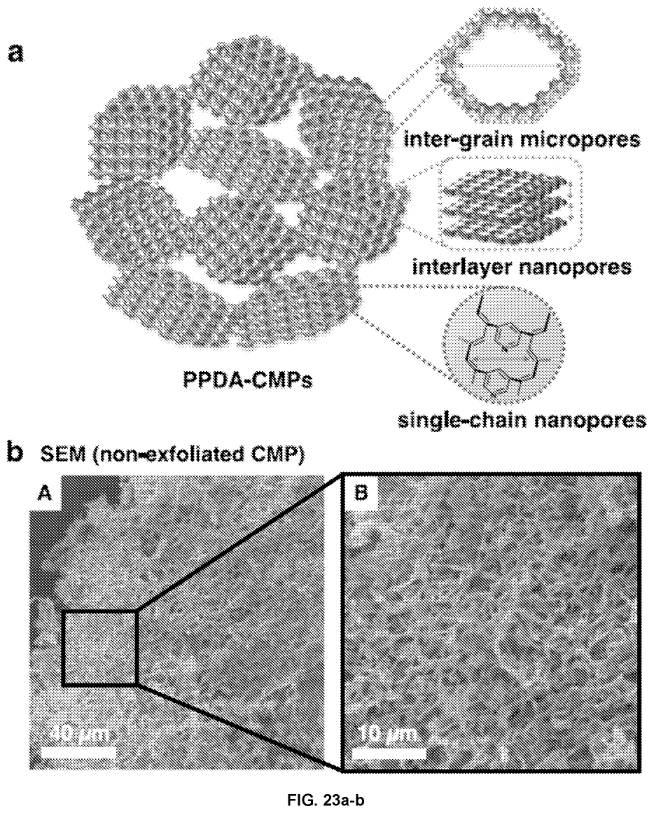

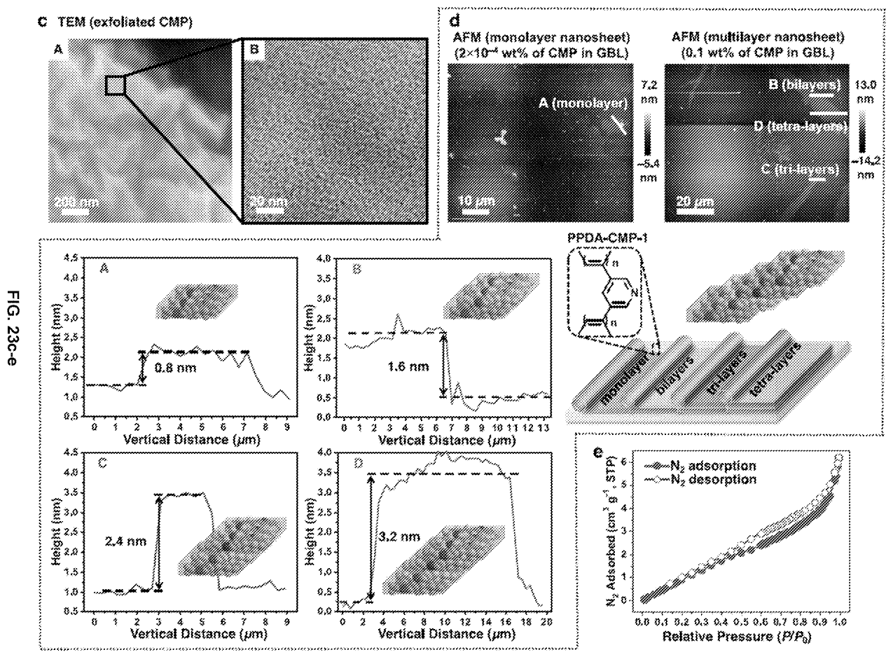

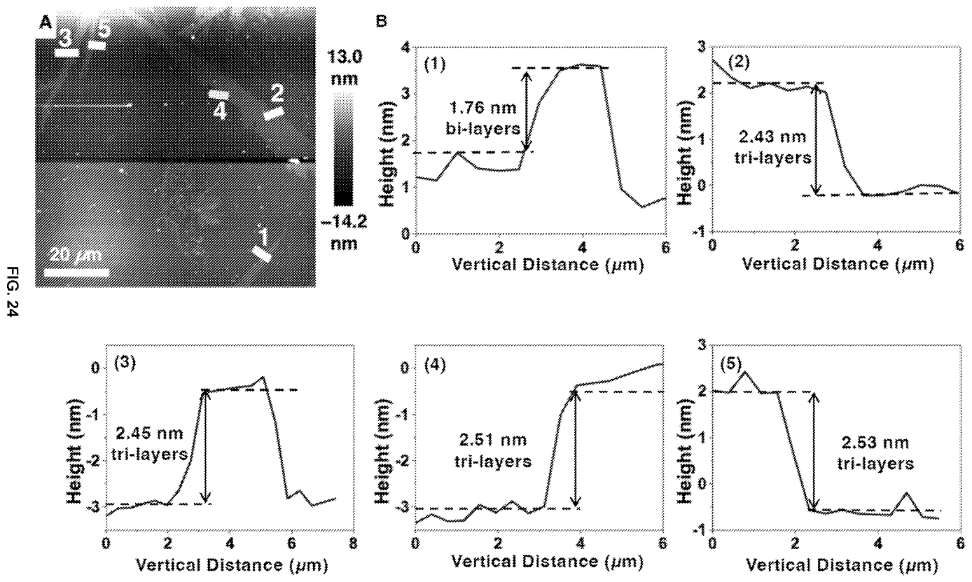

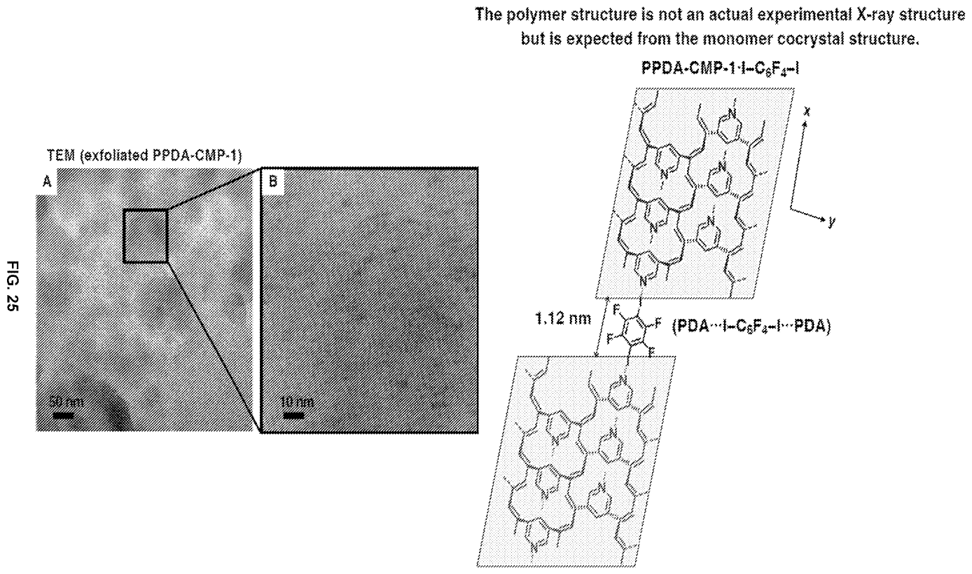

After the SPP, the polymerized 1.6, 1.7, 1.8, 2.6, and 2.7 cocrystals were purified (washed) with ethanol to remove the linkers and soluble polymers. After the linker removal, porous polymers and hence CMPs were obtained from 1.6, 1.7, and 1.8 (FIG. 23a), which are termed PPDA-CMP-1, PPDA-CMP-2, and PPDA-CMP-3, respectively. Here, PPDA is poly(pyridyl-3,5-diacetylene). The FTIR spectra of the CMPs (FIGS. 13-15) showed peaks at 1698-1721 cm⁻¹ for nonaromatic C═C bonds (polyacetylene backbone), as separated from the peaks at 1560-1639 cm⁻¹ for aromatic (pyridine) C═C bonds. The alkene C—H stretch (═C—H stretch) in the polyacetylene backbone also appeared at 2968-3047 cm-1. The results confirm the formation of the polyacetylene backbone. Besides nanometer-sized pores as described below, there were micrometer-sized pores (inter-grain micropores) (FIG. 23a), as observed with SEM (FIG. 23b). The obtained polymers formed multiple grains (FIG. 23a), and the grain sizes of the polymers corresponded to the grain sizes of the monomer cocrystals (as mentioned above) or were slightly larger due to possible fusion of the grains. The gaps between the grains were enlarged in the washing process (via the swelling in ethanol), which would generate the observed micrometer-sized pores. The TGA of the three CMPs showed that their 50% weight loss decomposition temperatures (T_{d(50%)} were 363-667° C. (FIGS. 18-20), demonstrating their high thermal stability. In addition, the FTIR study also showed that the linear polymers obtained from 2-6 to 2.7 contained polyacetylene backbones (FIGS. 16-17).

### Comparative Example 1

### Solution-Phase Polymerization (Comparison Experiment)

In a typical run, monomer 1 (0.10 g, 0.79 mmol) and DMPA (67.0 mg, 0.26 mmol) were dissolved in dichloromethane in a vial, in which XB linker was not added. The solution formed a thin liquid layer at the bottom of the vial. The vial was capped with a rubber septum, and oxygen was removed with an argon flow for 10 min. The solution was irradiated with UV light (I=365 nm) at room temperature for 40 h, yielding polymer. The solution was dropped in ethanol (10 mL) to precipitate polymer (insoluble polymer in ethanol) for separating out from soluble polymer, residual monomer, and residual DMPA. The insoluble polymer was separated by centrifugation.

The soluble part of the polymer in ethanol (10 mL) was reprecipitated into hexane (100 mL) to remove the residual monomer and DMPA, and analysed with GPC to determine the molecular weight and dispersity of the soluble part of the polymer. The monomer conversion was determined by analyzing the ethanol solution (containing soluble polymer and monomer) using 1H NMR and the weight of insoluble polymer (monomer conversion=(total amount of soluble polymer and insoluble polymer)/(total amount of monomer, soluble polymer, and insoluble polymer)).

Specifically, a mixture of 1 (0.10 g, 0.79 mmol), and DMPA (67.0 mg, 0.26 mmol) was dissolved in dichloromethane (2 mL) in a vial, in which 6 was not added. The solution formed a thin liquid layer at the bottom of the vial. The vial was capped with a rubber septum, and oxygen was removed with an argon flow for 10 mins. The solution was irradiated with UV light (/=365 nm) at room temperature for 40 h to obtain the polymer. The solution was dropped in ethanol (10 mL) to separate insoluble polymer from soluble polymer, residual monomer, and DMPA. The insoluble polymer was separated by centrifugation and obtained PPDA with brown color as the final product. The soluble part of the polymer in ethanol (10 mL) was reprecipitated into hexane (100 mL) to remove the residual monomer and DMPA and analysed with 1H NMR and GPC to determine the monomer conversion, molecular weight, and dispersity in the soluble part.

### Results and Discussion

For comparison (Table 5, entry C1), we conducted a solution-phase radical polymerization of 1 using DMPA as a photo-initiator and dichloromethane as a solvent but without using 6 (linker), giving a significantly lower monomer conversion (=10%). The insoluble (high-molecular-weight) polymer was only 18 wt %, which was significantly lower than that obtained from the SPP (97 wt %) (Table 5, entry 1). The result means the low reactivity of 1 in solution.

### Comparative Example 2

For comparison, we analyzed a polymer solid of 1 synthesized in the solution phase (as described in Comparative Example 1) and the original monomer solid of 1 (FIG. 1f). The PXRD pattern showed only a 6% matching (Table 4, entries 3 and 4), suggesting that the polymer solid was mostly amorphous. The polymer solids obtained from 1.7, 1.8, 2-6, and 2.7 via the SPP also had relatively high matchings (43-79%) (Table 4, entries 5-12, and FIG. 21). The results qualitatively show that the cocrystal structures were relatively largely retained during the SPP and that the polymerizations were crystal-to-crystal polymerizations with some deformation of the cocrystal structures, giving polycrystalline solids.

### Example 4. Iodine (I₂) Doping

Doping PPDA with I₂ Vapor (Boyle, C. J., et al., Nat. Commun. 2019, 10, 1-10)

In a typical run, 18 g iodine powder was loaded into a 20 mL capped glass vial and allowed for reaching solid-vapor equilibration of the iodine inside the vial at 100° C. for 10 min. In parallel, the PPDA-CMP-1 polymer film was heated in a separate vial at 100° C. for 10 min. The polymer film was subsequently placed into the iodine vial, which was capped tightly and heated at 100° C. for 30 min. The film of the PPDA obtained in the solution-phase polymerization in Comparative Example 1 was studied similarly.

### Surface Resistivity

The surface resistivity (ρₛ (Ω/sq)) values of the PPDA-CMP-1 and PPDA synthesized in solution polymerization were determined by a four-point technique with a Loresta-GP resistivity meter (Mitsubishi Chemical Analytech (Japan), MCP-T610) at room temperature. The polymers were pressed to form thin films using a manual hydraulic press (15T) prior to the analyses. The Loresta-GP MCP-T610 meter included a standard accessories PSP probe (MCP-TP06P, 4-pins, inter-pin distance 1.5 mm, pin points 0.26R, spring pressure 70 g/pin) and a probe checker (MPC-TRPS). The thicknesses (L (cm)) of the polymer films were measured by a high-precision digital caliper (Fowler ProMax-Cal, Japan). The electrical conductivity (o (S cm-1)) values were calculated according to equation (6):

$$σ = \frac{1}{{ρ}_{s} L} [ S {cm}^{- 1} ] \qquad ( 6 )$$

### Results and Discussion

The electronic conductivities (o) of PPDA-CMP-1 before and after 12 doping were measured at room temperature. The σ value increased from 2.4×10⁻⁹ S cm⁻¹ (before the doping) to 2.7×10⁻⁴ S cm-1 after the doping (Table 6, entry 1). For comparison, the σ value of the PPDA synthesized in the solution phase (Table 5, entry C1) increased from ≤10⁻⁹ S cm⁻¹ (below detection limit) to 8.3×10⁻⁵ S cm⁻¹ after the doping (Table 6, entry 2). Both before and after the doping, the σ values of PPDA-CMP-1 were larger than those of the PPDA synthesized in the solution phase, because PPDA-CMP-1 had a longer π-conjugation (a higher-molecular weight) than the PPDA synthesized in the solution phase. The porous structure of PPDA-CMP-1 could also enhance the adsorption of 12 vapor during the doping process, increasing electron carrier mobility. The observed σ value (2.7×10⁻⁴ S cm⁻¹) of the doped PPDA-CMP-1 is not remarkably high but still comparable with those of doped substituted polyacetylenes (σ=10⁻⁴-10² S cm⁻¹) (Poddar, A. K., Patel, S. S. & Patel, H. D., Polym. Adv. Technol. 2021, 32, 4616-4641), and the doped PPDA-CMP-1 would be categorized to a semiconducting polymer.

TABLE 6
Conductivities of PPDA-CMP-1 and PPDA synthesized in solution-
phase polymerization (Table 5, entries 1 and C1).

| | Synthetic | | Conductivity (σ) (S cm⁻¹) | |
|---|---|---|---|---|
| Entry | mode | Polymer | Before I₂ doping | After I₂ doping |
| 1 | SPP | PPDA-CMP-1 | 2.4 × 10⁻⁹ | 2.7 × 10⁻⁴ |
| 2 | Solution | PPDA | NA (<10⁻⁹)^{a} | 8.3 × 10⁻⁵ |

^{a}Below the detection limit of the utilized instrument.

### Example 5. 2D Exfoliated Structures of PPDA-CMPs

### Exfoliation of PPDA-CMPs

PPDA-CMP-1 (4 mg) was dispersed in 4 mL of GBL and sonicated for 30 mins to obtain a 0.1 wt % dispersed solution. A part of the solution was further diluted 500 times in GBL to obtain a 2× 10-4 wt % dispersed solution. The two solutions (0.1 and 2×10⁻⁴ wt % solutions) were heated at 50° C. for 5 days with gentle stirring to induce exfoliation (Kissel, P. et al., Nat. Chem. 2014, 6, 774-778). Subsequently, the dispersed solution (1 μL) was dropped on Cu grids and cleaned Si wafers and dried under vacuum for TEM and AFM analysis, respectively. PPDA-CMP-2 and PPDA-CMP-3 were exfoliated similarly. The 0.1 wt % solutions were used for the AFM analysis of exfoliated PPDA-CMP-1 for FIGS. 23d (right) and 24. The 2×10⁻⁴ wt % solutions were used for all other TEM and AFM analyses of exfoliated PPDA-CMP-1, PPDA-CMP-2, and PPDA-CMP-3 for FIGS. 23c, 23d (left), 25, 26b, 27b, 28 and 29.

### Results and Discussion

The three CMPs were dispersed in GBL at two different concentrations (0.1 and 2×10⁻⁴ wt % of CMP in GBL). After gentle stirring at 50° C. for 5 days, exfoliation of 2D polymer nanosheets was observed (as described below), demonstrating that the obtained CMPs were 2D CMPs. We observed exfoliation in GBL but not in ethanol. We used ethanol to remove the linkers (as mentioned above in Example 3) and used GBL to exfoliate polymer sheets because PPDA is more miscible in GBL.

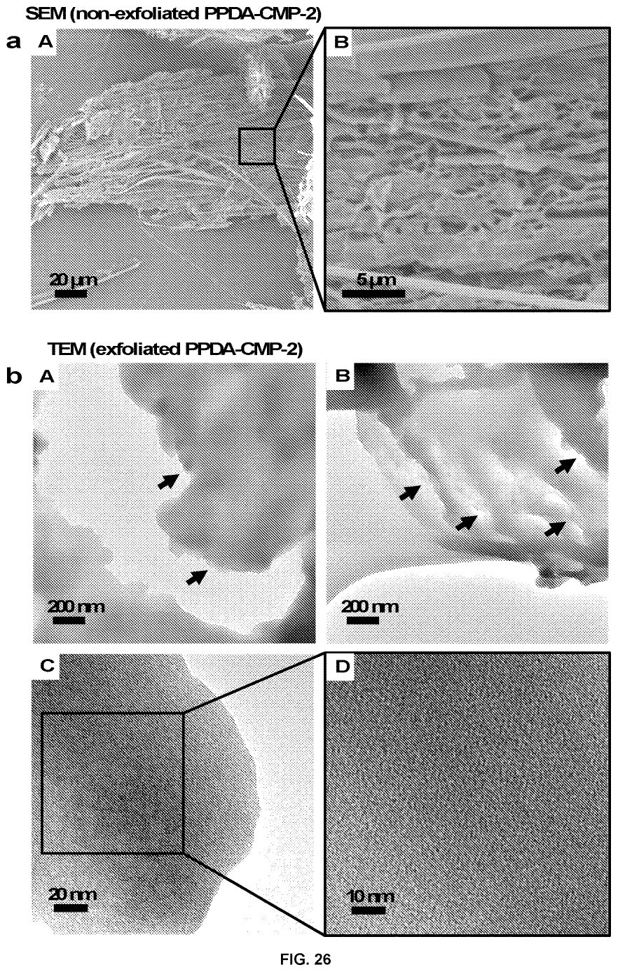

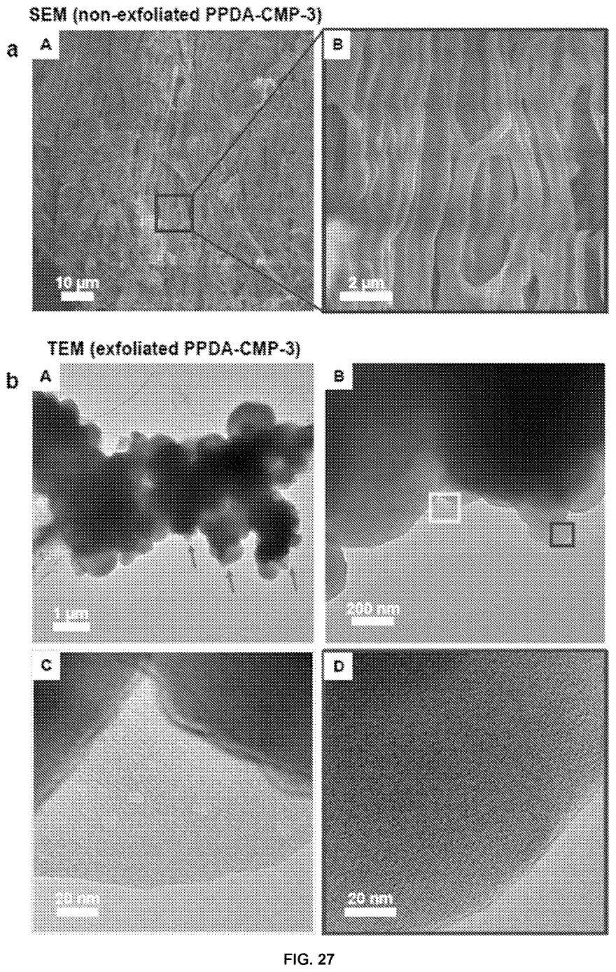

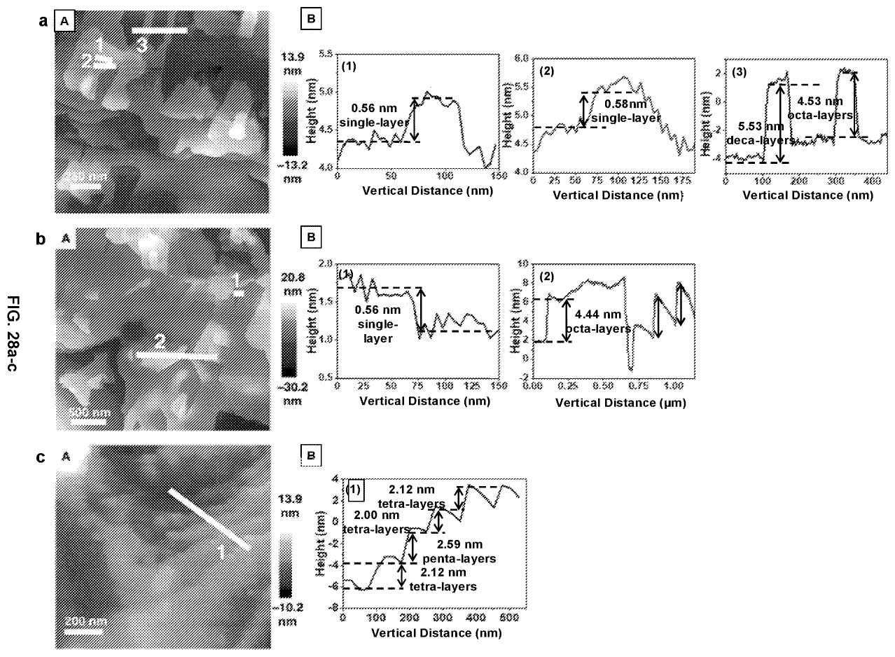

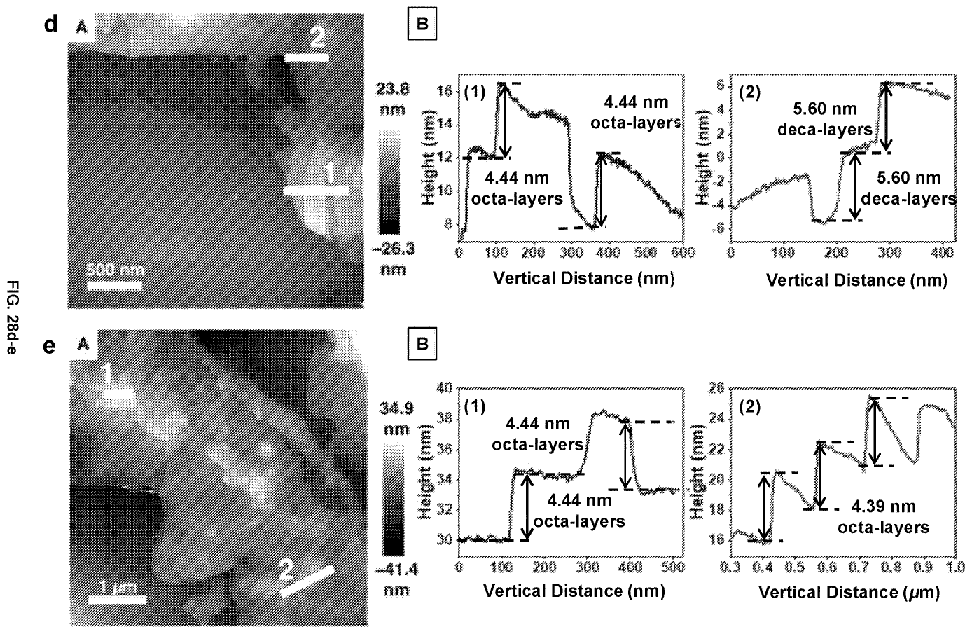

For PPDA-CMP-1 (FIGS. 1d and 25), based on the monomer cocrystal (1.6) structure, ladder-shaped polymer chains would grow on the x-axis and be further connected to the neighboring ladder-shaped polymer chains on the y-axis, forming nanosheets in the x-y plane (FIG. 1d (A)). The nanosheets would be bridged by the XB linkers to form layer-by-layer nanosheet structures on the z-axis. When the linkers were removed in ethanol, gaps would be generated between the nanosheets but the nanosheets would still be associated. In GBL, the nanosheets could be exfoliated because of the increased miscibility of the nanosheets in GBL. Because of the rigid polyacetylene backbones and ladder-shaped structures, the resultant nanosheets were rigid and retained the 2D structures even after the linker removal. For PPDA-CMP-2 and PPDA-CMP-3, exact polymer structures are not deducible because single cocrystals of 1.7 and 1.8 were not obtained, but ladder-shaped (nano-porous) polymers were likely generated as observed with TEM (below) (FIGS. 26b and 27b).

For the three CMPs, the dispersions of CMPs were drop-casted on Cu grids and Si wafers and characterized using TEM and AFM, respectively. The TEM images of CMPs (dispersed at 2×10⁻⁴ wt %) showed exfoliated multi-layered nanosheets (FIGS. 23c (image A), 25 (image A), 26b (images A and B), and 27b (images A and B)) and nano-porous structures on the outermost surface of the nanosheets (FIGS. 23c (image B), 25 (image B), 26b (images C and D), and 27b (images C and D)) for all three CMPs. The pore sizes were 1.1, 0.9, and 1.0 nm for PPDA-CMP-1, 2, and 3, respectively. There were three types of pores with different sizes (FIG. 23a). The first pores are nanometer-sized pores corresponding to voids in the ladder-shaped polymer chains (single-chain nanopores). The pores observed in the TEM images most likely correspond to the single-chain nanopores. The second pores were nanometer-sized pores generated between the nanosheets during the linker removal (interlayer nanopores). The interlayer distances would depend on the nanosheet structures. After the linker removal, the interlayer distances would be determined by attractive and repulsive forces between the nanosheets and hence by the polymer structures. The linkers can influence both single-chain and nanosheet structures and hence modulate the sizes of the single-chain and interlayer nanopores. The third micrometer-sized pores result from micrometer-sized gaps between different crystal grains in the polycrystalline polymer solids (inter-grain pores), as mentioned above. Thus, we observed the single-chain nanopores using TEM (FIG. 23c) and the inter-grain micropores using SEM (FIG. 23b), as described above, and also all three pores using BET analysis, as described below in Example 6.

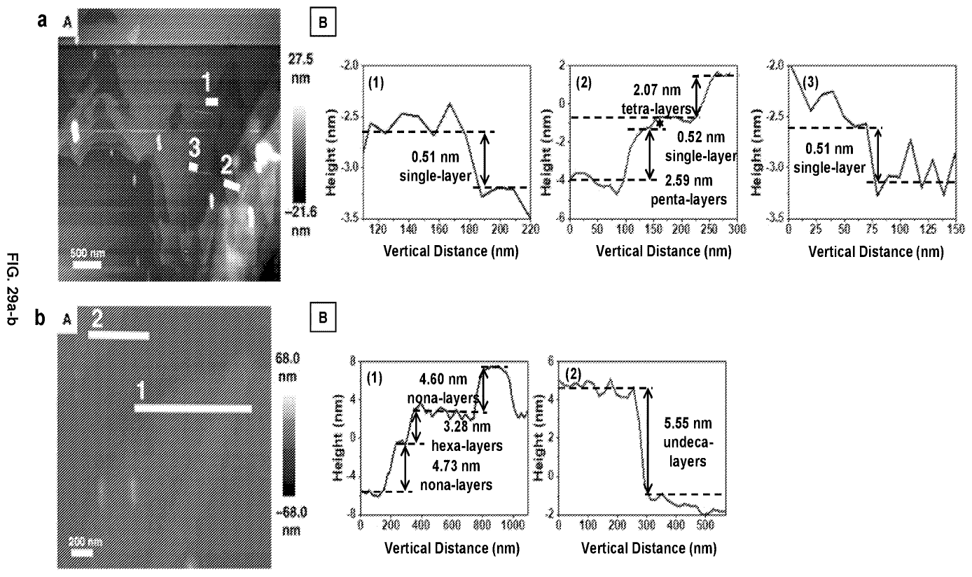

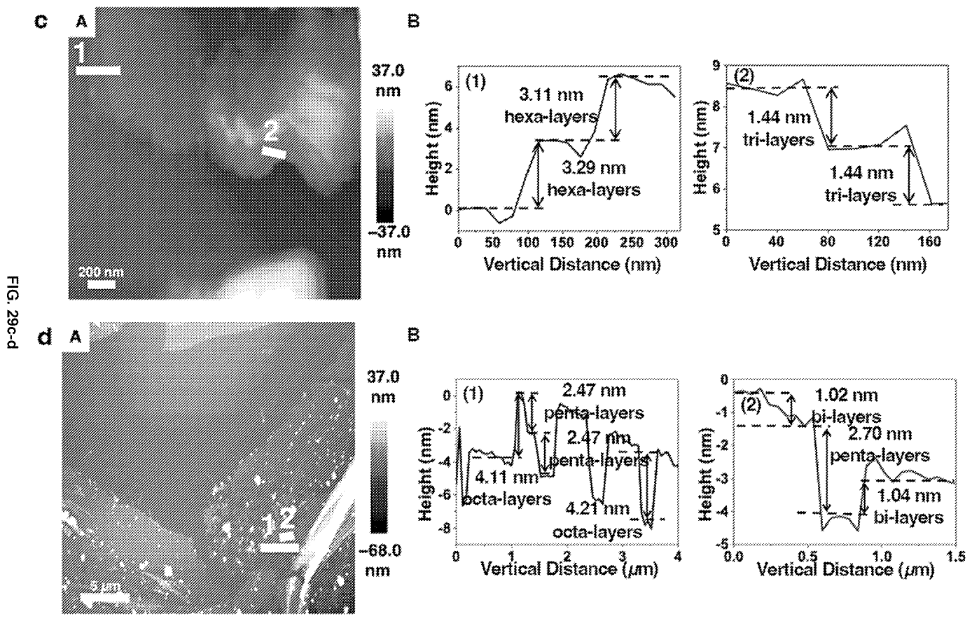

We analyzed the PPDA-CMP-1 nanosheet exfoliated at 2×10⁻⁴ wt % using AFM and observed a mono-layer structure with a thickness of ˜0.8 nm (FIG. 23d). At the higher exfoliation concentration (0.1 wt %) of PPDA-CMP-1, multilayer structures, i.e., bi-, tri-, and tetra-layered structures were observed with thicknesses of 1.6, 2.4, and 3.2 nm, respectively (FIGS. 23d and 24). Similarly, exfoliated PPDA-CMP-2 and PPDA-CMP-3 showed mono-layer structures with thicknesses of 0.5-0.6 nm and also bi- to undeca-layered multilayer structures (FIGS. 28-29). It should be noted that all three CMPs underwent partial exfoliations (not full exfoliations) in GBL, probably because PPDA nanosheets are not fully miscible in GBL or some nanosheets are covalently bonded during the polymerization (SPP) because of possible defects in the cocrystals.

### Example 6. BET Analysis

### BET Analysis

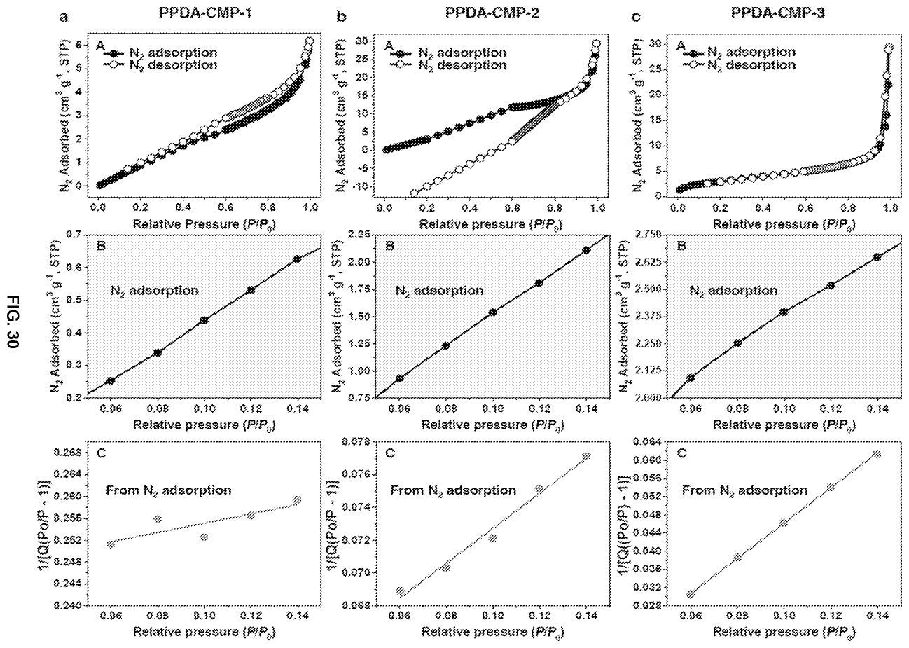

The surface areas of PPDA-CMP-1, PPDA-CMP-2, and PPDA-CMP-3 were analyzed with a Micromeritics 3FLEX (Micromeritics, USA) analyzer at −196° C. Before measurement, the samples were degassed totally in the nitrogen (N₂) atmosphere at 120° C. for 24 h and then backfilled with N₂. We studied the relative pressure (P/P₀) from 0 to 1 at −196° C., where P₀ is the saturated pressure of adsorbent (N₂). The specific surface areas (m² g⁻¹) were determined via BET model at the linearized P/P₀ range from 0.06 to 0.14 according to equation (7):

$$\frac{1}{Q ( ( {P}_{0} / P ) - 1 )} = \frac{1}{{Q}_{m} {c}_{B E T}} + \frac{( {c}_{B E T} - 1 )}{{Q}_{m} {c}_{B E T}} ( \frac{P}{{P}_{0}} ) \qquad ( 7 )$$

where Q is the volume of nitrogen gas adsorbed per weight of adsorbent (cm³ g⁻¹ STP) at a given relative pressure (P/P₀), Qₘ is the volume of nitrogen gas adsorbed to form the monolayer per weight of adsorbent (cm³ g⁻¹ STP), and c_{BET} is the BET constant (STP is standard condition at temperature 273 K and pressure 1 atm). The plot of 1/(Q((P₀/P)−1)) vs P/P₀ was linear of N₂ adsorption for all studied cases (FIG. 30), which indicates the formation of the monolayer in this range (P/P₀=0.06-0.14). From the slope and intercept of the plot, the c_{BET} and Qₘ values were determined. The BET specific surface area (S_{BET}, cm² g⁻¹) was calculated from Qₘ according to equation (8):

$${S}_{B E T} = \frac{{Q}_{m} {N}_{A} {A}_{m}}{{M}_{v}} \qquad ( 8 )$$

where the N_{A} is Avogadro's number (6.022×10²³ mol⁻¹), Aₘ is the molecular cross-sectional area for liquid N₂ (0.162 nm²), and My is the molar volume for the ideal gas at STP (22414 cm³ mol⁻¹).

The average pore diameter (d_{BET} (nm)) was calculated at P/P₀=0.99, assuming a cylindrical pore. At P/P₀=0.99, the pores were assumed to be completely filled with N₂ and the total volume (V_{BET}) of the adsorbed N₂ can be considered as the total pore volume. The d_{BET} (nm) was calculated according to equation (9):

$${d}_{B E T} = \frac{4 {V}_{B E T}}{{S}_{B E T}} \qquad ( 9 )$$

$$where {V}_{B E T} is the Q at P / {P}_{0} = 0.99 .$$

### Results and Discussion

We determined the surface areas of non-exfoliated PPDA-CMP-1, 2, and 3 (after removal of linkers but not exfoliation) using the BET method. The specific surface areas were determined to be 13, 26, and 11 m² g⁻¹ for PPDA-CMP-1, PPDA-CMP-2, and PPDA-CMP-3, respectively (Table 7, entries 1-3). FIG. 23e shows the nitrogen (N₂) adsorption isotherm of PPDA-CMP-1 studied at the relative pressure (P/P₀) from 0 to 1 at −196° C., where P₀ is the saturated pressure of adsorbent (N₂). The estimated specific surface area (S_{BET}) was 13 m² g⁻¹ (FIG. 30a and Table 7, entry 1). The estimated pore size (d_{BET}) was 2.9 nm (Table 7, entry 1), which is slightly larger than that estimated from the TEM analysis (1.1 nm). This is because the non-exfoliated CMP contained all three (single-chain, interlayer, and intergrain) pores and their average pore size was determined by the BET analysis, while the exfoliated CMP contained only the single-chain pore and its size was determined by the TEM analysis.

TABLE 7
BET analysis data of PPDA-CMPs (FIG. 30).

| | | | Qₘ | | V_{BET} | |
|---|---|---|---|---|---|---|
| | | | (cm³ g⁻¹ | S_{BET} | [×10⁻³] | d_{BET} |
| Entry | CMP | c_{BET}^{a} | STP)^{b} | (m² g⁻¹)^{c} | (cm³ g⁻¹)^{d} | (nm)^{e} |
| 1 | PPDA-CMP-1 | 1.3 | 3.0 | 13 | 9.6 | 2.9 |
| 2 | PPDA-CMP-2 | 2.7 | 5.9 | 26 | 46 | 7.1 |
| 3 | PPDA-CMP-3 | 53 | 2.5 | 11 | 46 | 17 |

^{a}BET constant.
^{b}Monolayer adsorbed gas volume.
^{c}BET specific surface area.
^{d}Volume of adsorbed gas at P/P₀ = 0.99.
^{e}(Average) pore diameter.

The BET analysis showed that PPDA-CMP-2 and PPDA-CMP-3 had SBET values of 26 and 11 m² g⁻¹, respectively, and d_{BET} values of 7.1 and 17 nm, respectively (FIGS. 30b-c and Table 7, entries 2 and 3). These d_{BET} values (7.1 and 17 nm) are much larger than those (0.9 and 1.0 nm) estimated from the TEM analysis, suggesting significant contributions of interlayer and intergrain pores for PPDA-CMP-2 and PPDA-CMP-3. Thus, using the same monomer q(PDA (1)) but using different XB linkers (6-8), we were able to vary CMP structures with respect to surface areas and pore sizes, demonstrating tuneable CMP structures driven by XB.

### Example 7. Applications in High-Performance Metal-Ion Adsorption

### Inductively Coupled Plasma Optical Emission Spectrometer (ICP-OES)

An ICP-OES (ICAP 6500, Thermo Scientific, US) was used to determine the metal ion concentrations (ppm or mg L⁻¹) of the samples. The simultaneous axial and radial view of the plasma was enabled by a synchronous vertical dual view (SVDV). The analytical conditions are: radio frequency (RF) power 1150 W; nebulizer gas flow 0.08 L min-1; auxiliary gas flow 1.0 L min⁻¹; plasma gas flow 12.0 L min⁻¹; and signal accusation time 3 s/replicate for 3 replicates. All standards and samples were dissolved (diluted) in nitric acid (2 wt % in ultrapure water) before analysis. Metal ions Li, Rb, Cs, and B were analysed individually at wavelength λ=670.784, 780.023, 672.328, and 249.773 nm, respectively, with the correlation factor of the calibration curve R²>0.999. For all the elements determined, the uncertainty of the analytical concentration (RSD) was <5% (before multiplying the dilution factors).

### XPS

XPS analysis was carried out with a Phoibos 100 spectrometer and a monochromatic Mg X-ray radiation source (SPECS, Germany). PPDA-CMP-1 before and after metal ion desorption were attached on a clean Si wafer and directly used for the XPS analysis.

### SEM-Energy Dispersive Spectroscopy (SEM-EDS)

Scanning electron microscopy (SEM) was performed with a JEOL-JSM-7600F microscope (Japan) equipped with an energy-dispersive detector (X-Max, Oxford Instruments, UK) for energy dispersive X-ray spectroscopy (EDS). The PPDA-CMP-1 before and after B³⁺ ion desorption were coated with Pt with power of 20 mA for 30 s before the SEM-EDS analysis.

### Adsorption and Desorption of Metal Ions

PPDA-CMP-1, PPDA-CMP-2, and PPDA-CMP-3 were placed in an oven at 120° C. overnight prior to adsorption for activation and subsequently were immersed in 1000 ppm solutions containing desired metal ions (0.1 wt % metal ions).

For the Li⁺ adsorption (0.1 wt % of Li⁺), LiOH·H₂O (0.302 g, 7.20 mmol) was dissolved in 50 mL of H₂O. Similar preparations were carried out for the mixed ion solution (Li⁺+Rb⁺+Cs⁺ at 0.1 wt % for each) (LiOH·H₂O (0.302 g, 7.20 mmol), RbOH (50 wt % in water) (0.1199 g, 0.585 mmol), and CsOH·H₂O (0.063 g, 0.376 mmol)) and the B³⁺ solution (0.1 wt % of B³⁺) (NH₄BF₄ (0.485 g, 4.625 mmol)). PPDA-CMP (12.5 mg) was subsequently added to each solution. The mixture was sonicated four times for 1 h in total (15 min each time) at a 600 W ultrasonication power and then left overnight for 24 h at room temperature.

The ion-adsorbed PPDA-CMPs were rinsed with water three times to fully remove ions possibly covering the surface of the CMP powder and dried under vacuum for 24 h to obtain the ion-absorbed PPDA-CMP-1, PPDA-CMP-2, and PPDA-CMP-3 as dark brown, yellow-brown, and brown solids, respectively. The solution parts before and after adsorption were filtered, diluted 500 times (with HNO₃ 2 wt % in ultrapure water), and analysed with ICP-OES to determine the ion concentrations in the solutions before and after adsorption (Tables 8-11). The content of metal ion (wt %) was calculated according to equation (10):

$$wt \% = ( {C}_{0} - C ) \times \frac{{v}_{sol}}{{m}_{( P P D A - C M P )}} \times 100 \% \qquad ( 10 )$$

$$where :$$

$${C}_{0} is the concentration of metal ion before adsorption [ ppm or mg {L}^{- 1} ] ;$$

$$C is the concentration of metal ion after adsorption [ ppm or mg {L}^{- 1} ] ;$$

$${V}_{sol} is the volume of the metal ion solution [ L ] ; and$$

$${m}_{( PDDA - CMP )} is the mass of PPDA - CMP [ mg ] .$$

The rinsed water was also analysed using ICP-OES, showing the amount of the ions covering the CMP surface was negligible (below the analytical detection limit) compared with the amount of ions adsorbed inside the CMP in all cases.

TABLE 8
Adsorption of metal ions by PPDA-CMP-1, 2, and
3 and PPDA synthesized in solution phase.

| | | Metal Solution | Amount of metal |
|---|---|---|---|
| | | (0.1 wt % (1000 | ion adsorbed per |
| Entry | CMP | ppm) of metal ion⁺) | CMP (mg/g CMP)^{a} |
| 1 | PPDA-CMP-1 | LiOH | 312 |
| 2 | PPDA-CMP-2 | LiOH | 84 |
| 3 | PPDA-CMP-3 | LiOH | 228 |
| C1 | PPDA synthesized | LiOH | 54 |
| | in solution | | |
| 4 | PPDA-CMP-1 | LiOH + RbOH + | 306 (Li⁺), 0 (Rb⁺)^{b}, |
| | | CsOH | 0 (Cs⁺) |
| 5 | PPDA-CMP-2 | LiOH + RbOH + | 72 (Li⁺), 4 (Rb⁺), |
| | | CsOH | 0 (Cs⁺) |
| 6 | PPDA-CMP-3 | LiOH + RbOH + | 168 (Li⁺), 84 (Rb⁺), |
| | | CsOH | 0 (Cs⁺) |
| C2 | PPDA synthesized | LiOH + RbOH + | 52 (Li⁺), 4 (Rb⁺), |
| | in solution | CsOH | 0 (Cs⁺) |
| 7 | PPDA-CMP-1 | NH₄BF₄ | 196 |
| 8 | PPDA-CMP-2 | NH₄BF₄ | 17 |
| 9 | PPDA-CMP-3 | NH₄BF₄ | 0 |
| C3 | PPDA synthesized | NH₄BF₄ | 7 |
| | in solution | | |

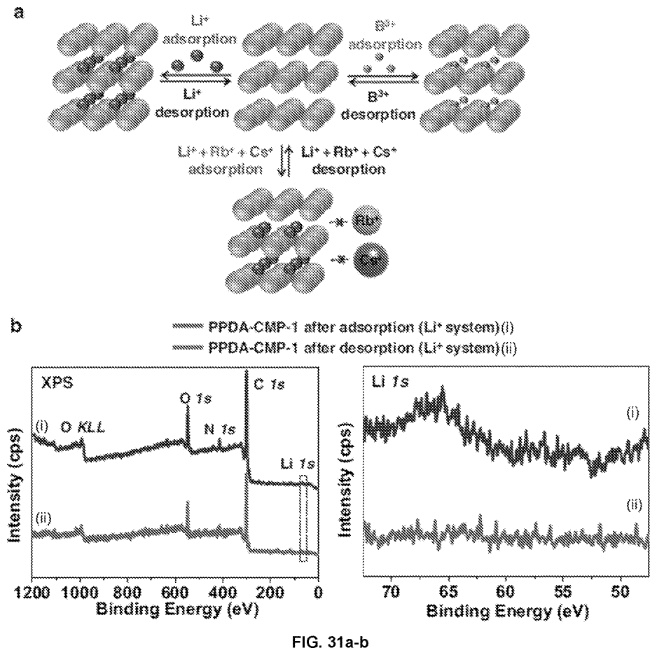

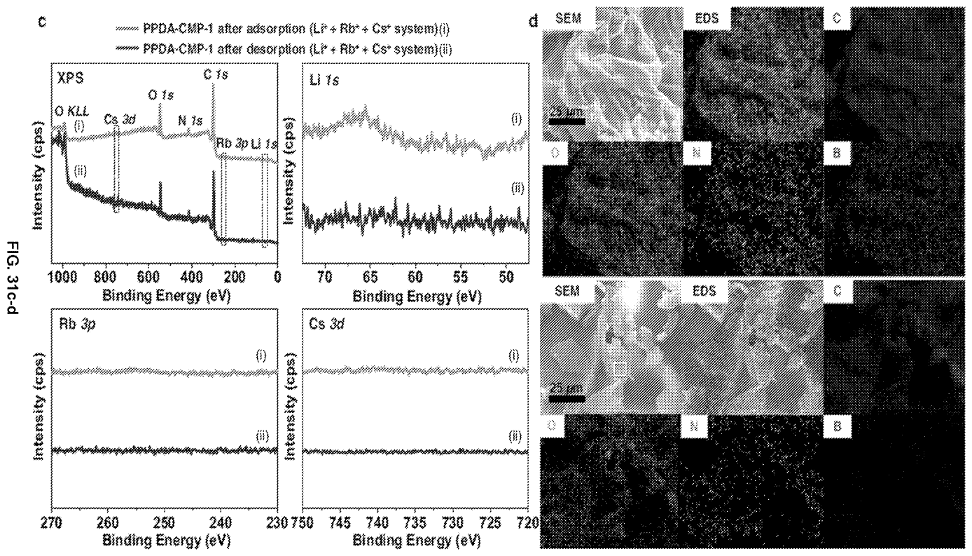

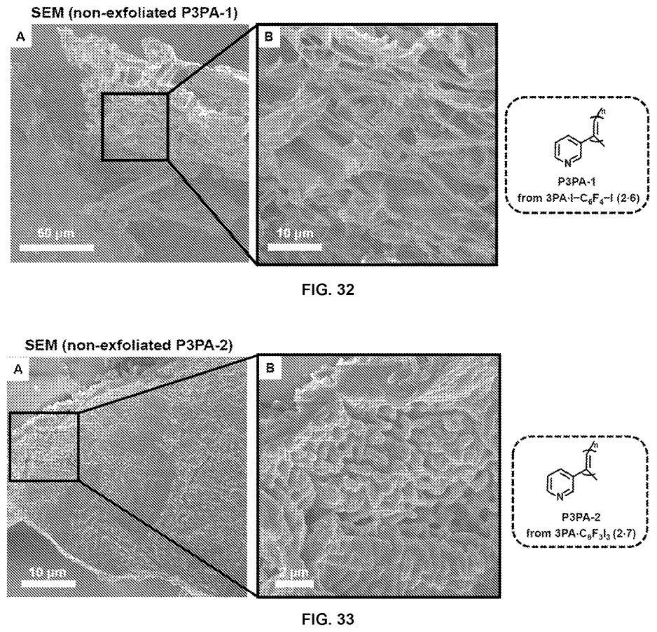

^{a}The metal ion adsorption was determined with ICP-OES (Table 9).
^{b}The amount of Cs⁺ adsorbed per CMP was nearly zero according to the XPS analysis (FIG. 31c).

TABLE 9
Metal-ion adsorption of PPDA-CMPs and PPDA synthesized in solution-phase polymerization.

| | | | | | | | | | | Amount of metal ion | |
|---|---|---|---|---|---|---|---|---|---|---|---|
| | Synthetic | | Metal | Metal ion concentration in solution (mg L⁻¹) | | | | | | adsorbed per CMP | |
| Entry | mode | Polymer | solution | Before adsorption^{a} | | After adsorption^{a} | | Difference^{b} | | (mg/g CMP) | |
| 1 | SPP | PPDA-CMP-1 | LiOH^{c} | 1026.5 | (±5.0) | 948.5 | (±7.0) | 78.0 | (±7.0) | 312 | (±28) |
| 2 | SPP | PPDA-CMP-2 | | 1042 | (±8) | 1021 | (±10) | 21 | (±10) | 84 | (±40) |
| 3 | SPP | PPDA-CMP-3 | | 1042 | (±8) | 985.0 | (±13.5) | 57.0 | (±13.0) | 228 | (±52) |
| Cl | Solution | PPDA | | 971.5 | (+ 2.0) | 958.0 | (±0.0) | 13.5 | (±1.6) | 54 | (±6) |
| 4 | SPP | PPDA-CMP-1 | LiOH + | 1000.0 (±3.0) (Li) | | 923.5 (±6.0) (Li) | | 76.5 (±5.5) (Li) | | 306 (±22) (Li) | |
| | | | RbOH + | 1411.5 (±5.0) (Rb) | | 1417.0 (±10.5) (Rb) | | −5.5 (±9.5) (Rb) | | 0 (0-16) (Rb) | |
| 5 | SPP | PPDA-CMP-2 | CsOH^{d} | 1021.0 (±5.0) (Li) | | 1003.0 (±3.5) (Li) | | 18.0 (±5.0) (Li) | | 72 (±20) (Li) | |
| | | | | 1286.5 (±5.5) (Rb) | | 1285.5 (±6.5) (Rb) | | 1.0 (±7.0) (Rb) | | 4 (0-32) (Rb) | |
| 6 | SPP | PPDA-CMP-3 | | 1021.0 (±5.0) (Li) | | 979.0 (±6.0) (Li) | | 42.0 (±6.4) (Li) | | 168 (±26) (Li) | |
| | | | | 1264.0 (±7.5) (Rb) | | 1243.0 (±7.0) (Rb) | | 21.0 (±8.4) (Rb) | | 84 (±34) (Rb) | |
| 7 | SPP | PPDA-CMP-1 | NH₄BF₄^{e} | 1057 | (±1) | 1008 | (±2) | 49 | (±2) | 196 | (±8) |
| 8 | SPP | PPDA-CMP-2 | | 943.1 | (±2.5) | 938.9 | (±3.1) | 4.2 | (±3.2) | 17 | (±13) |
| 9 | SPP | PPDA-CMP-3 | | 943.1 | (±2.5) | 950.4 | (±1.8) | −7.3 | (±2.5) | 0 | (±10) |
| C3 | Solution | PPDA | | 890.1 | (±4.6) | 888.3 | (±0.4) | 1.8 | (±3.8) | 7 | (±15) |

^{a}Uncertainty (error range) with three-time repeated analysis.
^{b}Difference in the concentrations before and after adsorption (C₀ − C in equation (10)). The uncertainty is the root-mean-square averaged uncertainty in the concentration difference before and after adsorption.
^{c}0.1 wt % of Li⁺ in water.
^{d}0.1 wt % of Li⁺ + 0.1 wt % of Rb⁺ + 0.1 wt % of Cs⁺ in water.
^{e}0.1 wt % of B³⁺ in water.

TABLE 10
Adsorption of metal ions by PPDA-CMP-1 in three cycles.

| | | Metal Solution (0.1% | Amount of metal ion |
|---|---|---|---|
| | | wt (1000 ppm) of | adsorbed per CMP |
| Entry | Cycle | metal ion⁺) | (mg/g CMP)^{a} |
| | First | LiOH | 312 |
| 1 | Second | LiOH | 320 |
| | Third | LiOH | 308 |
| | First | LiOH + RbOH + CsOH | 306 (Li) and 0 (Rb)^{b} |
| 2 | Second | LiOH + RbOH + CsOH | 240 (Li) and 0 (Rb) |
| | Third | LiOH + RbOH + CsOH | 188 (Li) and 0 (Rb) |
| | First | NH₄BF₄ | 196 |
| 3 | Second | NH₄BF₄ | 172 |
| | Third | NH₄BF₄ | 96 |

^{a}The metal ion adsorption was determined with ICP-OES (Table 11).
^{b}The amount of Cs+ adsorbed per CMP was nearly zero according to the XPS analysis (FIG. 31c).

TABLE 11
Metal ions adsorption of PPDA-CMP-1 in three cycles.

| | | Metal | Metal ion concentration in solution (mg L⁻¹) | | | | | | Amount of metal ion adsorbed per | |
|---|---|---|---|---|---|---|---|---|---|---|
| Entry | Cycle | solution | Before adsorption^{a} | | After adsorption^{a} | | Difference^{b} | | CMP (mg/g CMP) | |
| 1 | first | LiOH^{c} | 1026.5 | (±5.0) | 948.5 | (±7.0) | 78.0 | (±7.0) | 312 | (±28) |
| | second | | 1026.5 | (±5.0) | 946.5 | (±4.0) | 80.0 | (±5.2) | 320 | (±21) |
| | third | | 1026.5 | (±5.0) | 949.5 | (±5.5) | 77.0 | (±6.1) | 308 | (±24) |
| 2 | first | LiOH + | 1000.0 (±3.0) (Li) | | 923.5 (±6.0) (Li) | | 76.5 (±5.5) (Li) | | 306 (±22) (Li) | |
| | | RbOH + | 1411.5 (±5.0) (Rb) | | 1417.0 (±10.5) (Rb) | | −5.5 (±9.5) (Rb) | | 0 (0-16) (Rb) | |
| | | CsOH^{d} | | | | | | | 0 (Cs) | |
| | second | | 1000.0 (±3.0) (Li) | | 940.0 (±9.5) (Li) | | 60.0(±8.1) (Li) | | 240 (±32) (Li) | |
| | | | 1411.5 (±5.0) (Rb) | | 1423.5 (±4.5) (Rb) | | −12.0 (±5.5) (Rb) | | 0 (0-26) (Rb) | |
| | | | | | | | | | 0 (Cs) | |
| | third | | 1000.0 (±3.0) (Li) | | 953.0 (±1.5) (Li) | | 47.0 (±2.7) (Li) | | 188 (±11) (Li) | |
| | | | 1411.5 (±5.0) (Rb) | | 1472.0 (±7.0) (Rb) | | −60.5 (±7.0) (Rb) | | 0 (~0) (Rb) | |
| | | | | | | | | | 0 (Cs) | |
| 3 | first | NH₄BF₄^{e} | 1057 | (±1) | 1008 | (±2) | 49 | (±2) | 196 | (±8) |
| | second | | 1079 | (±2) | 1036 | (±3) | 43 | (±3) | 172 | (±12) |
| | third | | 1079 | (±2) | 1055 | (±1) | 24 | (±2) | 96 | (±8) |

^{a}Uncertainty (error range) with three-time repeated analysis.
^{b}Difference in the concentrations before and after adsorption (C₀ − C in equation (10)). The uncertainty is the root-mean-square averaged uncertainty in the concentration difference before and after adsorption.
^{c}0.1 wt % of Li⁺ in water.
^{d}0.1 wt % of Li⁺ + 0.1 wt % of Rb⁺ + 0.1 wt % of Cs⁺ in water.
^{e}0.1 wt % of B³⁺ in water.

### Results and Discussion

We studied ion adsorption of non-exfoliated PPDA-CMP-1, 2, and 3 in water (FIG. 31a). The studied ions were alkaline metal ions with different sizes, i.e., Li⁺, rubidium (Rb⁺), and cesium (Cs⁺) ions, and a group 13 ion, i.e., B³⁺. PPDA contains electron-donating nitrogen atoms, which can coordinate those cations. PPDA-CMP-1 (12.5 mg) was immersed in an aqueous solution (50 mL) containing Li⁺ (0.1 wt %), sonicated for 1 h, and left overnight at room temperature. We measured Li⁺ concentrations in the aqueous solution before and after the adsorption using ICP-OES, showing that PPDA-CMP-1 adsorbed 312 mg of Li⁺ per 1 g of CMP (31.2 wt % Li⁺ adsorption) (Table 8, entry 1 and Table 9, entry 1). This value (31.2 wt % Li⁺ adsorption) is the highest record of adsorption capacity in the area of Li⁺ adsorption. To the best of our knowledge, the maximum Li adsorption capacity previously reported is 7.67 wt % using H₂TiO₃ (Sun, Y. et al., Sep. Purif. Technol. 2021, 256, 117807; and Wang, S. et al., RSC Adv. 2016, 6, 102608-102616). Also, markedly, PPDA-CMP-1 showed selective Li⁺ adsorption from a mixed solution of Li⁺, Rb⁺, and Cs⁺ (0.1 wt % for each). We observed only Li⁺ adsorption (30.6 wt % Li⁺ adsorption) but no Rb⁺ or Cs⁺ adsorption (Table 8, entry 4, and Table 9, entry 4). (The adsorption of Cs⁺ was studied using XPS, as described below, because of insufficient sensitivity of ICP-OES to Cs⁺.) This selectivity is probably because the Li⁺ . . . N coordination was stronger than the Rb⁺ . . . N and Cs⁺ . . . N coordination due to the higher charge density of Li⁺ and because aromatic rings (or conjugated carbons) might have Li⁺ capacities as observed in electrochemical systems (Han, X. et al., Angew. Chem. Int. Ed. 2012, 51, 5147-5151; Wu, J. et al., Angew. Chem. Int. Ed. 2015, 54, 7354-7358; and Wu, J. et al., Adv. Energy Mater. 2015, 5, 1402189). The atomic diameter of Li⁺ (0.31 nm) is small enough for Li⁺ to be incorporated in single-chain pores (with 1.1 nm pore sizes according to the TEM analysis), rationalizing the Li⁺ adsorption. The atomic diameters of Rb⁺ (0.50 nm) and Cs⁺ (0.53 nm) are also small enough, but no incorporation was observed. In an aqueous solution of B³⁺ (0.1 wt %), PPDA-CMP-1 achieved 19.6 wt % B³⁺ adsorption (Table 8, entry 7, and Table 9, entry 7). This value (19.6 wt % B³⁺ adsorption) is also among the highest adsorption capacities previously reported for B³⁺ (12.8-30.3 wt %) (Oladipo, A. A. & Gazi, M., Chem. Eng. Res. Des. 2017, 121, 329-338; and Demir [symbol] ivi, P. & Sayg [symbol] , G. N., Water Sci. Technol. 2017, 76, 515-530). The atomic diameter of B³⁺ (0.17 nm) is also smaller than the single-chain pore size. Thus, PPDA-CMP-1 had the highest ever adsorption capacity of Li⁺, the notably high adsorption capacity of B³⁺, and perfect adsorption selectivity to Li⁺. The observed 31.2 wt % Li adsorption means an empirical formula Li_{5.73}/PDA (monomer unit).

PPDA-CMP-2 had much lower ion adsorption capacities (7.2-8.4 wt % Li⁺ adsorption and 1.7 wt % B³⁺ adsorption (Table 8, entries 2, 5, and 8)) than PPDA-CMP-1 (30.6-31.2 wt % Li⁺ adsorption and 19.6 wt % B³⁺ adsorption (Table 8, entries 1, 4, and 7)). The lower adsorption capacities of PPDA-CMP-2 would be partly ascribed to its smaller single-chain nanopores (0.9 nm according to the TEM analysis) compared with that of PPDA-CMP-1 (1.1 nm according to the TEM analysis), leading to limited Li⁺ capacities of aromatic rings. The empirical formula was Li_{1.32-1.54}/PDA (monomer unit), indicating Li⁺ was mostly absorbed via the Li⁺. . . . N coordination.

PPDA-CMP-3 had 22.8 wt % of Li⁺ adsorption (Table 8, entry 3), which is between 31.2 wt % Li⁺ adsorption for PPDA-CMP-1 (Table 8, entry 1) and 8.4 wt % Li⁺ adsorption for PPDA-CMP-2 (Table 8, entry 2). Unlike PPDA-CMP-1, PPDA-CMP-3 did not show good selectivity in Li⁺, Rb⁺ and Cs⁺ adsorptions (16.8 wt % Li⁺ adsorption, 8.4 wt % Rb⁺ adsorption, and 0 wt % Cs⁺ adsorption (Table 8, entry 6)) or did not absorb B³⁺ (0 wt % B³⁺ adsorption (Table 8, entry 9)). Although PPDA-CMP-1 and PPDA-CMP-3 have similar single-chain nanopores (1.1 nm and 1.0 nm diameters according to the TEM analysis, respectively), PPDA-CMP-3 showed poorer adsorption selectivity. As the BET analysis showed, the average pore sizes of single-chain pores, interlayer pores, and inter-grain pores were 2.9 and 17 nm for PPDA-CMP-1 and PPDA-CMP-3, respectively, and the large average pore size of PPDA-CMP-3 would allow adsorption of Rb⁺, which would result in poorer adsorption selectivity.

Because of the highest capacity and perfect selectivity for Li⁺ adsorption, we used PPDA-CMP-1 to study the desorption of Li⁺. The Lit-adsorbed PPDA-CMP-1 (Table 8, entry 1) was sonicated in an aqueous acidic solution (0.5 M HCl) for 30 min three times to desorb Li⁺, subsequently neutralized with water, and dried in an oven at 120° C. under vacuum overnight. The XPS analysis (FIG. 31b) showed that the Li 1 s peak at 65.9 eV (binding energy) that appeared before desorption (i) nearly perfectly disappeared after desorption (ii), meaning a complete removal of Li after desorption. The Li 1 s peak before desorption (i) appeared small, but this is not because the Li content was small but because the XPS relative sensitivity factor of Li (0.025) is much smaller than those of other atoms (0.296 for C, 0.477 for N, and 0.711 for O) (Wagner, C. D. et al., Surf. Interfac. Anal. 1981, 3, 211-225). FIG. 31c shows the XPS spectrum (i) of the Lit-adsorbed PPDA-CMP-1 obtained from a Li⁺, Rb⁺, and Cs⁺ mixed solution (Table 8, entry 4). The Li 1 s peak appeared at 65.9 eV but neither Rb 3p peak (230-271 eV, binding energy) nor Cs 3d peak (716-757 eV, binding energy) appeared, confirming the selective adsorption of Li⁺. The XPS relative sensitivity factors of Rb (1.542) and Cs (7.041) are much larger than that of Li (0.025) (Wu, J. et al., Adv. Energy Mater. 2015, 5, 1402189), and hence no appearance of Rb or Cs peaks means virtually no adsorption of Rb⁺ or Cs⁺. After the desorption, the Li 1 s peak disappeared (FIG. 31c(ii)), meaning a complete removal of Li⁺. We also studied the desorption of B³⁺ from the B³⁺-adsorbed PPDA-CMP-1 (Table 8, entry 7). The SEM-EDS mapping analysis (FIG. 31d) showed no B signal in the in the desorbed PPDA-CMP-1, while C, O, and N signals were clearly detected, meaning a complete removal of B³⁺.

We further studied the recycled use of PPDA-CMP-1 for ion adsorption (Tables 10 and 11). We adsorbed and desorbed Li⁺ using a solution solely containing Li⁺ (Table 10, entry 1), showing 32.0 and 30.8% wt % Li⁺ adsorption in the second and third cycles, respectively, which were similar values to 31.2 wt % Li⁺ adsorption in the first cycle (Table 8, entry 1 and Table 10, entry 1). For the mixed ion system (Table 8, entry 4 and Table 10, entry 2), PPDA-CMP-1 did not adsorb Rb⁺ or Cs⁺ but maintained perfect selectivity in the Li⁺ adsorption in all the three cycles, although a decreasing trend was observed in the Lit adsorption capacity (from 30.6 wt % to 24.0 wt % and 18.8 wt % Li⁺ adsorption from the first to second and third cycles). PPDA-CMP-1 also attained cycled B³⁺ adsorption-desorption despite a decreasing trend in the B³⁺ adsorption capacity (from 19.6 wt % to 17.2 wt % and 9.6 wt % B³⁺ adsorption from the first to second and third cycles) (Table 8, entry 7 and Table 10, entry 3). Thus, PPDA-CMP-1 is recyclable for at least three cycles of Li⁺ and B³⁺ adsorption. The results show the highest ever adsorption capacities, perfect selectivity, and recyclability of PPDA-CMP-1 for Li⁺ and B³⁺ adsorption.

Because of the porous structures, the obtained 2D CMPs worked as highly efficient and selective adsorbents of lithium (Li⁺) and boronium (B³⁺) ions, adsorbing up to 312 mg of Li⁺ (31.2 wt %) and 196 mg of B³⁺ (19.6 wt %) per 1 g of CMP. This Li⁺ adsorption capacity is the highest ever record in the area of Li⁺ adsorption.

Thus, we have studied metal ion adsorption of the obtained 2D CMPs as an interesting application. Adsorption is a low-cost, effective, and sustainable (low energy-consuming) technique that can be used for metal ion separation. We studied the adsorption of lithium ion (Li⁺) and boronium ion (B³⁺). Because of its high value, the collection of Li⁺ from seawater reverse osmosis (SWRO) brines is an urgent need in desalination and can be a promising application. Boron is a pollutant in the environment, potentially affecting human health and causing photosynthesis inhibition in plants. Therefore, the collection of Li⁺ and B³⁺ from SWRO brines and wastewaters can be an important application. Furthermore, our 2D CMPs are highly durable for recycled use, and the pore sizes are tuneable by XB linkers for selective absorption of particular metal ions. Our 2D CMPs are purely organic (metal-free) and can be environmentally friendly absorbents.

### Comparative Example 3

For comparison, we studied ion adsorption using PPDA synthesized in the solution phase in Comparative Example 1.

Because of no monomer alignment, nanosheets and hence single-chain nanopores would not be effectively generated, showing only 5.2-5.4 wt % Li⁺ adsorption and 0.7 wt % B³⁺ adsorption (Table 8, entries C1, C2 and C3). These values are much smaller than those of PPDA-CMP-1 (30.6-31.2 wt % Li⁺ adsorption and 19.6 wt % B³⁺ adsorption (Table 8, entries 1, 4, and 7)), confirming that the enhanced adsorption capacity of PPDA-CMP-1 resulted from the extended nanosheets with single-chain nanopores generated by the alignment of monomers.

### Example 8. Other Examples of Monomer

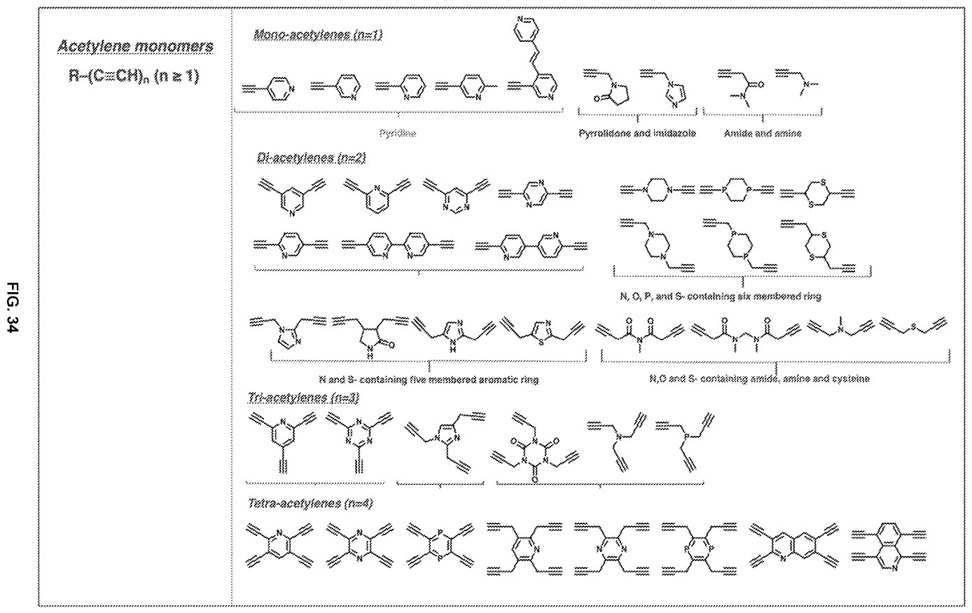

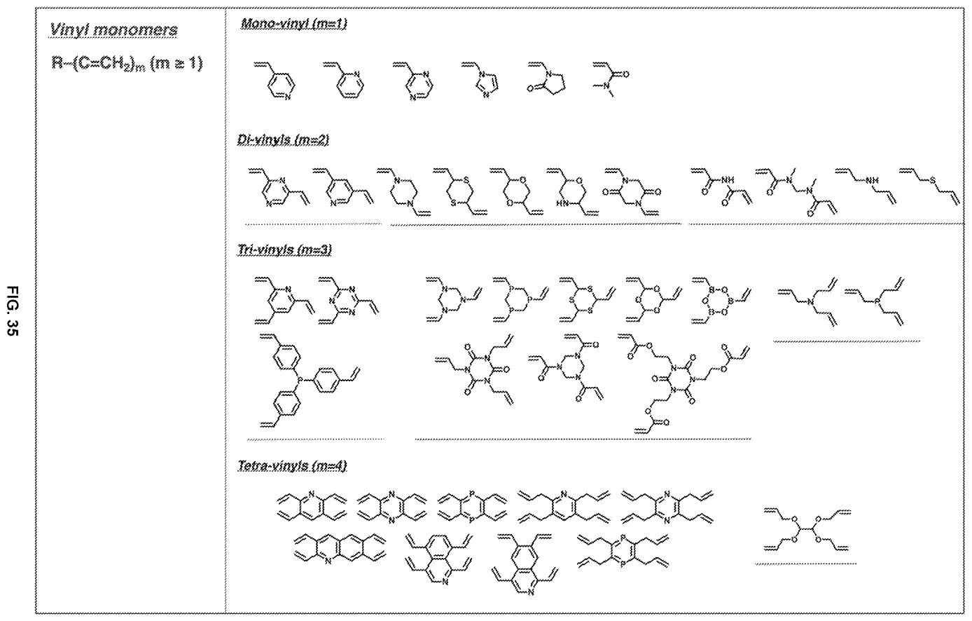

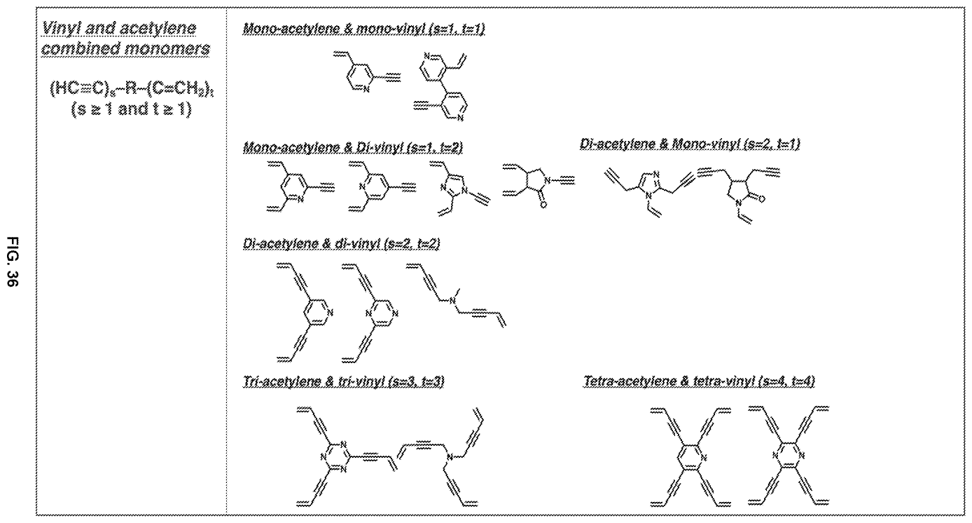

PDA is an example of monomer. Other examples of monomer are given in FIGS. 34-36. The monomers (FIG. 34) can be acetylenes R—(C≡CH)ₙ (n≥1) including mono-acetylenes (n=1), di-acetylenes (n=2), tri-acetylenes (n=3), tetra-acetylenes (n=4), and multi-acetylenes (n≥5), where the R group can be nitrogen-, oxygen-, phosphorus-, and sulfur-containing aromatic and aliphatic groups and other XB-forming groups. The monomers (FIG. 35) can be vinyl monomers R—(C═CH₂)ₘ (m≥1) including mono-vinyl (m=1), di-vinyl (m=2), tri-vinyl (m=3), tetra-vinyl (m=4), and multi-vinyl (m≥5) compounds, where the R group can be nitrogen-, oxygen-, phosphorus-, and sulfur-containing aromatic and aliphatic groups and other XB-forming groups. The monomers (FIG. 36) can be vinyl and acetylene combined monomers (HC≡C)ₛ—R—(C═CH₂)ₜ (s≥1 and t≥1) including mono-acetylene & mono-vinyl (s=1 and t=1), mono-acetylene & di-vinyl (s=1 and t=2), di-acetylene & mono-vinyl (s=2 and t=1), di-acetylene & di-vinyl (s=2 and t=2), tri-acetylene & tri-vinyl (s=3 and t=3), tetra-acetylene & tetra-vinyl (s=4 and t=4) and multi-acetylene & multi-vinyl compounds, where the R group can be nitrogen-, oxygen-, phosphorus-, and sulfur-containing aromatic and aliphatic groups and other XB-forming groups. The monomers in this invention are not limited to those described above but other XB-forming compounds that can be polymerized in radical polymerization.

### Example 9. Synthesis of monomer 10 (2,6-divinylpyridine (2,6-DVP)) and monomer 11 (3,5-divinylpyridine (3,5-DVP))

2,6-dibromopyridine (or 3,5-dibromopyridine) (3.15 g, 13.3 mmol) and tributyl (vinyl) tin (10 g, 31.5 mmol) were added into a three-necked 50 mL flask, THF (11 mL) was subsequently added in argon atmosphere to dissolve the mixture. After 3 h of reflux, Pd(PPh₃)₄ (0.05 g) was added into the flask. The solution was kept refluxed for 5 days. The crude product was purified by column chromatography using hexane/diethyl ether (9/1 v %/v %) as the eluent. 2,6-DVP (or 3,5-DVP) was obtained as a light yellow liquid (0.20 g, 1.52 mmol).

### Characterisation

Monomer 10 (2,6-DVP). ¹H NMR (400 MHZ, CDCl₃) δ 7.60 (t, J=7.8 Hz, 1H, —CH═CH—CH═), 7.21 (d, J=7.8 Hz, 2H, —CH═CH—CH═), 6.82 (dd, J₁=17.4 Hz, J₂=10.8 Hz, 2H, —CH═CH₂), 6.25 (dd, J₁=17.4 Hz, J₂=1.36 Hz, 2H, —CH═CH₂—), 5.48 (dd, J₁=10.8 Hz, J₂=1.36 Hz, 2H, —CH═CH₂—).

Monomer 11 (3,5-DVP). ¹H NMR (400 MHZ, CDCl₃) δ 7.87 (t, J=1.8 Hz, 1H, —CH═CH—CH═), 8.54 (dd, J₁=12.1 Hz, J₂=1.4 Hz, 2H, —CH═CH—CH═), 6.84 (ddd, J₁=28.6 Hz, J₂=13.4 Hz, J₃=11.0 Hz, 2H, —CH═CH₂), 5.83 (dd, J₁=17.6 Hz, J₂=17.6 Hz, 2H, —CH═CH₂—), 5.40 (dd, J₁=11.0 Hz, J₂=11.0 Hz, 2H, —CH═CH₂—).

### Example 10. Photo-SPP of Three-Component Cocrystal Monomers to Give PDVP-POPs

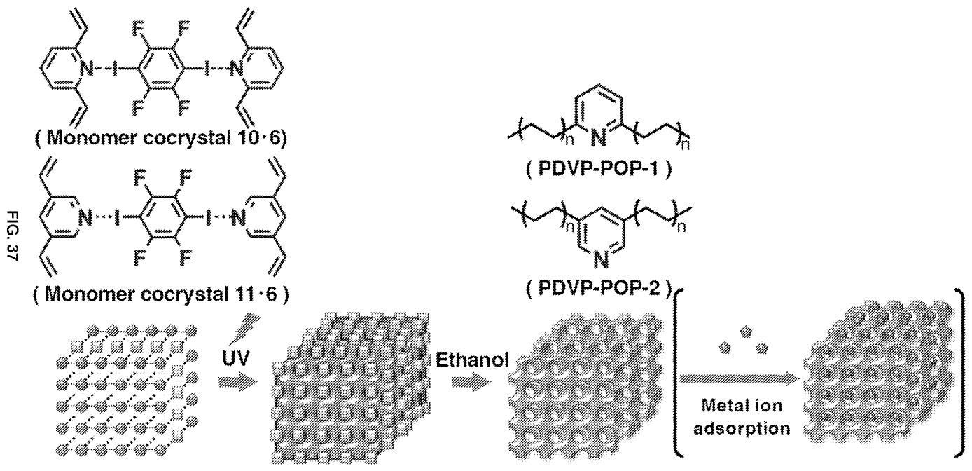

As an extended example, we used two divinyl monomers, 2,6-divinyl pyridine (2,6-DVP) (10) and 3,5-divinyl pyridine (3,5-DVP) (11) in halogen-bond (XB)-based free radical solid phase polymerization (SPP) (FIG. 37). DVP is an example of divinyl monomer. The di-vinyl (H₂C═CH—R—CH═CH₂) in DVP can generate network polymers after SPP.

### Preparation of PDVP-POPs

In a typical run, monomer 10 (0.03 g, 0.23 mmol), XB linker 6 (0.045 g, 0.11 mmol) (N/I molar ratio=1/1) and DMPA (1.92 mg, 7.50 μmol) were dissolved in dichloromethane (1 mL) in a flask. Slow evaporation of dichloromethane was performed using a rotary evaporator, yielding the co-crystal solid after hours. The monomer solid was put in a vial. The vial was capped with a rubber septum, and oxygen was removed with an argon flow. The solid was irradiated with UV light (λ=365 nm) at room temperature. After 24 h, the solid was washed with ethanol (20 mL) three times to completely remove soluble polymer, residual monomer (if present), XB linker 6, and DMPA, yielding poly(2,6-divinyl pyridine) (PDVP-POP-1) with yellowish white color as the final product (insoluble part). The cocrystal monomers 11.6 was polymerized and purified similarly, yielding poly(3,5-divinyl pyridine) (PDVP-POP-2) with the same yellowish white color as the final product (insoluble part). The soluble part of polymer in ethanol (10 mL) were reprecipitated into hexane (100 mL) to remove the residual monomers (if present), XB linkers, and DMPA, and analysed with 1H NMR and GPC to determine the monomer conversion, molecular weight, and dispersity in the soluble part.

### Results and Discussion

Monomer 10 (or 11), XB linker 6, and photoinitiator DMPA (9) were combined to generate a three-component monomer co-crystal (10·6 or 11·6), which was subsequently exposed to UV light (A=365 nm) under an argon atmosphere for 40 h at room temperature (22° C.) to generate polymer (network polymer) (FIG. 37). The SPP of 10·6 and 11·6 (actually containing monomer, 6, and DMPA) led to a 100% monomer conversion. After the SPP, the solids were stirred in ethanol. There were both insoluble polymers (50 and 89 wt %) and soluble polymers (50 and 11 wt %) (Table 12) in monomer 10 and 11, respectively. The divinyl C═C bonds can be branched and further be crosslinked, yielding insoluble polymer. After the polymerization and XB linker removal, POP of PDVP was generated. The polymers obtained from monomer cocrystals 10.6 and 11.6 were PDVP-POP-1 and PDVP-POP-2, respectively (FIG. 37).

TABLE 12
Polymerization of crystallized divinyl monomers 10 and 11 under
UV light (λ = 365 nm) at rt for 24 h.

| | | | | | Monomer | | | | Soluble | Insoluble |
|---|---|---|---|---|---|---|---|---|---|---|
| | | | | [M]₀/[L]₀/ | conversion | | | | polymer | polymer |
| Entry | Mode | M | L^{a} | [DMPAP]₀ | (%) | Mₚ^{b} | Mₙ^{b} | Ð^{b} | (% wt) | (% wt) |
| 1 | SPP | 10 | 6 | 2/1/0.067 | 100 | 7700 | NA | NA | 50 | 50 |
| 2 | SPP | 11 | 6 | 2/1/0.067 | 100 | 19000 | 14200 | 1.73 | 11 | 89 |

^{a}L = XB linker.
^{b}Polystyrene (PSt)-calibrated DMF-GPC values for soluble polymers in ethanol, where DMF was used as the GPC eluent. Mₚ is the peak-top molecular weight, Ð is the dispersity (Ð = M_{w}/Mₙ, where M_{w} and Mₙ are the weight- and number-average molecular weights, respectively.

### Example 11. BET Analysis of PDVP-POP-1 and PDVP-POP-2

BET analysis was carried out by following the protocol in Example 6.

### Exfoliation of PDVP-POPs

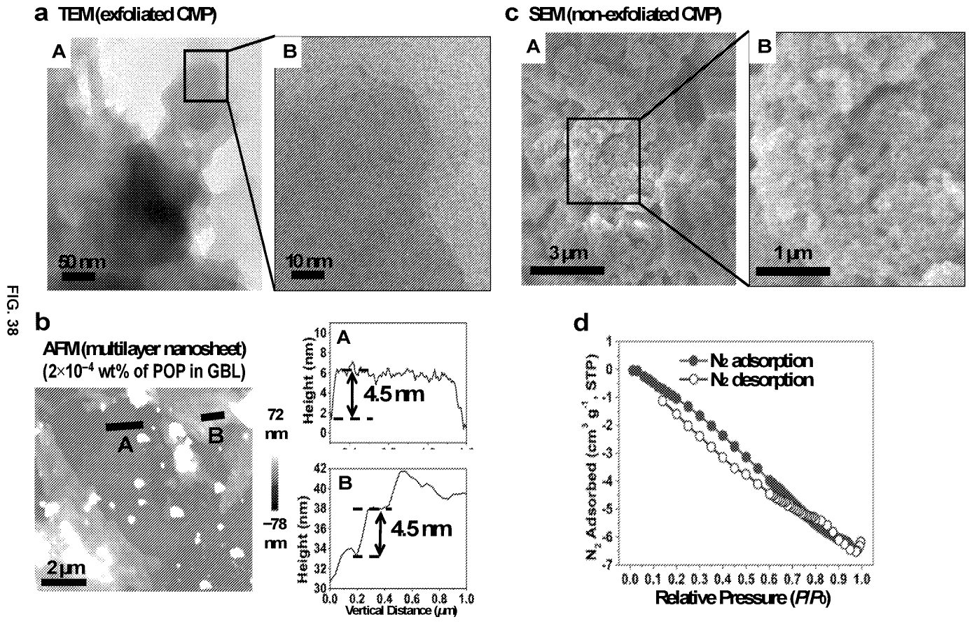

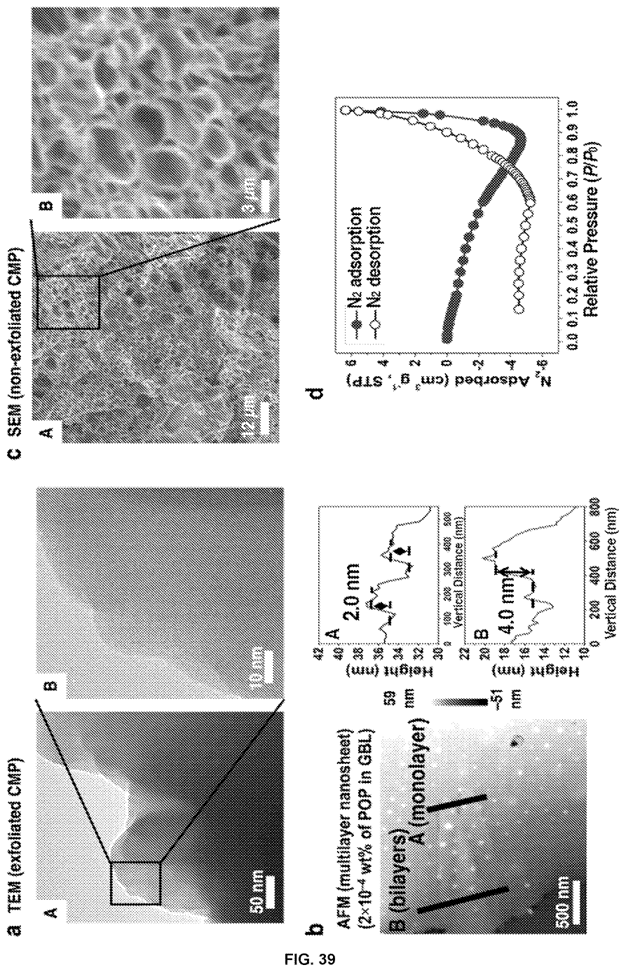

In a typical run, PDVP-POP-1 (2 mg) was dispersed in 2 mL of GBL and sonicated for 30 min to obtain a 0.1 wt % dispersed solution. A part of the solution was further diluted 500 times in GBL to obtain a 2×10⁻⁴ wt % dispersed solution. The diluted solution (2×10⁻⁴ wt % solution) was heated at 50° C. for 5 days with gentle stirring to induce partial exfoliation. Subsequently, the dispersed solution (1 μL) was dropped on Cu grids and cleaned Si wafers and dried under vacuum for TEM and AFM analyses, respectively. PDVP-POP-2 was exfoliated similarly (FIGS. 38d and 39d).

### Results and Discussion

Similarly, there were three types of pores with different sizes observed in PDVP-POP-1 and PDVP-POP-2 (FIGS. 38-39). The TEM images (FIGS. 38a and 39a) showed nanometer-sized pores (single-chain nanopores). The AFM images showed second pores, which were nanometer-sized pores generated between the nanosheets during the linker removal (interlayer nanopores). The multilayers were partially exfoliated at 2×10⁻⁴ wt % of polymers in GBL, generating layered structures of PDVP-POP-1 and PDVP-POP-2 with thicknesses of 4.5 nm and 2.0-4.0 nm, respectively (FIGS. 38b and 39b). The third micrometer-sized pores result from micrometer-sized gaps between different crystal grains (inter-grain micropores), which were observed with the SEM images (FIGS. 38c and 39c). The pore sizes were thereby tuneable by the positions of di-vinyl (H₂C═CH—R—CH═CH₂) in DVP. Using BET, the specific surface areas were determined to be 35 and 0.7 m² g⁻¹ for PDVP-POP-1 and 2, respectively (FIGS. 38d and 39d, and Table 13).

TABLE 13
BET analysis of PDVP-POPs.

| | | | Qₘ | | V_{BET} | |
|---|---|---|---|---|---|---|
| | | | (cm³ g⁻¹ | S_{BET} | [×10⁻³] | d_{BET} |
| Entry | CMP | c_{BET}^{a} | STP)^{b} | (m² g⁻¹)^{c} | (cm³ g⁻¹)^{d} | (nm)^{e} |
| 1 | PDVP-POP-1 | −0.45 | 8.0 | 35 | 9.6 | 1.1 |
| 2 | PDVP-POP-2 | −4.3 | 0.16 | 0.7 | 9.8 | 56 |

^{a}BET constant.
^{b}Monolayer adsorbed gas volume.
^{c}BET specific surface area.
^{d}Volume of adsorbed gas at P/P₀ = 0.99.
^{e}(Average) pore diameter.

### Example 12. Adsorption of Metal Ions by PDVP-POPs

We studied ion adsorption of PDVP-POPs in water by following the protocol in Example 7. The studied ions were Li⁺ and B³⁺ ions. PDVP also contains electron-donating nitrogen atoms, which can coordinate those cations. PDVP-POP-1 and PDVP-POP-2 were obtained as yellowish white, and yellowish white solids, respectively.

The content of metal ion (wt %) was calculated according to equation (11):

$$wt \% = ( {C}_{0} - {C}_{t} ) \times \frac{V}{{m}_{( PDVP - POP )}} \times 100 \% \qquad ( 11 )$$

$$where :$$

$${C}_{0} is the concentration of metal ion before adsorption [ ppm or mg {L}^{- 1} ] ;$$

$${C}_{t} is the concentration of metal ion after adsorption [ ppm or mg {L}^{- 1} ] ;$$

$$V is the volume of the metal ion solution [ L ] ; and$$

$${m}_{( PDVP - POP )} is the mass of PDVP - POP [ mg ] .$$

### Results and Discussion

The preliminary results using ICP-OES show that, PDVP-POP-1 adsorbed 314 mg of Lit per 1 g of POP (31.4 wt % Li⁺ adsorption) (Table 14, entry 1), which is among the highest adsorption capacity in the area of Li⁺ adsorption. PDVP-POP-2 showed 12.2 wt % Li⁺ adsorption (Table 14, entry 2). In an aqueous solution of B³⁺ (0.1 wt %), PDVP-POP-1 and PDVP-POP-2 achieved 2.52 wt % and 27.3 wt % B³⁺ adsorption, respectively (Table 14, entries 3 and 4). This data indicates that PDVP-POPs can achieve excellent Lit adsorption and the ability of B³⁺ adsorption.

TABLE 14
Adsorption of metal ions by PDVP-POPs.

| | | Metal Solution (0.1 | Amount of metal ion |
|---|---|---|---|
| | | wt % (1000 ppm) of | adsorbed per CMP |
| Entry | POP | metal ion⁺) | (mg/g CMP) |
| 1 | PDVP-POP-1 | LiOH | 314 |
| 2 | PDVP-POP-2 | | 122 |
| 3 | PDVP-POP-1 | NH₄BF₄ | 25.2 |
| 4 | PDVP-POP-2 | | 273 |

In summary, we constructed acetylene monomer cocrystals using XB and successfully used them to achieve free-radical SPPs of acetylenes. Despite the low reactivities of acetylene monomers in radical polymerization, the proximity of the adjacent C≡C groups in the cocrystals enabled effective propagation. The SPPs of PDA (diacetylene) and subsequent removal of linkers yielded 2D CMPs consisting of polymer nanosheets cumulating in layer-by-layer manners. The presence of nanosheets was demonstrated by the exfoliation of the CMPs. The pore structures were modulated by the linkers. PPDA-CMP-1 had the highest ever adsorption capacity of Li⁺ (31.2 wt % Li⁺ adsorption), high adsorption capacity of B³⁺ (19.6 wt % B³⁺ adsorption), perfect adsorption selectivity to Li⁺, and recyclability for Li⁺ and B³⁺ adsorption. The resultant 2D CMPs are purely organic (metal-free) and can be environmentally friendly absorbents. This synthetic method would be applicable to a range of nitrogen-containing and other electron-donating acetylenes and diacetylenes to yield high-molecular and crosslinked polymers that are inaccessible in solution-phase polymerizations and may open up new materials.

1. A polymeric material comprising:
a plurality of polymeric nanosheets arranged in a layer-by-layer configuration to provide a two-dimensional microporous polymeric material, wherein:
each of the plurality of polymeric nanosheets is formed from a plurality of ladder-shaped polymers,
the ladder-shaped polymers are formed from at least one multivalent monomeric material that has:
two or more polymerisable functional groups selected from one or both of acetylene and vinyl functional groups; and
a functional group capable of forming a halogen bond with a halogen atom.

2. The polymeric material according to claim 1, wherein the BET surface area of the polymeric material is less than 100 m² g⁻¹.

3. The polymeric material according to claim 2, wherein the BET surface area of the polymeric material is less than or equal to 50 m² g⁻¹.

4. The polymeric material according to claim 2, wherein the BET surface area of the polymeric material is less than or equal to 26 m² g⁻¹.

5. The polymeric material according to claim 4, wherein the BET surface area of the polymeric material is from 5 to 26 m² g⁻¹.

6. The polymeric material according to claim 1, wherein the at least one multivalent monomeric material is selected from one or more of the group consisting of:

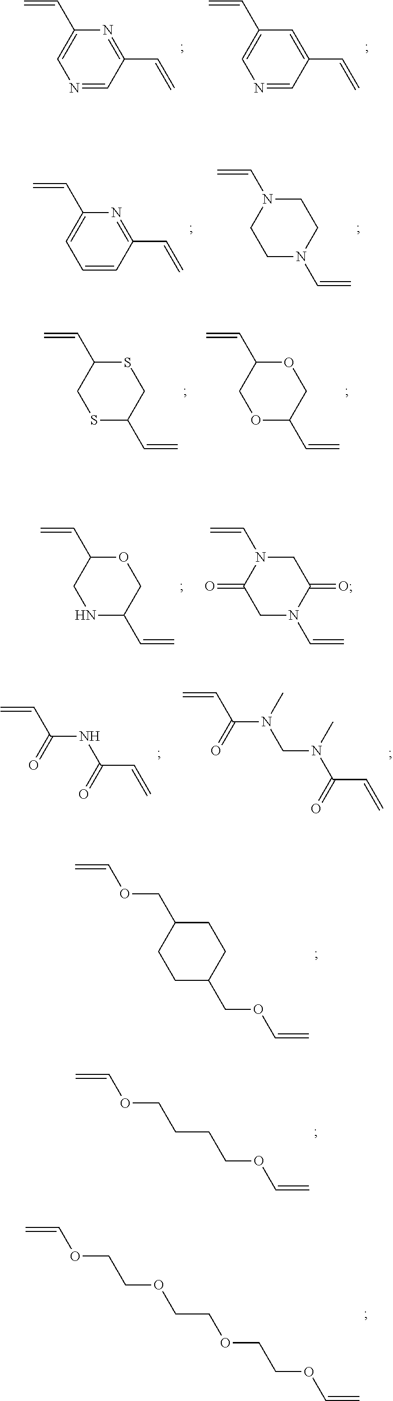

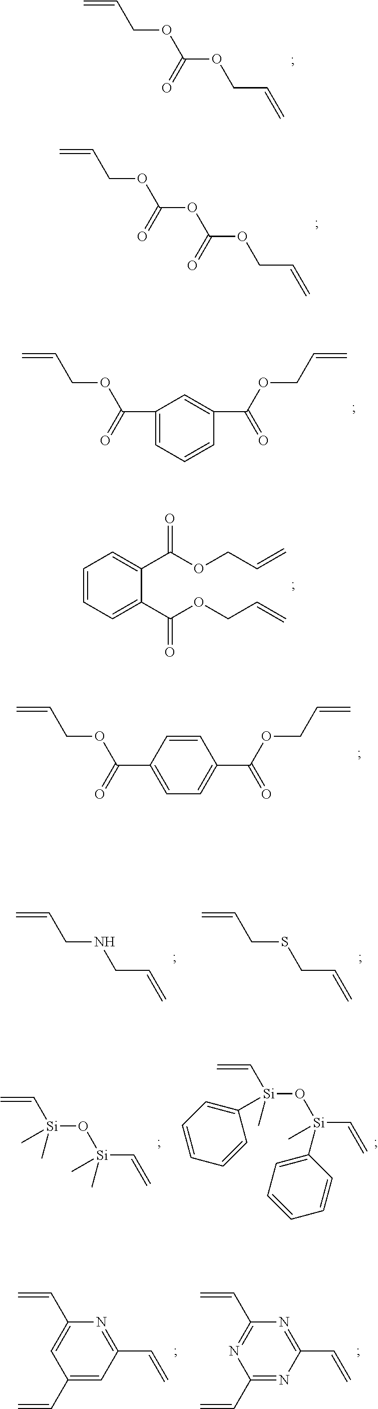

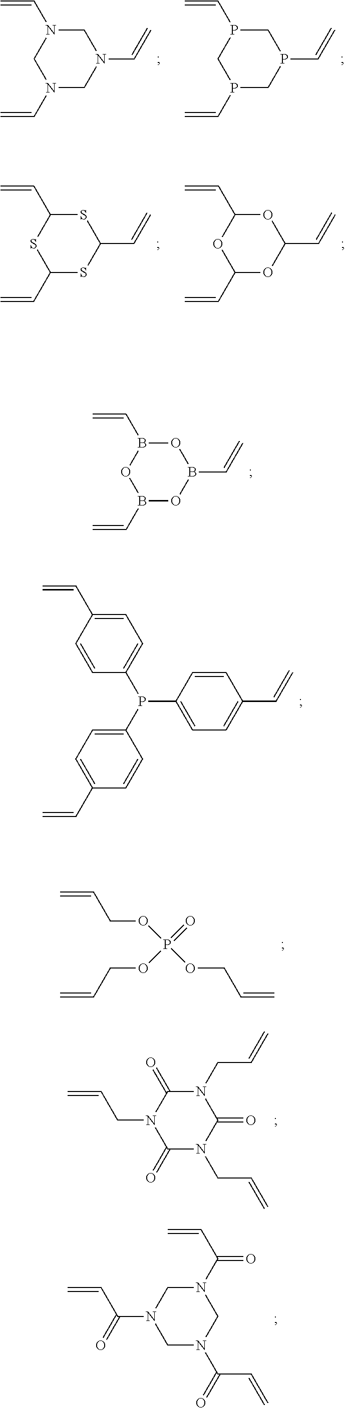

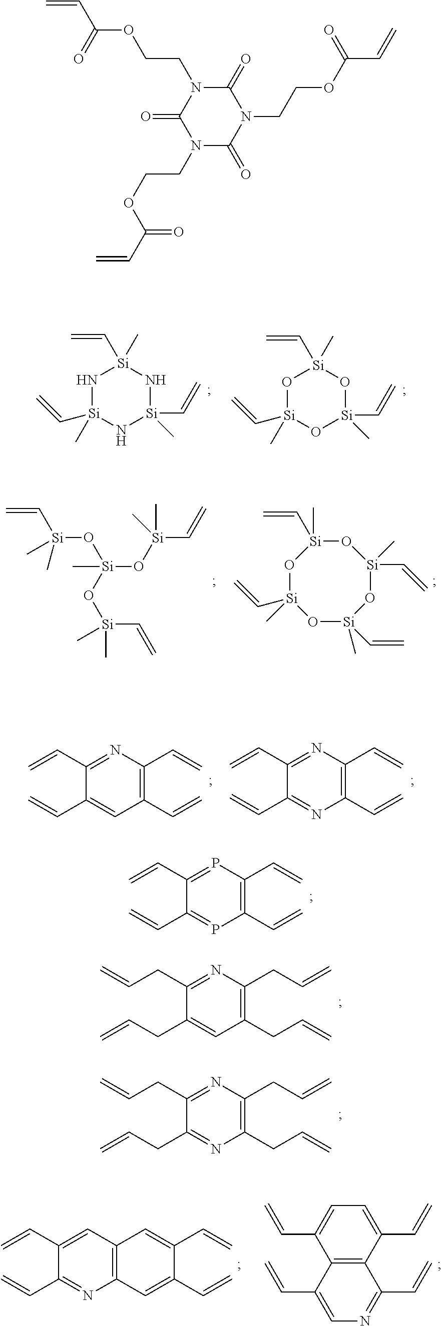

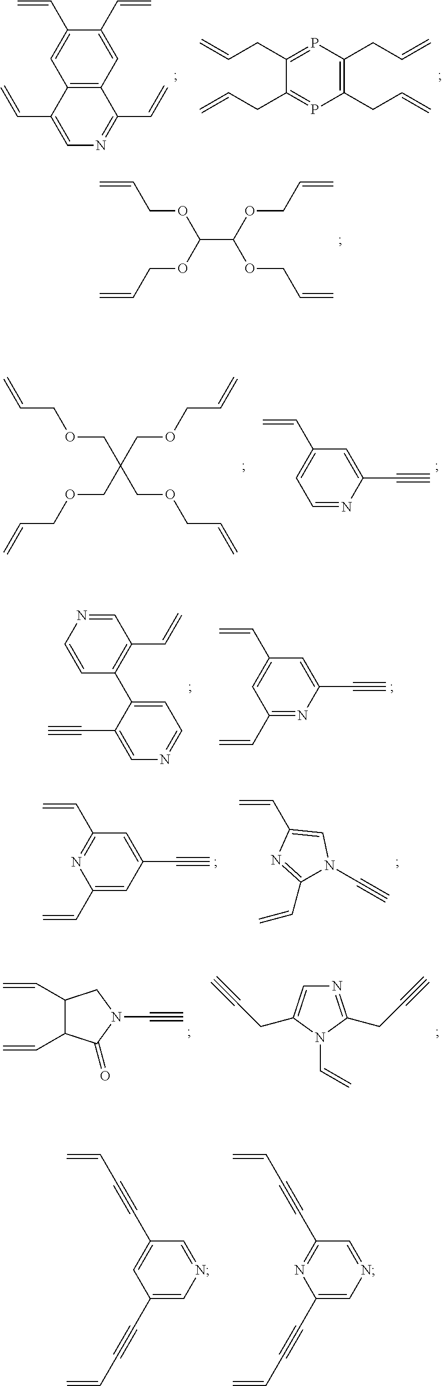

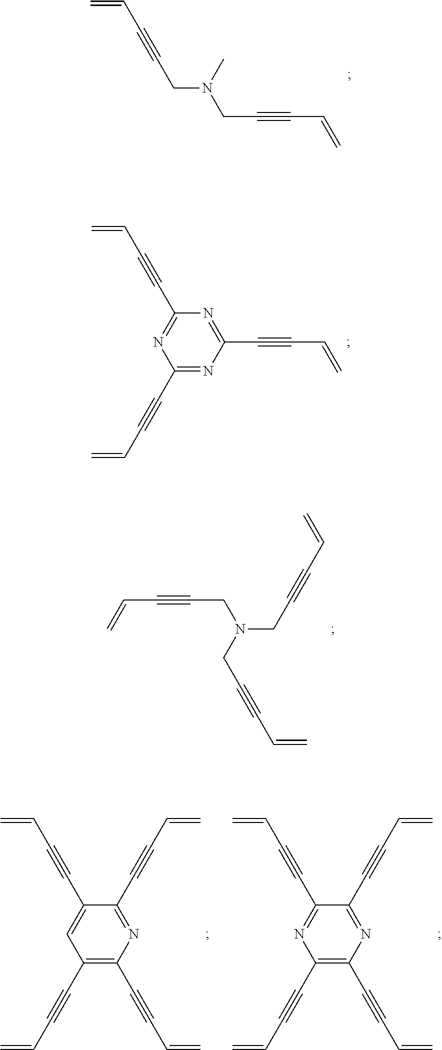

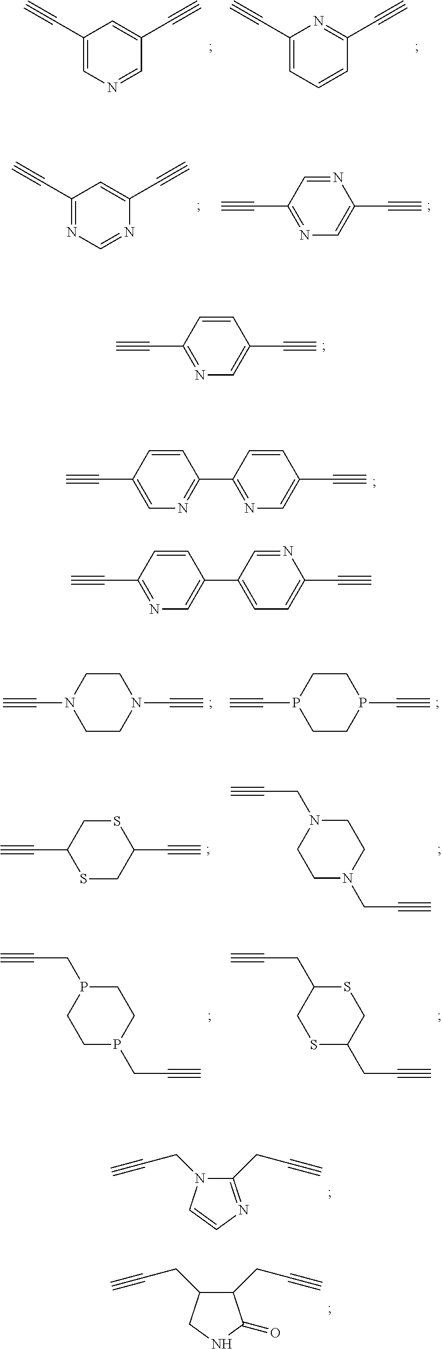

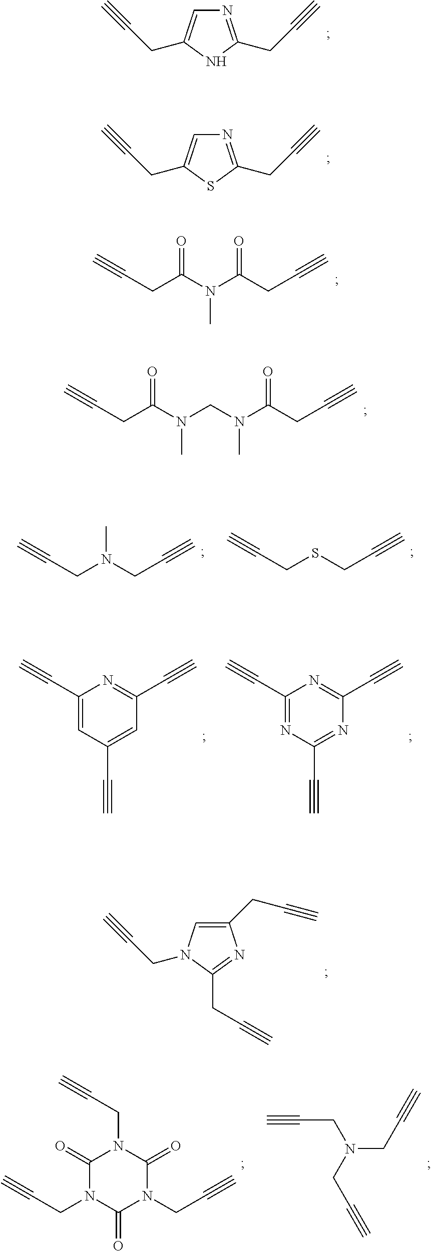

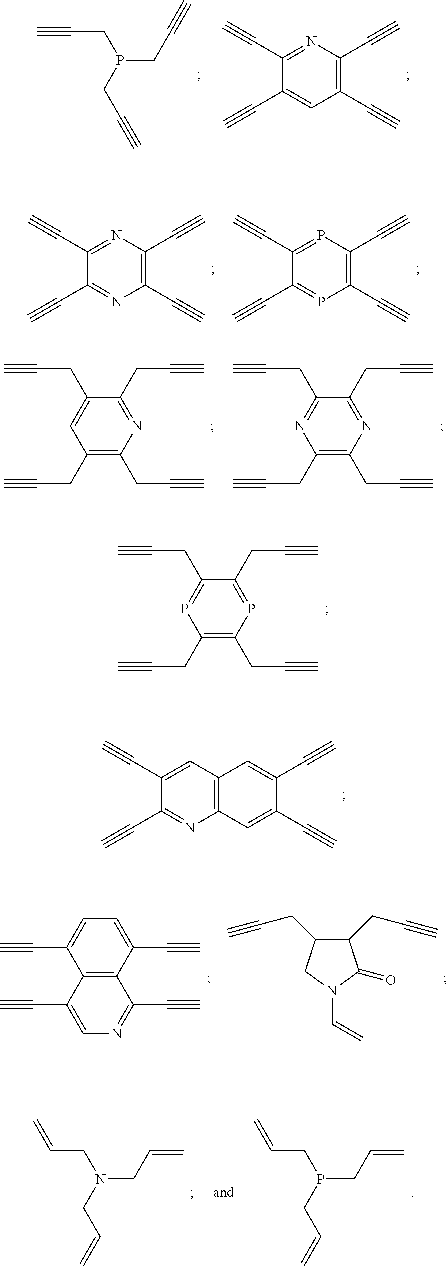

7. The polymeric material according to claim 6, wherein the at least one multivalent monomeric material is selected from one or more of the group consisting of:

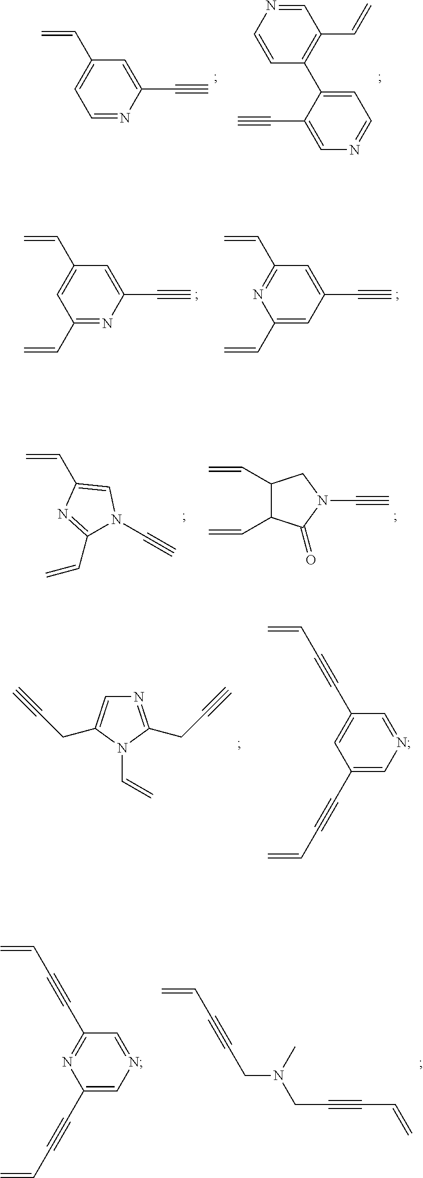

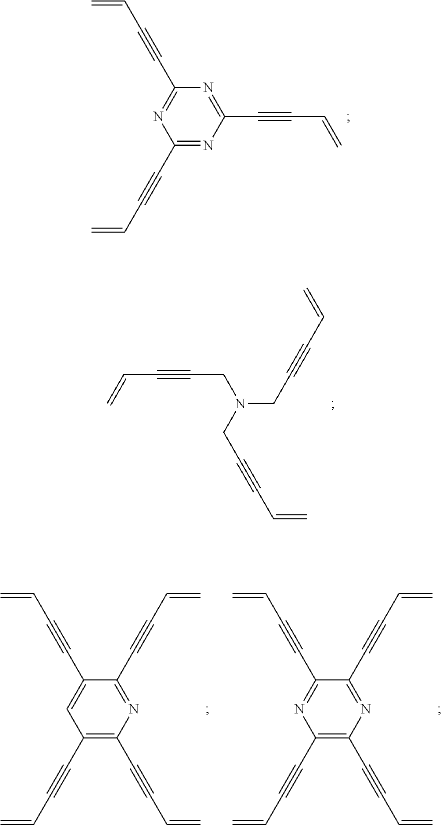

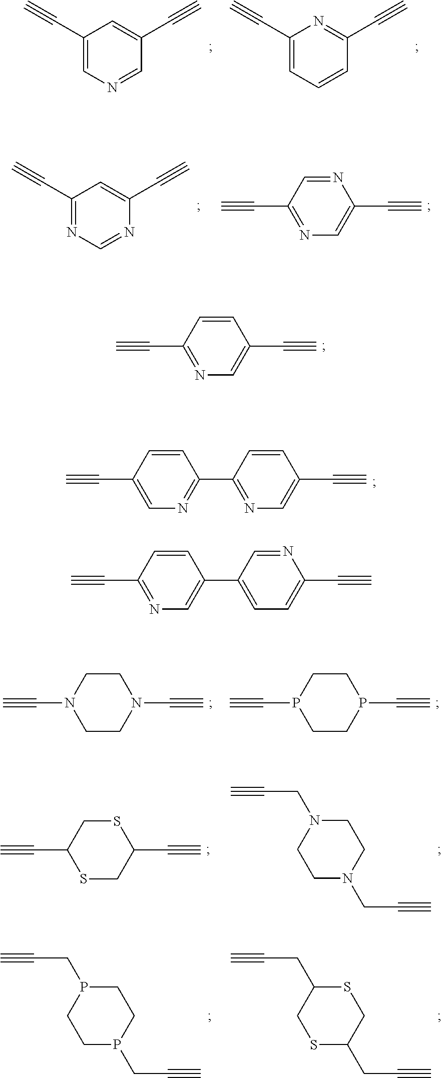

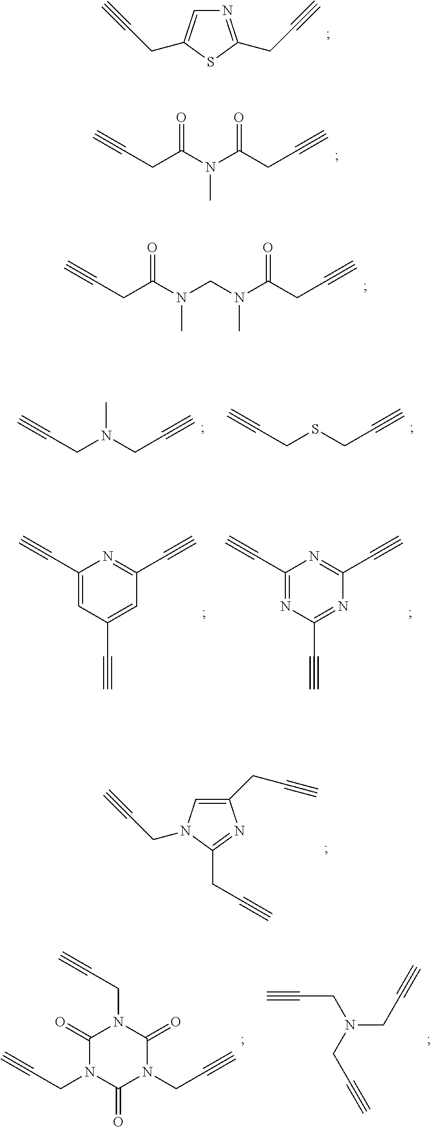

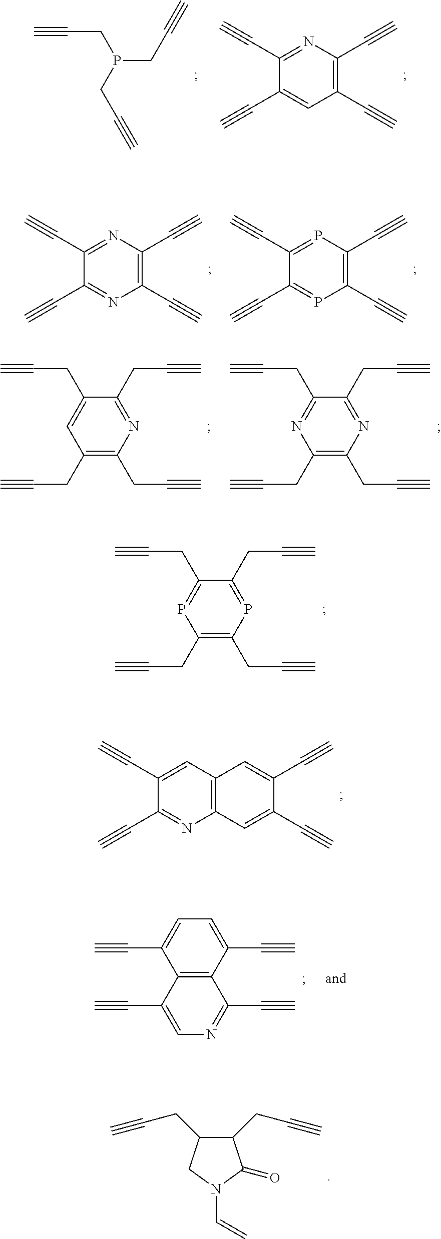

8. The polymeric material according to claim 7, wherein the at least one multivalent monomeric material is selected from one or more of the group consisting of:

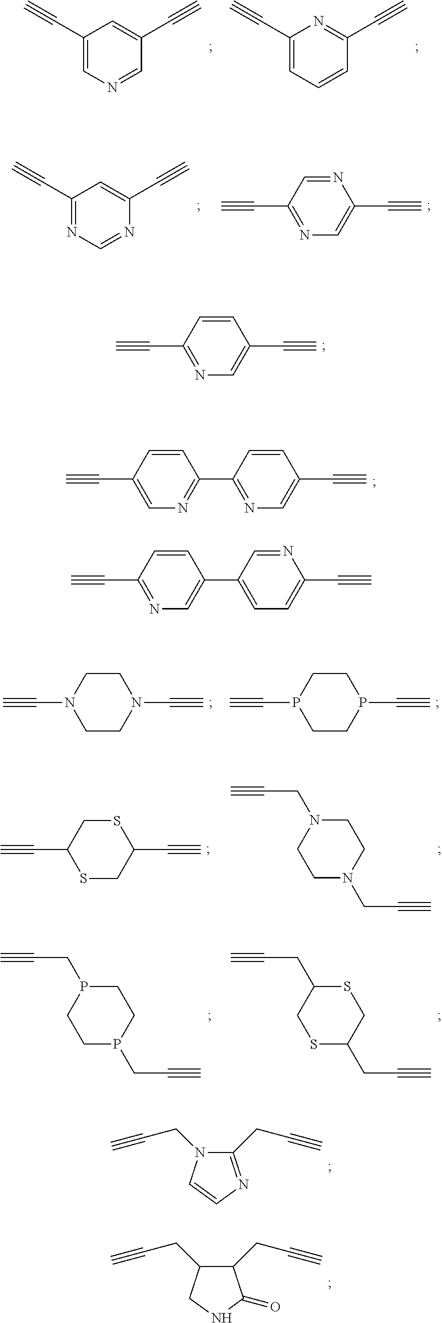

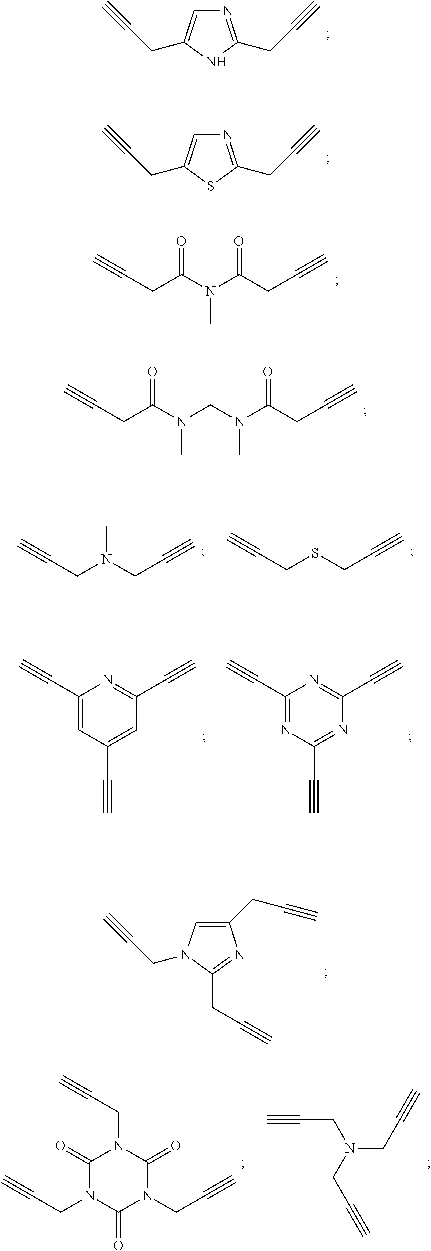

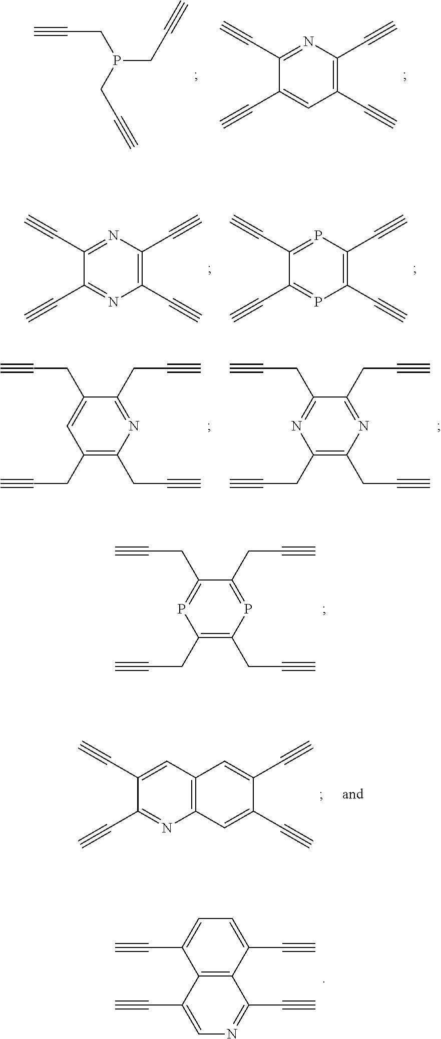

9. The polymeric material according to claim 8, wherein the at least one multivalent monomeric material is selected from one or more of the group consisting of:

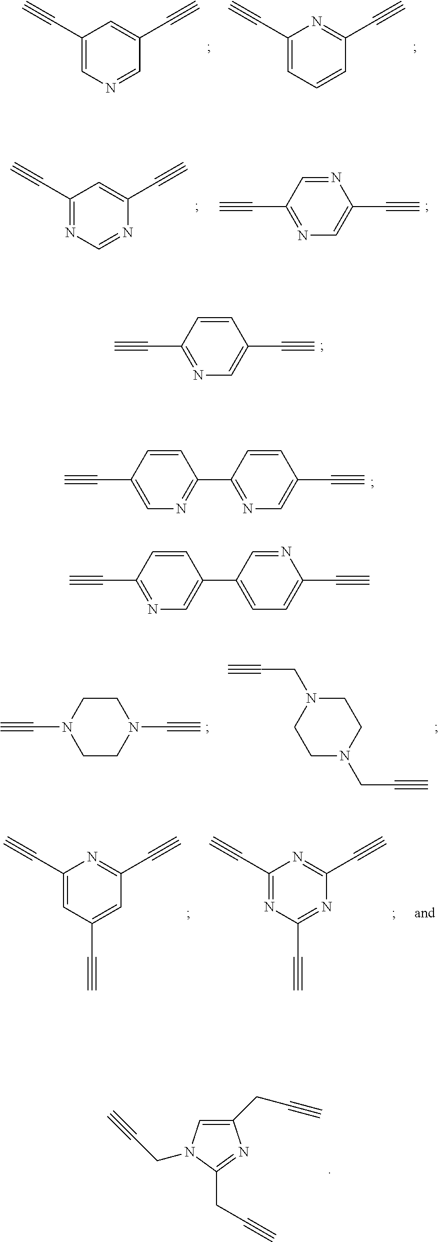

10. The polymeric material according to claim 9, wherein the at least one multivalent monomeric material is selected from one or more of the group consisting of:

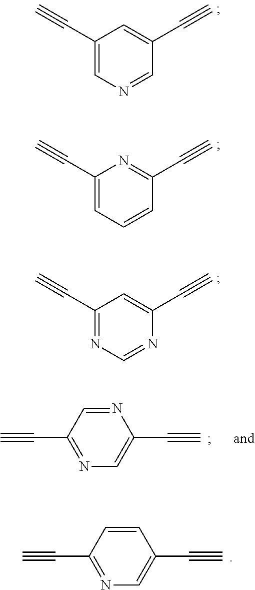

11. (canceled)

12. The polymeric material according to claim 1, wherein the ladder-shaped polymers are further formed from one or more monomeric materials that has:
one polymerisable functional group selected from acetylene or vinyl functional groups; and
a functional group capable of forming a halogen bond with a halogen atom, selected from one or more of the group consisting of:

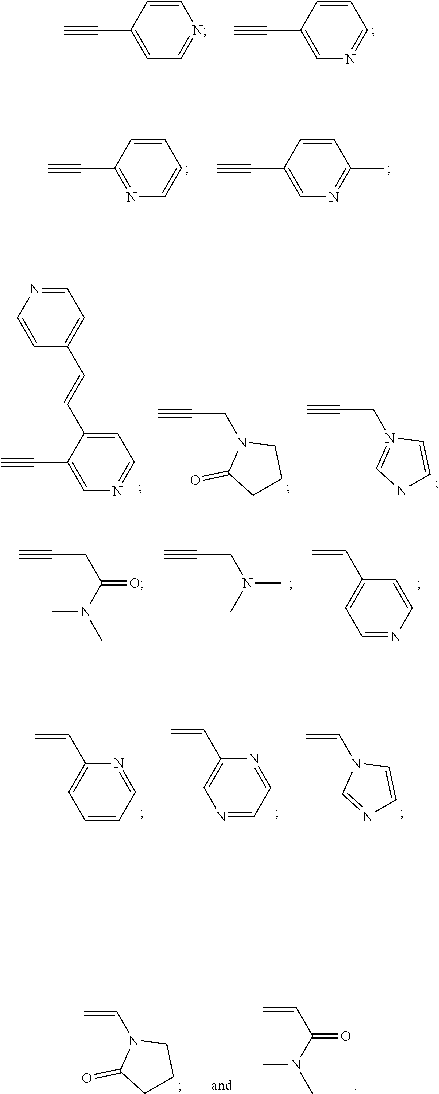

13. The polymeric material according to claim 1, wherein the polymeric material is crystalline.

14. The polymeric material according to claim 13, wherein the polymeric material has a plurality of pores corresponding to:
voids in the ladder-shaped polymers;
voids between any two nanosheets; and
voids between any two polymer crystals.

15. (canceled)

16. (canceled)

17. A method of adsorbing Li⁺ and/or B³⁺ ions from an aqueous solution comprising a mixture of ionic species, the method comprising:
(i) providing an aqueous solution comprising a mixture of ionic species, the aqueous solution comprising at least one of Li⁺ and B³⁺ ions; and
(i) adding a polymeric material according to claim 1 for a period of time to adsorb at least one of Li⁺ and B³⁺ ions from the aqueous solution comprising a mixture of ionic species.

18. A method of manufacturing a polymeric material according to claim 1, wherein the method comprises the steps of:
(a) providing a solid precursor material comprising:
an initiator;
at least one multivalent monomeric material that has two or more polymerisable functional groups selected from one or both of acetylene and vinyl functional groups and a functional group capable of forming a halogen bond with a halogen atom; and
a linker molecule capable of forming a halogen bond with the at least one multivalent monomeric material; and
(b) subjecting the solid precursor material to free radical solid phase polymerization to generate the polymeric material according to claim 1, wherein
the solid precursor material comprises cocrystals or polycrystalline materials formed by a network of the at least one multivalent monomeric material and the halogen bonding linker molecule, which cocrystals or polycrystalline materials are dispersed in the initiator.

19. The method according to claim 18, wherein:
(aa) step (b) is followed by a washing step to remove unwanted materials, including the initiator and the halogen bonding linker molecule; and/or
(ab) the initiator is selected from one or both of a photoinitiator and a thermal initiator.

20. The method according to claim 18, wherein the solid precursor material is formed by dissolving the initiator, the at least one multivalent monomeric material and the halogen bonding linker molecule in a solvent and removing the solvent over a period of time.

21. The method according to claim 18, wherein the halogen bonding linker molecule is selected from one or more of the group consisting of:

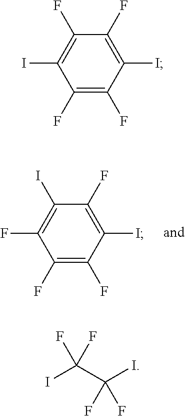 [SMILES: Fc1c(F)c(I)c(F)c(F)c1I ; Fc1c(F)c(I)c(F)c(I)c1F ; FC(F)(I)C(F)(F)I]

22. The method according to claim 18, wherein the at least one multivalent monomeric material is selected from one or more of the group consisting of:

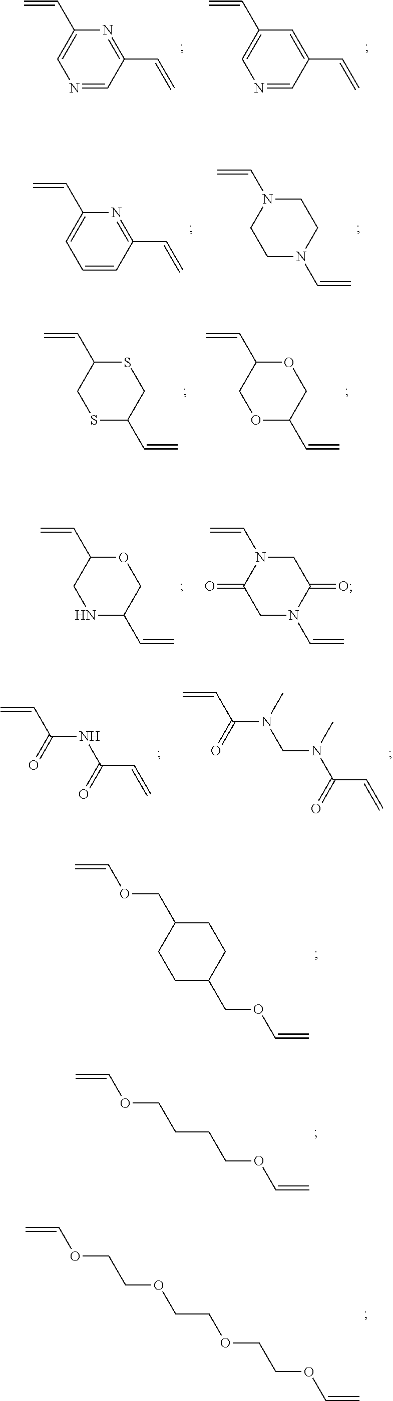

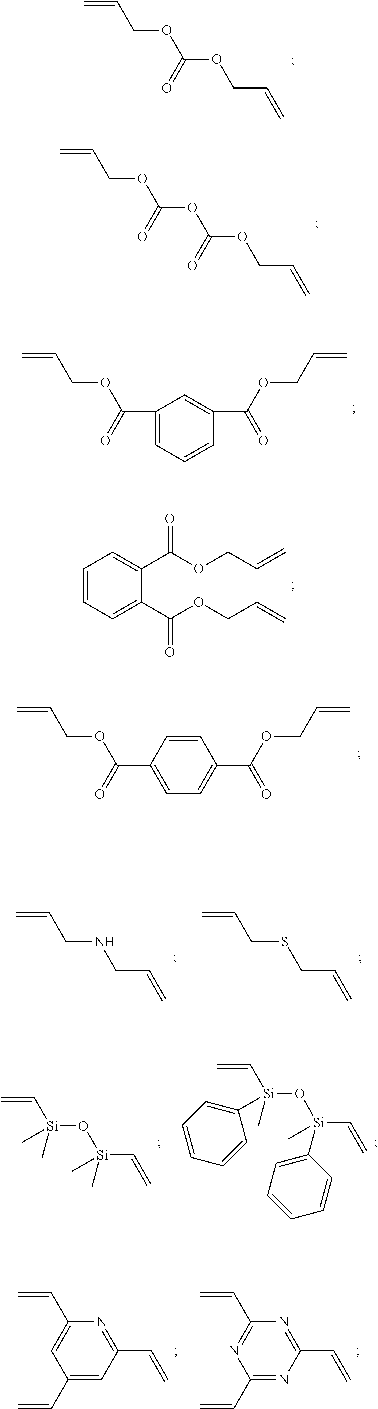

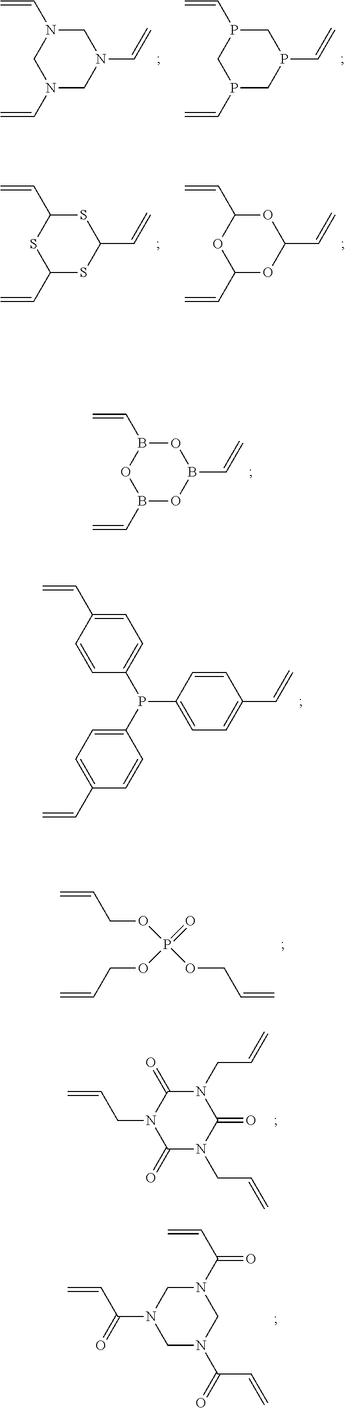

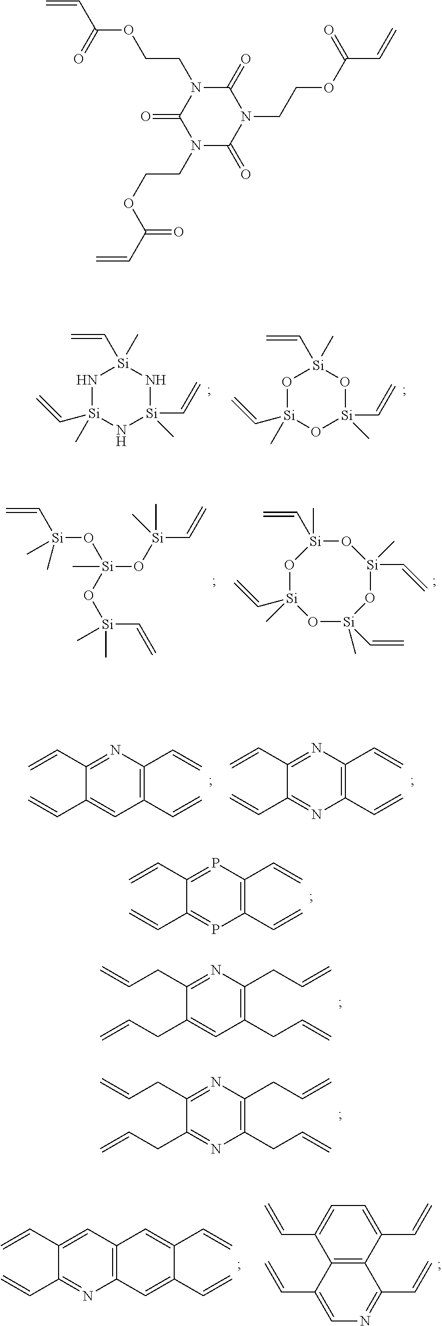

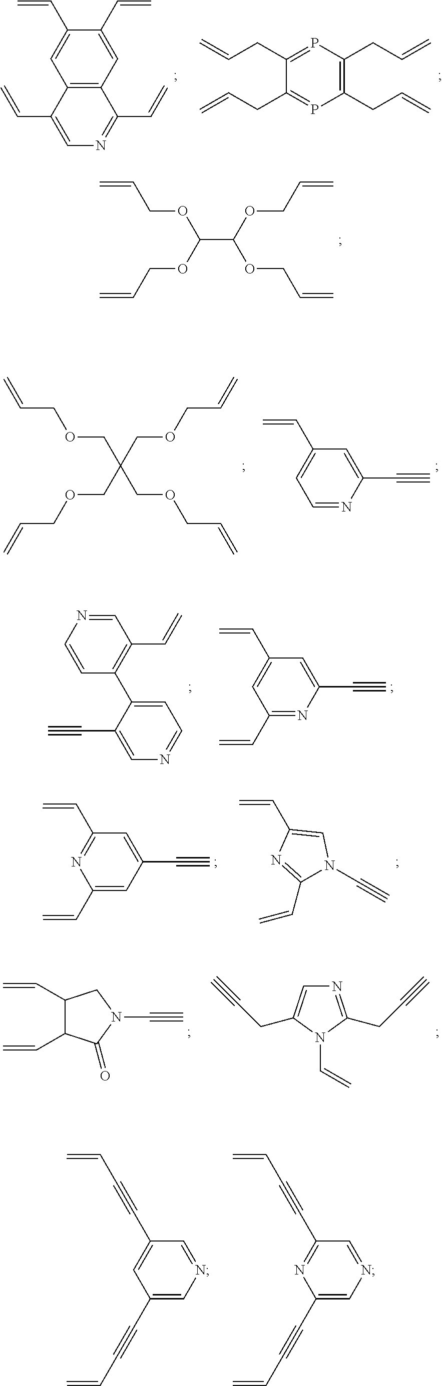

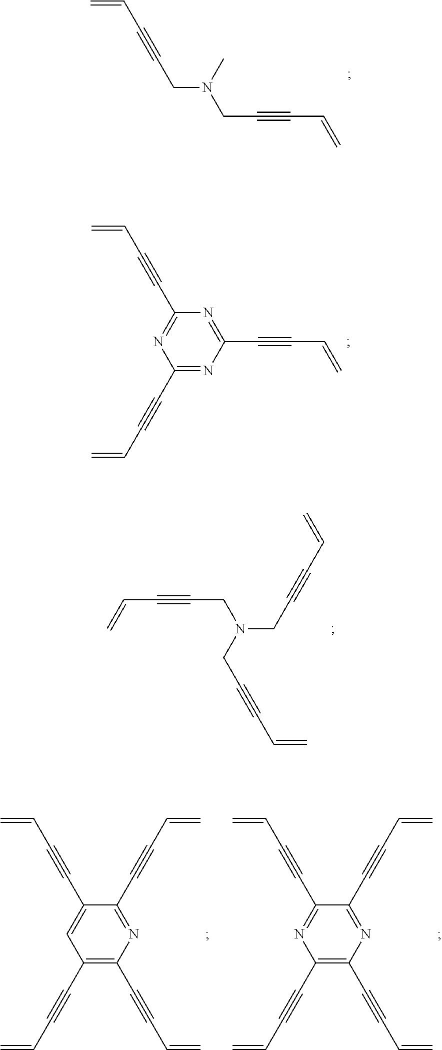

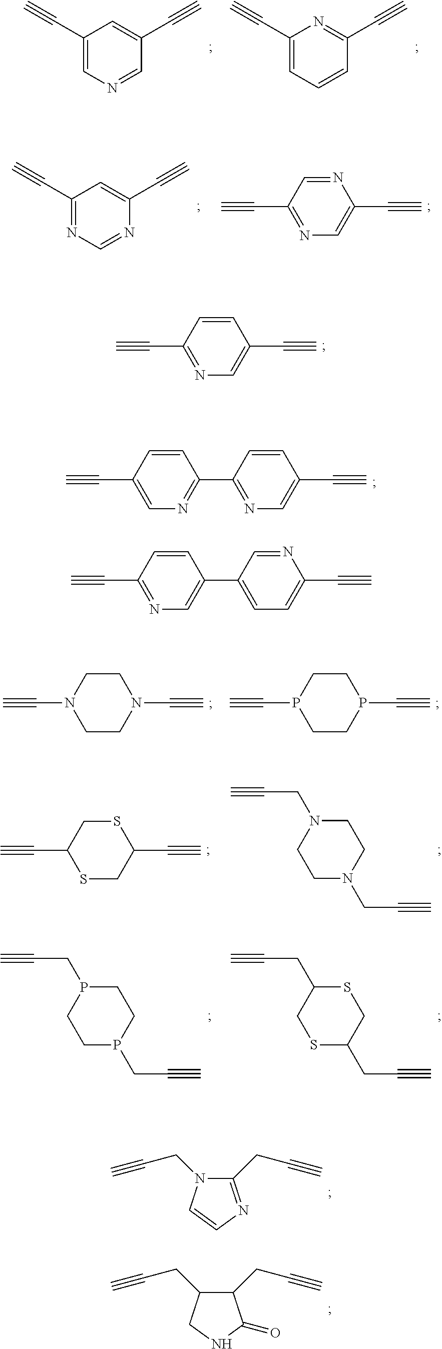

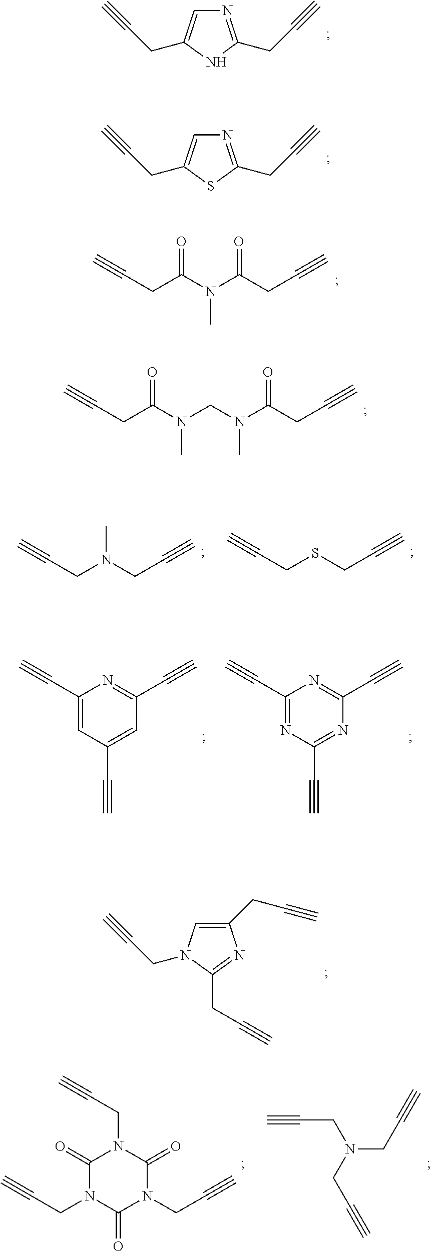

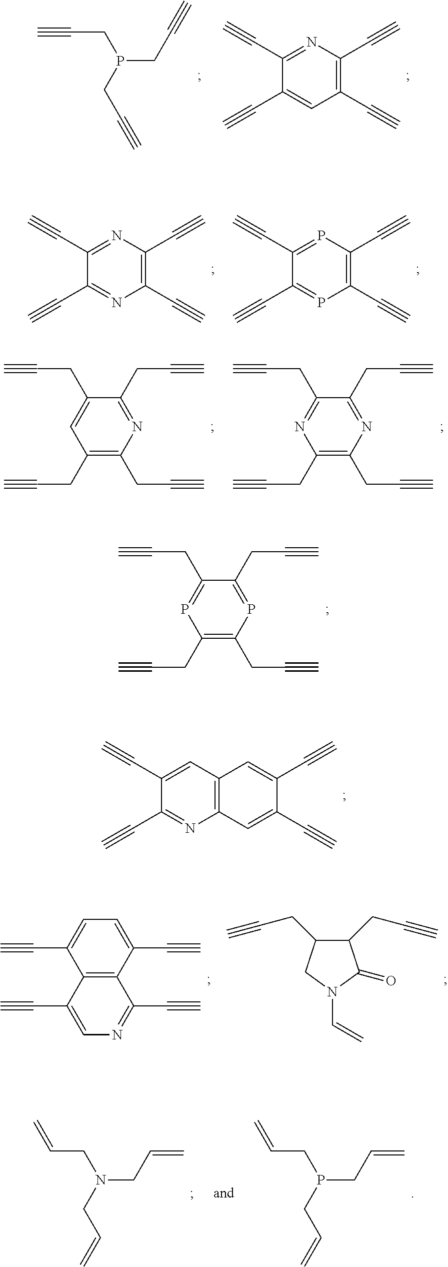

23. (canceled)

24. (canceled)

25. (canceled)

26. (canceled)

27. (canceled)

28. The method according to claim 18, wherein the solid precursor material further comprises one or more monomeric materials that has:
one polymerisable functional group selected from acetylene or vinyl functional groups; and
a functional group capable of forming a halogen bond with a halogen atom, selected from one or more of the group consisting of: [chemical structure]
